(19) United States
(12) Patent Application Publication
(10) Pub. No.: US 2025/0136380 A1
(43) Pub. Date: May 1, 2025

(54) IMPROVED OVERHEAD CONVEYING DEVICE FOR AN ORDER-PICKING SYSTEM, AND TRANSPORT CARRIER FOR TRANSPORTING HANGING GOODS

(71) Applicant: TGW Mechanics GmbH, Wels (AT)

(72) Inventors: Thomas KRIECHBAUM, Bad Schallerbach (AT); Josef REISCHL, Gunskirchen (AT); Christoph PAUZENBERGER, Neumarkt i. H. (AT); Bernhard OEGGER, Weibern (AT); Hussam KAMEL, Wels (AT)

(21) Appl. No.: 18/835,661

(22) PCT Filed: Feb. 3, 2023
(86) PCT No.: PCT/AT2023/060031

§ 371 Date: Aug. 2, 2024

(30) Foreign Application Priority Data
Feb. 4, 2022 (AT) A50068/2022

(51) Int. Cl. B65G 17/48; B65G 1/04; B65G 17/16; B65G 47/71

(52) U.S. Cl. CPC B65G 17/485; B65G 1/0457; B65G 17/16; B65G 47/71; B65G 2201/0229

(57) ABSTRACT

An overhead conveying device for an order-picking system comprises a support structure such as a guide rail, a transport carrier movable on the support structure for transporting a hanging article, and a drive device for moving the transport carrier on the support structure. The transport carrier can have a drive wheel coupled to a motor, an energy source connected to the motor, a holding force generator by means of which the transport carrier movably adheres to the support structure, and/or a driving control and a writably and readably configured memory connected thereto. The overhead conveying device can further have a diverter with a diverter element which is movable vertically to a level of a running surface of the guide rail or away from it.

### RELATED APPLICATIONS

This is a national stage under 35 U.S.C. § 371 of International Application No. PCT/AT2023/060031, filed Feb. 3, 2023, which claims priority of Austrian Patent Application No. A50068/2022, filed Feb. 4, 2022.

### TECHNICAL FIELD

The field of the present disclosure relates to an overhead conveying device for an order-picking system and to a transport carrier for an overhead conveying system for transporting a hanging article.

### BACKGROUND

An overhead conveying device and a transport carrier are known in the prior art.

For example, WO 2020/160585 A2 discloses a transport carrier system for an overhead conveying device in this context. In particular, the transport carrier has a universally usable base body and a support body that can be replaced via a connecting device and that, in a first configuration, is provided with a completely enclosed receiving means opening for transporting transport bags and, in a second configuration, is provided with a hook for transporting goods on clothes hangers.

A transport carrier system for an overhead conveying device is known from WO 2021/195682 A1 and DE 10 2018 209 722 A1, wherein the transport carriers are moved along a guide rail via a linear drive. A drive force is thereby transferred from a stationary primary element of the linear drive arranged on the guide rail to a secondary element of the linear drive arranged on the guide rail. A plurality of individually actuable drive segments can be provided, wherein all transport carriers within a drive segment are substantially jointly actuated.

A disadvantage of this and other known transport carrier systems is that these do not allow individual movement of a transport carrier by an order-picking system. Instead, transport carriers are moved collectively with other transport carriers in known order-picking systems. This leads to performance losses in the operation of known order-picking systems and to known order picking systems requiring a comparatively large amount of installation space. Furthermore, the support structure in known order-picking systems cannot be configured very flexibly.

### SUMMARY

An improved overhead conveying device for an order-picking system comprises a support structure configured as a guide rail with a (first) running surface extending along it. Furthermore, the overhead conveying device comprises a transport carrier for transporting a hanging article with a base body and several wheels rotatably mounted on the base body, as well as a drive device for moving the transport carrier along the guide rail. The drive device has an electrically powered motor which is mounted on the transport carrier, wherein one wheel of said wheels is configured as a (first) drive wheel that is coupled to the motor.

The proposed measures make it possible to move a transport carrier individually and (largely) independently of other transport carriers in the order-picking system. In particular, a route of the transport carrier, a speed of the transport carrier, an acceleration of the transport carrier and/or a distance of the transport carrier to another transport carrier travelling ahead can be selected individually. By accordingly specifying the speed of the transport carrier and/or the distance of the transport carrier to another transport carrier travelling ahead, a specific throughput of transport carriers can also be specified or achieved. For example, said speed and said distance can be reduced on curves and increased on straights. Said throughput can thereby be kept particularly constant. In particular, it is also possible to individually regulate a pendulum movement of the hanging article, which can occur during acceleration or braking of the transport carrier. The drive wheels are thereby driven such that they counteract a pendulum movement. Control algorithms for this purpose are known in principle and are therefore not described in detail here.

Some embodiments comprise an overhead conveying device for an order-picking system, which comprises a support structure that forms a driving surface. The overhead conveying device further comprises a transport carrier for transporting a hanging article, the former forming a base body, wherein the base body forms a first transport carrier side and a second transport carrier side, and a drive device for moving the transport carrier on the driving surface. The transport carrier additionally has a holding force generator, by means of which the transport carrier movably adheres to the support structure, in particular on the driving surface. This means that the holding force acts substantially in the direction orthogonal to the driving surface and allows movement of the transport carrier on the driving surface.

The proposed measures lead to a particularly flexible configuration of the support structure, since it only has to provide one driving surface for the transport carriers.

Some embodiments comprise a transport carrier for transporting a hanging article on an overhead conveying device for an order-picking system, wherein the transport carrier has a driving control and a writably and readably configured memory connected to the driving control.

These are further or alternative measures in order to move a transport carrier individually and (largely) independently of other transport carriers in the overhead conveying device. In particular, a route of the transport carrier, a speed of the transport carrier, an acceleration of the transport carrier and a distance of the transport carrier to another transport carrier travelling ahead can, in turn, be selected individually.

Some embodiments comprise an overhead conveying device for an order-picking system which, in particular as previously described, comprises a support structure configured as a guide rail with a running surface extending along the guide rail, or a support structure which forms a driving surface. Furthermore, the aforementioned overhead conveying device comprises a transport carrier for transporting a hanging article which, in particular, forms a base body, and has a drive device for moving the transport carrier on the guide rail or driving surface. The transport carrier also has a drive motor and an energy source connected thereto.

These further or alternative measures also enable or support an individual movement of the transport carrier in the order-picking system. In particular, the proposed transport carrier is at least temporarily independent of a (stationary) energy supply system of the order-picking system.

Finally, some embodiments comprise an overhead conveying device for an order-picking system which comprises a guide rail with a (first) running surface extending along it. Furthermore, the overhead conveying device comprises a transport carrier for transporting a hanging article that has a base body and a plurality of wheels rotatably mounted on the base body, as well as, in particular in a diverter section, a diverter which comprises a diverter element movable vertically to a height of the running surface of the guide rail or away from it, wherein the guide rail comprises a first rail route adjoining the diverter, in particular upstream of the diverter in a first transport direction of the transport carrier, a second rail route adjoining the diverter, in particular downstream of the diverter in the first transport direction of the transport carrier and a third rail route adjoining the diverter, in particular downstream of the diverter in the first transport direction of the transport carrier, and wherein the diverter element is switchable between a first switch position and a second switch position in order to selectively guide the transport carrier along a first transport path between the first rail route and the second rail route or along a second transport path between the first rail route and the third rail route, wherein the overhead conveying device and/or its diverter are configured in particular according to one of the aspects described previously.

A diverter can thereby be switched very quickly because the necessary lift of a diverter element is comparatively small, in particular smaller than an adjusting path of a comparable horizontally adjustable diverter.

Further advantageous embodiments and further embodiment variations can be derived from the dependent claims and from the description in conjunction with the figures.

It is expedient for the drive wheel to lie on the running surface in a rollable manner and for the transport carrier to be suspended from the guide rail by means of the drive wheel. The weight of the transport carrier and potentially a weight of the hanging article thus exerts a pressing force of the drive wheel onto the running surface, whereby a friction force transferred by means of the drive wheel is increased. In addition to the drive wheel lying on the running surface, the transport carrier can have further wheels which do not necessarily lie on the running surface but rather elsewhere on the guide rail.

In addition, it is expedient if the electrically powered motor is arranged above the drive wheel on the base body. The drive wheel can thereby be reliably and simply coupled to the electric motor.

Furthermore, it is expedient if the electrically powered motor is arranged above the guide rail when the transport carrier is suspended from the guide rail. The motor is thereby arranged where there is usually sufficient space anyway. In particular, the special arrangement of the motor affords great design freedom in the configuration of a diverter.

It is advantageous if the guide rail has a counter running surface extending along it and if one wheel of said wheels is configured as an adjusting wheel and lies on the counter running surface in a rollable manner. Guidance of the transport carrier on the guide rail is thereby improved. According to one possible embodiment, the counter running surface extends in parallel to the running surface with a horizontal spacing and/or vertical spacing. The “adjusting wheel” can alternatively be designated or seen as a “counter wheel”.

It is also particularly advantageous if the transport carrier has an adjusting device by means of which the adjusting wheel is pressed against the counter running surface with an adjusting force. Guidance of the transport carrier on the guide rail is thereby further improved. In addition, a friction force transferred by the drive wheel is also increased. In particular, the weight force caused by the transport carrier, the weight force caused by the hanging article, and the adjusting force can act on the drive wheel. In this embodiment, the adjusting wheel can alternatively also be designated or seen as a “counter wheel”, “trailing wheel” or “pressing wheel”. Accordingly, the “adjusting force” can alternatively also be designated or seen as a “trailing force” or “pressing force”.

It is expedient if the adjusting device
has a carriage that is movably mounted on the base body and a force generator acting against the carriage, wherein the adjusting wheel is arranged on the carriage, or
a swing arm that is movably mounted on the base body and a force generator acting against the swing arm, wherein the adjusting wheel is mounted on the swing arm.

Height tolerances of the guide rail can thereby be well compensated. The term “adjusted” can alternatively also be designated or seen as “preloaded”.

Furthermore, it is expedient if the force generator comprises a preloaded, elastic spring element (for example a spring or a rubber buffer), a pneumatic spring, a permanent magnet, or an electromagnet. The adjusting force can thereby be generated using well established technical means.

In a further expedient embodiment, the drive device has a traction drive via which the drive wheel is coupled to the motor. The drive is thus relatively quiet and low-maintenance. In particular, a toothed belt or flat belt are an option as a traction means of the traction drive.

In a further embodiment, the transport carrier has a support body with a receiving means for hanging the hanging article. In particular, the receiving means can comprise a fully enclosed receiving means opening (eyelet) for hanging a hanger of the hanging article into, or an open receiving means section (hook) to hang a hanger of the hanging article into or onto.

It is advantageous if the support body is exchangeably fixed to the base body via a connecting device. The support body can thus flexibly deployable and can be used for a plurality of different hanging articles.

It is expedient if the overhead conveying device comprises the hanging article which is transportable with the transport carrier, and the hanging article has a transport bag with a bag body for storing an article. In particular, the transport bag and the transport carrier are coupled to one another. In a preferred embodiment, the transport bag comprises a hanging carrier, wherein the hanging carrier and the transport carrier are coupled to one another via a hinge connection in such a way that the hanging carrier is pivotable relative to the transport carrier around an axis extending substantially parallel to the overhead conveying device (or substantially parallel to the transport direction of the transport carrier). The transport carrier can be provided with a first coupling element and the hanging carrier with a second coupling element, wherein the first coupling element and the second coupling element are connectable and form the hinge connection. The first coupling element can thereby comprise a pivot support and the second coupling element a pivot bearing axle. The pivot bearing axle can thereby be configured on a hook. According to another embodiment, the hinge connection between the hanging carrier and the transport carrier can comprise an elastic body, in particular made from elastomer material, which is connected on one side with the hanging carrier and on the other side with the transport carrier. The hanging carrier and the transport carrier are preferably permanently or inextricably connected to one another via the elastic body (the elastic hinge connection).

The hanging article can generally be configured by clothing which hang on the transport carriers by means of clothes hangers, or by means of transport bags for receiving articles which hang on the transport carriers.

It is also particular advantageous if the transport carrier and/or the transport bag has/have an energy storage electrically connected to the motor and/or an energy source electrically connected to the motor. In particular, the motor is thereby connected to the energy storage or the energy source via a switch element or control element. The energy storage can, for example, be configured as a rechargeable battery or also as a capacitor (e.g., as a “supercap”). The energy storage can be charged during a movement of the transport carrier, for example via an energy supply system arranged along the guide rail or along the driving surface, or in situ at a charging station of the order-picking system. The energy source can be configured, for example, as a solar module and be provided in addition or as an alternative to an energy storage. The proposed measures enable or support an individual movement of the transport carrier in the order-picking system. In particular, the proposed transport carrier is at least temporarily independent of a (stationary) energy supply system of the order-picking system.

It is also advantageous if the overhead conveying device has an electric energy supply system which comprises an insulator and exposed electrical conductors which are arranged along the guide rail, in particular on the guide rail, wherein the transport carrier has current collectors which are in electrical contact with the electrical conductors and are electrically connected to the motor. It is thereby possible to also supply a transport carrier with electricity independently of an optionally provided energy storage in the transport carrier or independently of an optionally provided energy source in the transport carrier, and to enable driving of the transport carrier. Furthermore, an energy storage provided in the transport carrier can also be charged via the energy supply system, in particular also during a movement of the transport carrier. The current collectors can, for example, be configured as sliding contacts and slide/brush on the electrical conductors when the transport carrier moves. The electrical conductors can then also be seen and/or designated as “sliding conductors”. If the electrical conductors are arranged on the support rail and the current collectors roll on them, the current collectors can also be configured as wheels of the transport carrier.

Furthermore, it is advantageous if along the guide rail, in particular on the guide rail, the overhead conveying device has an inductive energy supply system or an inductive energy transfer system and the energy transmission to the motor (and potentially to a charging connection of an energy storage connected to the motor) of the transport carrier is inductive. The energy transmission to the transport carrier can thereby be performed contactlessly and thus noiselessly and without wear. In particular, the inductive energy supply system can have at least one electrical conductor extending parallel to the guide rail and a coil which is arranged on the transport carrier and is electrically connected to the motor, wherein the energy transmission to the coil is performed contactlessly. In a particularly advantageous embodiment variation, the transport carrier comprises a ferromagnetic core around which the coil is wrapped and which at least partially surrounds the at least one electrical conductor. The magnetic flow can thereby be guided better, and the efficiency of the inductive energy transmission improved.

Advantageously, the electrical energy supply system is only provided or present on straight route sections of the guide rail. The electrical energy supply system can thereby be configured more simply. In this embodiment, on curves and diverters the motor can be supplied from the energy storage or the energy source of the transport carrier.

Furthermore, it is particularly advantageous if the overhead conveying device has a feeding device which is assigned to a transport section of the guide rail which extends from a first height level to a second height level different to the first height level, wherein the feeding device interacts with the transport carrier and the feeding device applies a feeding force onto the transport carrier at least during a transport movement of the transport carrier between the different height levels. The transport carrier can thereby also be safely moved forwards on steep route sections. The feeding force can act in addition to the drive force. Alternatively, it is conceivable that the drive is deactivated in the transport section and only the feeding force acts upon the transport carrier. For example, in the transport section the feeding device can have a rack extending parallel to the guide rail and the transport carrier can have a gear wheel which meshes with the rack and is coupled to the motor. It is thereby expedient if the drive wheel and the gear wheel are coupled to one another, in particular in a torque-proof manner. Furthermore, the drive wheel and the gear wheel can be mounted on a shared drive shaft and are arranged thereon with an axial offset to one another. Alternatively, the feeding device can, for example, by configured by a bolt which is fixed to a traction drive and can positively engage the transport carrier.

It is further expedient if at least some of the wheels of the transport carrier are configured double and are arranged in pairs symmetrically to a vertical plane extending in the longitudinal direction of the guide rail, wherein in an operating state of the transport carrier one set, in particular a first set or a second set, of the wheels provided in pairs is engaged with the guide rail respectively. A change in direction at diverters can thereby occur easily, wherein the transport carrier has a simple construction. Preferably those wheels which are arranged towards a first side of the vertical plane hereby form the first set of wheels provided in pairs, and those wheels which are arranged towards a second side of the vertical plane the second set of wheels provided in pairs.

It is also particularly advantageous if the guide rail has a first running surface and a second running surface, wherein the first running surface and the second running surface extend in parallel or inclined towards one another with a mutual horizontal spacing. The transport carrier can thereby be mounted in a particularly stable manner on the guide rail. The first and second running surfaces can in particular be aligned such that they are inclined towards one another and extend in parallel to one another along an extension direction.

Furthermore, one wheel of said wheels of the transport carrier can be configured as the first drive wheel of a first drive wheel pair and a further wheel of said wheels of the transport carrier as the second drive wheel of the first drive wheel pair. Optionally, the first drive wheel can lie on the first running surface and the second drive wheel on the second running surface in a rollable manner. The first drive wheel and the second drive wheel of the first drive wheel pair can, for example, be arranged coaxially on a first drive shaft coupled to the motor. Due to the coaxial arrangement of the two drive wheels, the drive has a very compact construction.

In a further embodiment of the overhead conveying device, one wheel of said wheels of the transport carrier can be configured as the first drive wheel of a second drive wheel pair and lie on the first running surface in a rollable manner, and a further wheel of said wheels of the transport carrier can be configured as the second drive wheel of the second drive wheel pair and lie on the second running surface in a rollable manner, wherein the first drive wheel and the second drive wheel of the second drive wheel pair can be arranged coaxially on a second drive shaft coupled to the motor. The transport carrier can thereby be mounted in an even more stable manner on the guide rail.

Advantageously, the transport carrier is suspended from the guide rail by means of said drive wheels. In particular, the transport carrier can be suspended from the guide rail by means of the drive wheel if (only) one drive wheel is provided. The transport carrier can, however, also be suspended from the guide rail with the first and/or second drive wheel of the first drive wheel pair if a first drive wheel pair is provided, and additionally also be suspended from the guide rail with the first and/or second drive wheel of the second drive wheel pair if a second drive wheel pair is provided. The weight of the transport carrier and potentially the weight of the hanging article thus exerts a pressing force of the drive wheel onto the running surface or a pressing force of the drive wheels onto the running surfaces, whereby a friction force transferred by means of the drive wheel or the drive wheels is increased.

It is particularly advantageous if the first running surface and the second running surface are arranged symmetrically to a vertical plane extending in the longitudinal direction of the guide rail and/or the drive wheels are arranged symmetrically to the vertical plane extending in the longitudinal direction of the guide rail. The transport carrier can thus not only be mounted in a stable manner on the guide rail, but the guide rail and/or the transport carrier can thereby also have a simple construction.

In a further expedient embodiment, the drive device has a traction drive via which said drive wheels are coupled to the motor. The drive is thus relatively quiet and low-maintenance. In particular, a toothed belt or flat belt are in turn an option as a traction means of the traction drive.

Moreover, it is advantageous if the guide rail has a first counter running surface and a second counter running surface, wherein the first counter running surface and the second counter running surface extend parallel to one another with a mutual horizontal spacing. One wheel of said wheels of the transport carrier can thereby be configured as the first adjusting wheel of a first adjusting wheel pair. In addition, a further wheel of said wheels of the transport carrier can be configured as the second adjusting wheel of the first adjusting wheel pair. For example, the first adjusting wheel and the second adjusting wheel of the first adjusting wheel pair can thereby be arranged coaxially on a first bearing axle. Furthermore, one wheel of said wheels of the transport carrier can be configured as the first adjusting wheel of a second adjusting wheel pair and a further wheel of said wheels of the transport carrier as the second adjusting wheel of the second adjusting wheel pair, wherein the first adjusting wheel and the second adjusting wheel of the second adjusting wheel pair are arranged coaxially on a second bearing axle. The arrangement of the adjusting wheels is very compact due to the coaxial construction. In particular, the first adjusting wheel, in particular of the first adjusting wheel pair and/or of the second adjusting wheel pair, can lie respectively on the first counter running surface and the second adjusting wheel, in particular of the first adjusting wheel pair and/or of the second adjusting wheel pair, can lie respectively on the second counter running surface. The proposed measures allow for the improved guidance of the transport carrier on the guide rail. According to one possible embodiment, the counter running surface extends in parallel to the running surface with a horizontal spacing and/or vertical spacing. The “adjusting wheels” can alternatively be designated or seen as “counter wheels”.

It is particularly advantageous if the first counter running surface and the further counter running surface are arranged symmetrically to a vertical plane extending in the longitudinal direction of the guide rail and/or the adjusting wheels are arranged symmetrically to the vertical plane extending in the longitudinal direction of the guide rail. The transport carrier can thus not only be mounted in a particularly stable manner on the guide rail, but the guide rail and/or the transport carrier can thereby also have a simple construction.

It is also particularly advantageous if the transport carrier has an adjusting device by means of which the first adjusting wheel is pressed with a first adjusting force against the first counter running surface and the second adjusting wheel is pressed with a second adjusting force against the second counter running surface Guidance of the transport carrier on the guide rail is thereby further improved. In addition, a friction force transferred by the drive wheels is also increased. In particular, the weight force caused by the transport carrier, the weight force caused by the hanging article, and the adjusting force can act on the drive wheels. In this embodiment, the adjusting wheels can alternatively also be designated or seen as “counter wheels”, “trailing wheels” or “pressing wheels”. Accordingly, the “adjusting force” can alternatively also be designated or seen as a “trailing force” or “pressing force”.

It is also expedient if the adjusting device as described above
has the carriage that is movably mounted on the base body and the force generator acting against the carriage, wherein the adjusting wheels are arranged on the carriage, or
has the swing arm that is movably mounted on the base body and the force generator acting against the swing arm, wherein the adjusting wheels are mounted on the swing arm.

Height tolerances of the guide rail can thereby be well compensated. The term “adjusted” can again alternatively be designated or seen as “preloaded”.

In turn, it is also expedient if the force generator comprises a preloaded, elastic spring element (for example by a spring or a rubber buffer), a pneumatic spring, a permanent magnet, or an electromagnet. The adjusting force can thereby be generated using well established technical means.

In addition, it is expedient if one wheel of said wheels of the transport carrier is configured as the first support wheel of a first support wheel pair and a further wheel of said wheels of the transport carrier is configured as the second support wheel of the first support wheel pair, which can be arranged coaxially on either side of the first drive wheel pair on the first drive shaft coupled to the motor. Furthermore, it is possible that one wheel of said wheels of the transport carrier is configured as the first support wheel of a second support wheel pair and a further wheel of said wheels of the transport carrier is configured as the second support wheel of the second support wheel pair, which can be arranged coaxially on either side of the second drive wheel pair on the second drive shaft coupled to the motor, insofar as one is provided. With these proposed measures, the transport carrier can be additionally stabilized on the guide rail or in a diverter section and a tipping of the transport carrier can be prevented or at least impeded. The support wheels be fixed on the drive shaft and be driven or can be rotatably mounted thereon and run free. It is thereby expedient if the support wheels are arranged symmetrically to a vertical plane extending in the longitudinal direction of the guide rail. In particular, the first and the second support wheel of the first support wheel pair and, where provided, the first and the second support wheel of the second support wheel pair, can be arranged symmetrically to the vertical plane extending in the longitudinal direction of the guide rail. The transport carrier thus has a comparatively simple construction.

Furthermore, it is advantageous if one wheel of said wheels of the transport carrier is configured as the first additional adjusting wheel of a first additional adjusting wheel pair and a further wheel of said wheels of the transport carrier is configured as the second additional adjusting wheel of the additional adjusting wheel pair, which can be arranged coaxially on either side of the first adjusting wheel pair on the first bearing axle. With these proposed measures, the transport carrier can be stabilized even better on the guide rail or in a diverter section and a potential tipping of the transport carrier can be further impeded. It is thereby expedient if the additional adjusting wheels are arranged symmetrically to a vertical plane extending in the longitudinal direction of the guide rail. In particular, the first and the second additional adjusting wheel of the additional adjusting wheel pair can be arranged symmetrically to the vertical plane extending in the longitudinal direction of the guide rail. In turn, the transport carrier has a comparatively simple construction.

Furthermore, it is advantageous if one wheel of said wheels of the transport carriers is configured as the first guide wheel of a first guide wheel pair and a further wheel of said wheels of the transport carrier is configured as the second guide wheel of the first guide wheel pair, wherein the first guide wheel and the second guide wheel of the first guide wheel pair are each mounted around vertical axles. The transport carrier can thus be stabilized even better on the guide rail or in a diverter section and a tipping of the transport carrier can be impeded even further. In particular, it is advantageous if one wheel of said wheels of the transport carrier is configured as the first guide wheel of a second guide wheel pair and a further wheel of said wheels of the transport carrier as the second guide wheel of the second guide wheel pair, wherein the first guide wheel and the second guide wheel of the second guide wheel pair are each rotatably mounted around vertical axles. The aforementioned effects are then intensified. It is expedient if the guide wheels are also arranged symmetrically to a vertical plane extending in the longitudinal direction of the guide rail. In particular, the first and the second guide wheel of the first guide wheel pair and, where provided, the first and the second guide wheel of the second guide wheel pair, can be arranged symmetrically to the vertical plane extending in the longitudinal direction of the guide rail. In turn, the transport carrier has a comparatively simple construction.

In a further embodiment, the overhead conveying device comprises a diverter in a diverter section, wherein the guide rail comprises a first rail route upstream of the diverter in a first transport direction of the transport carrier and a second rail route and third rail route downstream of the diverter in the first transport direction of the transport carrier and wherein the diverter has a diverter element which is switchable between a first switch position and a second switch position in order to selectively direct the transport carrier along a first transport path between the first rail route and the second rail route or along a second transport path between the first rail route and the third rail route. It is thereby possible to direct the transport carriers in the order-picking system along various paths of the overhead conveying device.

Furthermore, it is conceivable that the overhead conveying device comprises a diverter in a diverter section, wherein the guide rail comprises a second and third rail route upstream of the diverter in a second transport direction (in the opposing direction to the first transport direction) of the transport carrier and a first rail route downstream of the diverter in the second transport direction of the transport carrier and that the diverter has a diverter element which is switchable between a first switch position and a second switch position in order to selectively direct the transport carrier along a first transport path between the second rail route and the first rail route or along a second transport path between the third rail route and the first rail route. It is thus possible to merge transport carriers coming from different paths back onto one rail route.

The diverter element can be horizontally or vertically displaceable for switching a transport path. Furthermore, the diverter element can be configured in a pivotable or slidable manner. In addition, the diverter element can have a first guiding element for straight travel and a second guiding element for diversion travel or vice versa.

The diverter element can comprise a running surface and a counter running surface, wherein the counter running surface extends parallel to the running surface with a horizontal spacing and/or a vertical spacing. In particular, the diverter element can comprise a first running surface and a second running surface as well as a first counter running surface and a second counter running surface, wherein the first running surface and the second running surface extend parallel to the first counter running surface and to the second counter running surface with a horizontal spacing and/or a vertical spacing. The disclosure concerning the running surfaces of the guide rail and the drive wheels lying thereon in a rollable manner, as well as the disclosure concerning the counter running surfaces of the guide rail and the adjusting wheels lying thereon in a rollable manner also applies analogously for the diverter or diverter element. That is also particularly applicable for the effect of the adjusting device.

In one embodiment variation it is provided that
in the first switch position of the diverter element the first drive wheel of the first drive wheel pair (and where applicable the first drive wheel of the second drive wheel pair) lies on a running surface of a first guiding element of the diverter element in a rollable manner and the first adjusting wheel of the first adjusting wheel pair (and where applicable the first adjusting wheel of the second adjusting wheel pair) lies on a counter running surface of the first guiding element when the transport carrier is moved along the diverter section, and
in the second switch position of the diverter element the second drive wheel of the first drive wheel pair (and where applicable the second drive wheel of the second drive wheel pair) lies on a running surface of a second guiding element of the diverter element and the second adjusting wheel of the first adjusting wheel pair (and where applicable the second adjusting wheel of the second adjusting wheel pair) lies on a counter running surface of the second guiding element when the transport carrier is moved along the diverter section.

That means that in one switch position of the diverter element one half of the drive wheels and adjusting wheels provided in pairs is engaged with the diverter element, whilst the other half is not engaged with the diverter element in this switch position. Specifically, in the first switch position of the diverter element a first half of the drive wheels and adjusting wheels provided in pairs is engaged with the first guiding element of the diverter element, whilst the other half is not engaged with the diverter element in this switch position, and vice versa.

It can thereby be provided that in the first switch position a first end of the running surface of the first guiding element adjoins the running surface of the first rail route and a second end of the running surface of the first guiding element adjoins the running surface of the second rail route and in the second switch position a first end of the running surface of the second guiding element adjoins the running surface of the first rail route and a second end of the running surface of the second guiding element adjoins the running surface of the third rail route, such that the transport carrier can be selectively transferred from the first rail route to the second or third rail route.

In the definition above, the first guiding element and the second guiding element each have only one running surface. It can, however, be provided that the first guiding element and the second guiding element each have a first and second running surface and a first and second counter running surface. The following conditions are then present:
In the first switch position of the diverter element the first drive wheel of the first drive wheel pair (and where applicable the first drive wheel of the second drive wheel pair) lies on a first and second running surface of a first guiding element of the diverter element in a rollable manner and the first adjusting wheel of the first adjusting wheel pair (and where applicable the first adjusting wheel of the second adjusting wheel pair) lies on a first and second counter running surface of the first guiding element when the transport carrier is moved along the diverter section, and
in the second switch position of the diverter element the second drive wheel of the first drive wheel pair (and where applicable the second drive wheel of the second drive wheel pair) lies on a first and second running surface of a second guiding element of the diverter element and the second adjusting wheel of the first adjusting wheel pair (and where applicable the second adjusting wheel of the second adjusting wheel pair) lies on a first and second counter running surface of the second guiding element when the transport carrier is moved along the diverter section.

Here again, in one switch position of the diverter element one half of the drive wheels and adjusting wheels provided in pairs is engaged with the diverter element, whilst the other half is not engaged with the diverter element in this switch position. Specifically, in the first switch position of the diverter element again a first half of the drive wheels and adjusting wheels provided in pairs is engaged with the first guiding element of the diverter element, whilst the other half is not engaged with the diverter element in this switch position, and vice versa.

It can thereby be provided that in the first switch position a first end of the first running surface of the first guiding element adjoins the first running surface of the first rail route and a second end of the first running surface of the first guiding element adjoins the first running surface of the second rail route and in the second switch position a first end of the first running surface of the second guiding element adjoins the first running surface of the first rail route and a second end of the first running surface of the second guiding element adjoins the first running surface of the third rail route, such that the transport carrier can be selectively transferred from the first rail route to the second or third rail route. Equally, in this case in the first switch position a first end of the second running surface of the first guiding element adjoins the second running surface of the first rail route and a second end of the second running surface of the first guiding element adjoins the second running surface of the second rail route and in the second switch position a first end of the second running surface of the second guiding element adjoins the second running surface of the first rail route and a second end of the second running surface of the second guiding element adjoins the second running surface of the third rail route, such that the transport carrier can be selectively transferred from the first rail route to the second or third rail route.

Furthermore, it is expedient if the diverter element, in particular the first guiding element, comprises a first diverter guide surface, which in the first switch position of the diverter element acts upon a support wheel of the first support wheel pair (and where applicable on a support wheel of the second support wheel pair) or interacts with a guide wheel of the first guide wheel pair (and where applicable with a guide wheel of the second guide wheel pair), wherein the transport carrier is guided along the first transport path, in particular straight ahead, and in the second switch position of the diverter element does not interact with the transport carrier (i.e., is ineffective), and the transport carrier can be moved unhindered along the second transport path. Through a movement along the second transport path, the transport carrier can thus, in particular, be diverted. In other words, the transport carrier is only in interaction with the first diverter guide surface during straight travel, namely via the support wheels or the guide wheels.

Furthermore, it is expedient if the diverter element, in particular the second guiding element, comprises a second diverter guide surface (diversion surface), which in the first switch position of the diverter element does not interact with the transport carrier, wherein the transport carrier can be moved along the first transport path, in particular straight ahead, and in the second switch position of the diverter element interacts with a guide wheel of the first guide wheel pair (and where applicable with a guide wheel of the second guide wheel pair), wherein the transport carrier is guided along the second transport path. The transport carrier can thus be diverted, for example. In other words, the transport carrier is only in interaction with the second diverter guide surface (diversion surface) during diversion travel, namely via the guide wheels.

Advantageously, the diverter additionally comprises a diverter base body, upon which the diverter element is mounted, said diverter base body
comprises an upper side,
comprises a lower side,
comprises a first passage channel extending from the upper side to the lower side and along a first transport path, to which at one end of the first passage channel the first rail route adjoins and at an opposite, further end of the first passage channel the second rail route adjoins,
comprises a second passage channel extending from the upper side to the lower side and along a transport path (for instance for diversion travel) which at one end of the second passage channel leads into the first passage channel and at an opposite, further end of the second passage channel adjoins to the third rail route,
comprises on the upper side a first running surface upon which the first drive wheel of the first drive wheel pair (and where applicable the first drive wheel of the second drive wheel pair) lies in a rollable manner when the transport carrier is moved, for example straight, along the first transport path, and a second running surface upon which the second drive wheel of the first drive wheel pair (and where applicable the second drive wheel of the second drive wheel pair) lies in a rollable manner when the transport carrier is moved, for example is diverted, along the second transport path,
comprises on the upper side a first support surface upon which the first support wheel of the first support wheel pair (and where applicable the first support wheel of the second support wheel pair) lies in a rollable manner, and a second support surface upon which the second support wheel of the first support wheel pair (and where applicable the second support wheel of the second support wheel pair) lies in a rollable manner,
comprises on the upper side a first straight guidance upon which the first support wheel of the first support wheel pair (and where applicable the first support wheel of the second support wheel pair) lies in a rollable manner, and a second straight guidance upon which the second support wheel of the first support wheel pair (and where applicable the second support wheel of the second support wheel pair) lies in a rollable manner when the transport carrier is moved straight, in particular along the first transport path, and
comprises on the upper side a first diversion guidance upon which the first support wheel of the first support wheel pair (and where applicable the first support wheel of the second support wheel pair) lies in a rollable manner, and a second diversion guidance upon which the second support wheel of the first support wheel pair (and where applicable the second support wheel of the second support wheel pair) lies in a rollable manner when the transport carrier is diverted, in particular along the second transport path.

Through the clever arrangement of the running surface, the support surface, the straight guidances and the diversion guidances, not only is a tipping of the transport carrier in the region of the diverter avoided effectively, but it is also enabled that a drive force of the drive wheels of the transport carrier can be transferred to the guide rail.

Advantageously, the diverter base body additionally comprises
on the lower side a first counter running surface upon which the first adjusting wheel of the (first) adjusting wheel pair lies in a rollable manner when the transport carrier is moved along the first transport path (for example, straight ahead), and a second counter running surface upon which the second adjusting wheel of the (first) adjusting wheel pair lies in a rollable manner when the transport carrier is moved along the second transport path (for example, is diverted),
on the lower side a first additional support surface upon which the first additional adjusting wheel of the additional adjusting wheel pair lies in a rollable manner, and a second additional support surface upon which the second additional adjusting wheel of the additional adjusting wheel pair lies in a rollable manner,
on the lower side a first additional straight guidance upon which the first additional adjusting wheel of the additional adjusting wheel pair lies in a rollable manner, and a second additional straight guidance upon which the second additional adjusting wheel of the additional adjusting wheel pair lies in a rollable manner when the transport carrier is moved straight, in particular along the first transport path, and
on the lower side a first additional diversion guidance upon which the first additional adjusting wheel of the additional adjusting wheel pair lies in a rollable manner, and a second additional diversion guidance upon which the second additional adjusting wheel of the additional adjusting wheel pair lies in a rollable manner when the transport carrier is diverted, in particular along the second transport path.

Through the clever arrangement of the counter running surface, the additional support surface, the additional straight guidances and the additional diversion guidances, not only is a tipping of the transport carrier in the region of the diverter avoided even better, but the transfer of a drive force from the drive wheels of the transport carrier to the guide rail is also improved.

Furthermore, it is advantageous if the diverter guide surfaces and/or the support surfaces are only provided in the region of the diverter. In particular, the first and the second diverter guide surfaces and the first and the second support surface can be provided only in the region of the diverter. The guide rails can thereby have a simple construction.

In one embodiment variation of the overhead conveying device, at least some of the wheels of the transport carrier are configured double and are arranged in pairs symmetrically to a vertical plane extending in the longitudinal direction of the guide rail, wherein in a switch state of the diverter (only) one set, in particular a first set or a second set, of the wheels provided in pairs on the transport carrier is engaged with the diverter element respectively. It is also conceivable that at least some of the wheels of the transport carrier are configured double and are arranged in pairs symmetrically around said vertical plane, wherein in a switch mode of the diverter both sets of the wheels provided in pairs on the transport carrier are temporarily engaged with the diverter element, that is to say until a drive force for the transport carrier can be fully assumed by one set of the drive wheels provided in pairs.

A “set” of wheels provided in pairs is formed by the sum of such wheels, which each represent one part of a wheel pair. A set can thus comprise, in particular, all first or all second wheels of a group of wheel pairs.

It is also advantageous if the guide rail comprises rail guide surfaces and/or the diverter element comprises diverter guide surfaces which interact with the guide wheels of the transport carrier. The transport carrier can thereby be well guided transversely and a potential tipping of the transport carrier can be reliably avoided.

It is also expedient if the drive wheels of the first drive wheel pair and the drive wheels of the second drive wheel pair and/or the adjusting wheels of the (first) adjusting wheel pair are all engaged with the guide rail when the transport carrier is moved on the guide rail. In particular, the first and second drive wheels of the first drive wheel pair and the first and second drive wheels of the second drive wheel pair and/or the first and second adjusting wheels of the adjusting wheel pair are all engaged with the guide rail when the transport carrier is moved on the guide rail. A tipping of the transport carrier and a consequential falling down of the same from the guide rail is thereby avoided effectively.

In a further expedient embodiment variation of the overhead conveying device, the transport carrier and the guide rail have lateral guide elements which are provided with mutually complementary lateral guide surfaces in order to guide the transport carrier during the transport movement along a longitudinal extension of the guide rail. Furthermore, it is advantageous if the transport carrier and the diverter have lateral guide elements which are provided with mutually complementary lateral guide surfaces in order to guide the transport carrier during the transport movement along the longitudinal extension of the diverter. A transverse guidance of the transport carrier on the guide rail or in the diverter can thereby be effected or improved. In this regard, it is advantageous if the running surfaces on the guide rail and/or on the diverter each have a lateral guide surface as lateral guide element for this purpose. In particular, the first running surface and the second running surface on the guide rail and/or on the diverter can, for this purpose, each be configured by running surfaces running inclined to one another and act as lateral guide surfaces. A lateral guide surface which is aligned normally to a running surface and in particular adjoins the latter would, however, also be conceivable. Furthermore, it is advantageous if the drive wheels of the transport carrier each have a lateral guide surface as a lateral guide element for said purpose. In particular, the first and second drive wheels of the first drive wheel pair and the first and second drive wheels of the second drive wheel pair can each have such a lateral guide surface. In particular, for this purpose the drive wheels can have a conical configuration or be configured with a conical recess or have a flange which interacts with a lateral guide surface of the guide rail and/or of the diverter. It is hereby expedient if the drive wheels each have a conical recess which extends along a circumferential surface of the respective drive wheel and which, in particular in the direction of an axis of rotation of the drive wheels, has a tapered configuration. The conical recess can hereby be formed by lateral guide surfaces extending with mutual inclination and interact with the mutually inclined lateral guide surfaces of the guide rail and/or diverter in order to guide the transport carrier.

With regard to the embodiment variation according to which the transport carrier additionally comprises a holding force generator by means of which the transport carrier is movably adhered to the support structure (in particular to the driving surface), it is advantageous if the drive device comprises drive elements which rest on the driving surface. The drive device can hereby comprise an electrically powered motor which is arranged on the base body, wherein a first drive element of the drive elements and a second drive element of the drive elements is coupled to the electrically powered motor. Alternatively, the drive device can comprise a plurality of electrically powered motors which are arranged on the base body, wherein a first drive element of the drive elements is coupled to a first motor of the electrically powered motors and a second drive element of the drive elements is coupled to a second motor of the electrically driven motors.

Furthermore, it is expedient if the base body is provided with the drive elements, wherein the first drive element is arranged on the first transport carrier side and the second drive element on the second transport carrier side. The proposed measures enable the transport carrier to both move straight on the driving surface (when the drive elements are actuated equally) as well as around corners (when the drive elements are actuated differently).

It is advantageous if the drive elements each comprise one or more drive wheels. The drive can thus have a comparatively simple construction.

Furthermore, the first drive element can comprise an endlessly circulating first crawler belt guided on the first transport carrier side around the drive wheels of the first drive element and/or the second drive element can comprise an endlessly circulating second crawler belt guided on the second transport carrier side around the drive wheels of the second drive element. The contact surface towards the driving surface is thereby enlarged.

It is particularly advantageous if the first and second drive elements each form an outer circumference and a plurality of holding force generators are arranged on the outer circumference of the drive elements. A comparatively high holding force can thereby be generated between the transport carrier and the driving surface, even when the drive elements are moving. In addition, the proposed system is error-tolerant because the failure of one holding force generator does not lead to a total failure of the system. It is preferably hereby provided that a plurality of holding force generators are arranged on a circumferential surface or an outer circumference of each of the drive wheels or are arranged on a surface of the crawler belt or the chain.

Alternatively or in addition, it can be provided that the holding force generator is arranged on the base body between the first transport carrier side and the second transport carrier side. The holding force generator can thereby be mounted on fixed, non-moving parts of the transport carrier such that the construction of the transport carrier can be simplified.

It is particularly advantageous if the holding force generator comprises a permanent magnet, holding lamellae (as per the gecko principle), suction cups and/or a Velcro strip of a Velcro fastening (in particular a part of a Velcro strip), for example hooks or mushroom heads of a Velcro fastening. In the case that the holding force generator comprises a permanent magnet, it is advantageous if the support structure forms a driving surface and is made of a (ferro)magnetic material (for example a steel sheet), wherein the transport carrier movably adhere to the driving surface via (or with the aid of) the permanent magnets. That means that the transport carrier than adheres to the driving surface due to the magnetic force. The use of one or more permanent magnets for said purpose is indeed advantageous, although it would also be conceivable to use one or more electromagnets in order to generate the necessary holding force to adhere the transport carrier to the driving surface. It is particularly advantageous that the generation of the holding force can be performed in a contactless manner. That means that the at least one permanent magnet does not have to be in contact with the driving surface but rather can be slightly spaced apart from it. Aside from the (electro) magnetic principle, other technologies for generating a holding force can also be used, namely said holding lamellae (as per the gecko principle), suction cups, and/or hooks or mushroom heads of a Velcro fastening. The holding force is hereby generated by the contact of the holding force generator with the driving surface. It is thereby particularly advantageous if holding force generators as described above are arranged on the outer circumference of the drive elements. While the driving surface is configured to be rather smooth when using holding lamellae and/or suction cups, it can have one part of a Velcro fastening if using a Velcro fastening. The other part of the Velcro fastening is then arranged on the transport carrier (in particular on the outer circumference of the drive elements). Suction cups can additionally be attached to a vacuum generator in order to generate or increase the holding force.

It is also particularly advantageous if the transport carrier comprises a hinge assembly which allows the hanging article to be pivoted relative to the base body by more than 45° and in particular by at least 90° transverse to the movement direction of the transport carrier. It is thereby possible that the transport carrier can travel on non-horizontally aligned driving surfaces without the movement being hindered by the hanging article. The driving surface can extend with an incline or even be aligned vertically and then in principle form a wall. The transport carriers adhering to the driving surface can also move on this wall. For example, a space-saving storage surface for the transport carriers can be formed this way. For said purpose, the transport carrier can have an extension bar with an eyelet arranged thereon and a hook of a hanging article rotatably mounted therein. A corresponding selection of the length of the extension bar can, in particular, influence the lateral pivot angle.

In this embodiment variation according to which the transport carrier additionally comprises a holding force generator by means of which the transport carrier is movably adhered to the support structure, it is particularly advantageous if the transport carrier has an energy storage electrically connected to the motor and/or an energy source electrically connected to the motor. Alternatively or in addition, it can be provided that the transport carrier comprises the hanging article, which has a transport bag with a bag body for storing an article, wherein the transport bag has an energy storage electrically connected to the motor and/or an energy source electrically connected to the motor.

In particular, the motor can itself be connected to the energy storage or the energy source via a switch element or control element. The energy storage can, for example, be configured as a rechargeable battery or also as a capacitor (e.g., as a “supercap”). The energy storage can be charged during a movement of the transport carrier, for example via an energy supply system arranged along the support structure the driving surface, or in situ at a charging station of the order-picking system. The energy source can be configured, for example, as a solar module and be provided in addition or as an alternative to an energy storage. The proposed measures enable or support an individual movement of the transport carrier in the order-picking system. In particular, the proposed transport carrier is at least temporarily independent of a (stationary) energy supply system of the order-picking system.

It is also advantageous if the overhead conveying device has an electric energy supply system which comprises an insulator and exposed electrical conductors which extend along the support structure or driving surface (and in particular are arranged thereon), wherein the transport carrier has current collectors which are in electrical contact with the electrical conductors and are electrically connected to the motor. It is thereby possible to also supply a transport carrier with electricity independently of an optional energy storage of the transport carrier or independently of an optional energy source of the transport carrier, and to enable driving of the transport carrier. Furthermore, an energy storage of the transport carrier can also be charged via the energy supply system, in particular also during a movement of the transport carrier. The current collectors can, for example, be configured as sliding contacts and slide/brush on the electrical conductors when the transport carrier moves. If the electrical conductors are arranged on the support structure or driving surface and the current collectors roll on them, the current collectors can also be configured as wheels of the transport carrier.

Furthermore, it is advantageous if along the support structure, in particular on the support structure or driving surface, the overhead conveying device has an inductive energy supply system or an inductive energy transfer system and the energy transmission to the motor (and potentially to a charging connection of an energy storage connected to the motor) of the transport carrier is inductive. The energy transmission to the transport carrier can thereby be performed contactlessly and thus noiselessly and without wear. In particular, the inductive energy supply system can have at least one electrical conductor extending parallel to the support structure or driving surface and a coil which is arranged on the transport carrier and is electrically connected to the motor, wherein the energy transmission to the coil is performed contactlessly. In a particularly advantageous embodiment variation, the transport carrier comprises a ferromagnetic core around which the coil is wrapped and which at least partially surrounds the at least one electrical conductor. The magnetic flow can thereby be guided better and the efficiency of the inductive energy transmission improved.

Advantageously, the electrical energy supply system is only provided on straight route sections of the driving surface. The electrical energy supply system can thereby be configured more simply. In this embodiment, on curves and diverters the motor is supplied from the energy storage or the energy source of the transport carrier.

In this embodiment variation according to which the transport carrier additionally comprises a holding force generator by means of which the transport carrier is movably adhered to the support structure, it is particularly advantageous if the transport carrier has the base body and a support body with a receiving means for suspending the hanging article. In particular, the support body can again be exchangeably fixed to the base body via a connecting device. Furthermore, the hanging article can comprise a transport bag with a bag body for storing an article.

With regard to embodiments according to which the transport carrier has a driving control and a writably and readably configured memory connected thereto, it is advantageous if the driving control is configured to influence or control a movement of the transport carrier on the support structure on the basis of movement data stored in the memory. In particular, a route of the transport carrier, a speed of the transport carrier, an acceleration of the transport carrier, and/or a distance of the transport carrier from another transport carrier moving ahead can be influenced on the basis of the movement data. For instance, the movement data can thus comprise a desired route of the transport carrier, a desired speed of the transport carrier, a desired acceleration of the transport carrier and/or a desired distance of the transport carrier from another transport carrier moving ahead, and be subsequently uploaded to the driving control, which uses the saved or stored transport data or parameters for a movement of the transport carrier. Correspondingly, the driving control can move the transport carrier on the stored route, set or control the stored desired speed of the transport carrier, set or control the desired acceleration of the transport carrier, and/or set or control the desired distance of the transport carrier from another transport carrier moving ahead. Generally, the movement of the transport carrier can be influence by control and/or regulation interventions.

It is also advantageous if the support structure has at least one control element and the driving control is configured to influence or control a movement of a control element of the support structure on the basis of control data saved or stored in the memory. In particular, such a control element can be understood as a diverter element of a diverter, which can be switched by the driving control as required. Other installations in an order-picking system, such as a lift, can, however, be controlled by the driving control. Generally, the movement of the control element can be influence by control and/or regulation interventions.

It is expedient if the driving control of the transport carrier and/or the at least one control element of the support structure is configured for optical, wired or wireless communication. For example, data and commands can be sent by a superordinate controller of the overhead conveying device or of the order-picking system to the transport carrier or vice versa. For wired communication, powerline communication technology in particular is an option, specifically by using an energy supply system of the overhead conveying device for data transmission.

In an advantageous embodiment of the overhead conveying device, the transport carrier comprises has a light source connected to the driving control and the control element of the support structure has a light-sensitive element, wherein a control command can be transmitted from the driving control of the transport carrier to the control element of the support structure with the light source via the light-sensitive element. In other words, the transmission of data or of control commands from the transport carrier to the support structure is performed optically. For example, it can be provided that the control element is activated or switched when the light-sensitive element receives the light from the light source. This light can be modulated or unmodulated. Furthermore, more complex data transmission is also possible with the corresponding modulation of the light source.

It is particularly advantageous if the control element of the support structure (in particular of the guide rail) is configured as a diverter and a control command of the driving control of the transport carrier causes the diverter to be switched into a predeterminable switch position. This way, the driving control of the transport carrier can actively switch a diverter and thus also actively determine its path along the overhead conveying device. The diverter can thereby be configured as described previously.

Furthermore, it is particularly advantageous if the transport carrier has a driving surface sensor connected to the driving control with which a driving marking and/or control marking arranged on the support structure is readable, which influences a movement of the transport carrier on the support structure. In particular, the driving surface sensor can be configured as an optical driving surface sensor, the driving marking as an optical driving marking and/or the control marking as an optical control marking. In other words, the behavior of the transport carrier in this embodiment is influenced by the markings on the support structure. The (optical) marking can, for example, be configured as a driving marking or driving line on the driving surface of the support structure along which the transport carrier is to move. The (optical) marking can, however, be configured as a control marking or control element for the transport carrier and can influence the transport carrier's further behavior. For example, the control marking can act as a turn-off point if the marking influences the direction of travel of the transport carrier at a diverter, or as a stopping point if the marking causes the transport carrier to stop. The change of a speed of the transport carrier, the change of an acceleration of the transport carrier, and/or the change of a distance of the transport carrier from another transport carrier can also be influenced by a control marking. An optical marking can be drawn, glued or printed onto the support structure. The optical marking can, in particular, be configured as a barcode or QR code. In addition, the optical marking (in the direction of transport) also has a longer configuration and affect a plurality of consecutive transport carriers. Although the use of optical markings is advantageous, markings with a different basis can of course also be used, for example magnetic markings.

It is also particularly advantageous if the support structure has a controllable light source and the transport carrier has an optical driving surface sensor connected to the driving control, wherein a control command can be transmitted from the support structure to the driving control of the transport carrier by means of the light source and the optical driving surface sensor. In particular, the controllable light source on the transport carrier or the support structure can have a plurality of individually activatable luminous dots arranged in the form of a matrix. The control commands transmitted to the transport carrier are thereby not fixed, but can rather be flexibly adapted to a certain situation. The luminous dots can thereby act as a driving marking and/or control marking. The above disclosure regarding the driving marking and/or control marking therefore applies analogously.

In this context, “arranged in the form of a matrix” can mean that a plurality of luminous dots are arranged in a row (in the form of a 1×m matrix) and thus form luminous dot rows. In particular, a one-dimensional control command can thereby be acquired. Furthermore, arranged in the form of a matrix can mean that where applicable a plurality, in particular at least two, such luminous dot rows are arranged next to one another (in the form of an n×m matrix, wherein n>1). A multi-dimensional control command can, for example, be acquired whereby a number of acquirable control commands is increased.

Furthermore, it is particularly advantageous if the driving control of the transport carrier is configured to receive a path definition from a superordinate controller, wherein the path definition specifies a path for the transport carrier at least in one diverter section of the support structure, to store a received path definition in the memory of the transport carrier, and to select a path from several paths in the diverter section corresponding to the received path definition. For example, the selection of a path can comprise an autonomous switching of diverters of the support structure by means of the driving control and the path definition. Using the proposed measures, the autonomy of the transport carrier is thereby achieved in that it independently determines its path in a diverter section. For example, the transport carrier can follow one of a plurality of driving markings in doing so. In particular, this can also occur in that the transport carrier independently approaches the diverters of the overhead conveying device on the basis of the path definition in the memory. Autonomous movement of the transport carrier can be well achieved this way. The superordinate controller thereby specifies the path which the transport carrier then travels along autonomously with the help of the driving control. The path definition can comprise, for instance, the selection of a certain driving marking in a diverter section or the sequence for switching the next four diverters, for example, such as the sequence “straight travel, diversion travel, diversion travel, straight travel”. As mentioned, this path definition is transmitted to the driving control and stored in the memory, and then serves the autonomous selection of a driving marking or the autonomous switching of the diverters. In other words, in the first diverter section that driving marking is selected which causes straight travel, in the second diverter section that driving marking which causes diversion travel, and so on. In the case of switchable diverters this means that the first diverter that the transport carrier reaches during its movement is controlled such that the diverter element is set to straight travel, the second diverter such that the diverter element is set to diversion travel, and so on. The transmission of the path definition can, in turn, be optical, wired, or wireless. The sequence for switching the next four diverters, for instance, can also be direction-independent and simply specify switch commands for the diverters, for example the sequence “do not switch, switch, switch, do not switch”. A switch command is thereby not bound to a certain direction. Depending on the diverter construction, “switch” can mean either straight travel or diversion travel. The same applies to “do not switch”. The sequence can also be specified in a purely binary manner, for instance in the sequence “0, 1, 1, 0” and then be used directly for controlling a light source of the transport carrier that is connected to the driving control if the diverter has a light-sensitive element to control it.

It would also be conceivable that a switching of a diverter is caused by means of a control marking which is arranged in the region of the support structure and can be detected by the transport carrier. This is then expedient, for instance, if several rail routes are merged into one rail route at a diverter. In this case, control markings can advantageously be provided in due time before the diverter that cause a correct switching of a diverter element.

It is also advantageous if the driving control of the transport carrier is configured to receive a weight of a mass carried by the transport carrier from a superordinate controller, to store this weight in the memory of the transport carrier, and to execute an acceleration profile depending on that weight. This way, the movement dynamic of the transport carrier can be adapted to the article. Said weight can be derived from a database, for example, in which the weight assigned to an article is stored, or can be acquired by weighing. In particular, the weight of the mass carried by the transport carrier can also influence the balancing out of a pendulum movement of the hanging article insofar as such regulation is provided.

It is also particularly advantageous if the driving control of the transport carrier is configured to regulate a speed of the transport carrier and/or to regulate a distance from another transport carrier. Speed and/or distance from another transport carrier can thereby be individually regulated. The movement mode of the transport carrier can thus be executed or influenced in a particularly flexible manner. For the regulation of the distance, it can be provided that the transport carrier has at least one distance sensor which is connected to the driving control (for signal and/or data transmission).

Furthermore, it is particularly advantageous if the transport carrier has a plurality of distance sensors which are connected to the driving control (for signal and/or data transmission) and which are arranged such that they form an angle of greater than 0° and less than 180° in pairs. The distance between transport carriers can thus also be well regulated in curves or in the diverter section. The signal of the distance sensor pointing into the inside of the curve is thereby evaluated preferably or exclusively. For example, the distance sensor can be configured as an ultrasound sensor.

It is advantageous if a setting of a desired speed of the transport carrier or of a desired distance of the transport carrier from another transport carrier is caused by a control marking which is arranged in the region of the support structure and can be detected by the transport carrier. The behavior of the transport carrier can thereby be simply influenced by disposing corresponding markings on the support structure. Complicated data transmission processes from a superordinate controller are not required for this.

Furthermore, it is advantageous if the transport carrier
has a driving surface sensor connected to the driving control with which a control marking arranged on the support structure can be read, wherein detecting the control marking triggers signalling of the driving control to a superordinate controller, or
has a short-range radio receiver connected to the driving control with which a signal of a short-range radio transmitter arranged on the support structure can be received, wherein receiving the signal by the short-range radio receiver triggers signalling of the driving control to a superordinate controller, or
has a short-range radio transmitter, wherein receiving a signal from the short-range radio transmitter of the transport carrier by a short-range radio receiver arranged on the support structure triggers signalling of the transport carrier (via the short-range radio receiver) to a superordinate controller.

Further actions can be linked to the signalling, for example the transmission of commands or data from the superordinate controller to the transport carrier. For example, a desired speed, a desired acceleration, and/or a desired distance of the transport carrier from another transport carrier moving ahead can be transmitted to the transport carrier. The signalling point can be configured by a (optical) control marking. If this control marking is detected by a driving surface sensor, in this embodiment variation this triggers a signalling of the driving control to the superordinate controller, which in turn can trigger the subsequent actions as already described. The signalling point can also be configured by a short-range radio transmitter arranged on the support structure. If its signal is received by the short-range radio receiver of the transport carrier, a signalling of the driving control to a superordinate controller is also triggered, which can trigger the subsequent actions as already described. Alternatively, the transport carrier can have a short-range radio transmitter. If its signal is detected by a short-range radio receiver arranged on the support structure, this in turn triggers signalling to a superordinate controller, which can also trigger the subsequent actions as already described. In both cases, it is advantageous if the short-range radio transmitter transmits a clear identified such that the short-range radio transmitter from which a signal is received can be allocated. In this context, “short-range” in particular a range of a few centimeters to a few meters (for instance, less than two meters).

Preferably, the signalling of the driving control to the superordinate controller can cause or trigger a transmission of a path definition to the driving control by the superordinate controller. For example, the transport network formed by the support structure or by the guide rail and the diverters can be divided into a plurality of segments separated by signalling points. When the driving control actively reports at a signalling point (for example, a control marking acting as a signalling point), the driving control receives the path definition for the following segment from the superordinate controller. The measure thus supports the flexible and autonomous movement of the transport carrier through the transport network.

In a further advantageous embodiment of the overhead conveying device, a local position is assigned to the driving marking and/or control marking or the short-range radio transmitter arranged on the support structure or the short-range radio receiver arranged on the support structure, wherein the signalling of the driving control to the superordinate controller effects an adaptation of the path definition starting from this position by the superordinate controller when a desired position of the transport carrier does not correspond with the local position of the driving marking and/or control marking or of the short-range radio transmitter or of the short-range radio receiver. It can occur that the actual position of the transport carrier does not correspond to the position of the transport carrier as assumed by the driving control.

The selection of a path in a diverter section and the switching of diverters according to the path definition stored in the memory then leads to switching errors and guiding errors. The proposed measures do, however, allow for a deviation of the actual position of the transport carrier from the position of the transport carrier as assumed by the driving control to be taken account of and the desired position of the transport carrier to be corrected again, that is to say, reverted to its actual position.

It would also be conceivable that the control marking or the short-range radio transmitter arranged on the support structure or the short-range radio receiver arranged on the support structure are configured to effect the simultaneous signalling of the driving controls of several transport carriers to the superordinate controller. The behavior of a group of transport carriers can thus be influenced in this way.

It is expedient if an energy supply system of the overhead conveying device (for example a loop conductor or an inductive energy supply system) is also configured for wired communication with the driving control of the transport carrier. The energy supply system can thereby perform a double use.

It is also advantageous if the energy supply system of the overhead conveying device is divided into several supply segments which have different addresses in a communication system of the overhead conveying device. In particular, the address can be detected by the transport carrier. It is thus possible to locate a transport carrier relatively simply.

It is also hereby advantageous if the energy supply system of the overhead conveying device is divided into several supply segments, wherein a local position is assigned to one of the supply segments of the energy supply system, and moving the transport carrier into this supply segment causes an adaptation of the path definition based on the local position assigned to this supply segment by a superordinate controller when a desired position of the transport carrier does not correspond with the local position of this supply segment of the energy supply system. It can naturally be provided here that a local position is assigned to each of the supply segments, wherein the adaptation of the path definition is performed depending on the respective supply segment that the transport carrier has entered. The selection of a certain path or the switching of diverters according to the path definition stored in the memory again leads to switching errors and guiding errors in case of the aforementioned deviation. The proposed measures do, however, allow for a deviation of the actual position of the transport carrier from the position as assumed by the driving control to be taken account of and the desired position of the transport carrier to be corrected again, that is to say, reverted to its actual position (in this case to the position of the supply segment that the transport carrier is entering).

It is particularly advantageous in the embodiment variation according to which the transport carrier has a driving control and a writably and readably configured memory connected thereto if the electrical energy supply system comprises an insulator and exposed electrical conductors which are arranged along the support structure, in particular on the support structure, wherein the transport carrier has current collectors which are in electrical contact with the conductors and are both electrically connected to a motor of the drive device and are electrically connected to the driving control via a communication module of the transport carrier. It is thus not only possible to supply a transport carrier with electricity independently of an energy storage provided in a transport carrier of independently of an energy source provided in a transport carrier, but it is hereby also possible to execute the transmission of data and/or control commands from and to the transport carrier via the electrical energy supply system. A voltage applied to the electrical conductors or an electrical signal applied to the electrical conductors is thus also applied to the inputs of the communication module which can extract the data from the signal and convert them. The communication module thereby also has a data connection with the current collectors or the electrical conductors. In particular, a galvanic isolation can also be performed between the current collectors and the inputs of the driving control in the communication module, for example by using an optical coupler or an isolating transformer. Of course, the communication module, the driving control and other modules can be supplied with energy via the current collectors. The current collectors can, for example, be configured as sliding contacts and slide/brush on the electrical conductors when the transport carrier moves. If the electrical conductors are arranged on the support structure or driving surface and the current collectors roll on them, the current collectors can also be configured as wheels of the transport carrier.

Furthermore, it is advantageous if along the support structure, in particular on the support structure, and/or along the driving surface, in particular on the driving surface, the overhead conveying device has an inductive energy supply system or an inductive energy transfer system and the energy transmission to the motor of the transport carrier and/or a data transmission to a communication module of the transport carrier that is connected to the driving control is inductive. The energy transmission to the transport carrier as well as the transmission of data and/or control from and to the transport carrier can thus be performed in a contactless manner. In particular, the inductive energy supply system can have at least one electrical conductor extending along the support structure or driving surface and a coil which is arranged on the transport carrier and is electrically connected to the motor and the communication module, wherein the energy and/or data transmission to the coil is performed contactlessly. A voltage applied to the coil or an electrical signal applied to the coil is thus also applied to the inputs of the communication module which can extract the data from the signal and convert them. The communication module thereby also has a data connection with the coil or the electrical conductors. In particular, a galvanic isolation can be performed between the coil and the inputs of the driving control in the communication module, for example by using an optical coupler or an isolating transformer. Of course, the communication module, the driving control and other modules can be supplied with energy via the coil. In a particularly advantageous embodiment variation, the transport carrier comprises a ferromagnetic core around which the coil is wrapped and which at least partially surrounds the at least one electrical conductor. The magnetic flow can thereby be guided better and the efficiency of the inductive energy transmission improved.

### BRIEF DESCRIPTION OF THE DRAWINGS

For a better understanding of the invention, it is explained in more detail with reference to the following figures.

These show in significantly simplified, schematic representation:

FIG. 1 an oblique top view of a first example of an overhead conveying device with a guide rail and a transport carrier mounted thereon;

FIG. 2 the transport carrier from FIG. 1 in a detailed oblique view;

FIG. 3 a section of an overhead conveying device with an inductive energy transmission system in front view;

FIG. 4 an oblique top view of the transport carrier from FIG. 1 on the guide rail near to a diverter in the straight travel position;

FIG. 5 an oblique top view of the transport carrier from FIG. 1 on the guide rail near to a diverter in the diversion travel position;

FIG. 6 a front view of the assembly according to FIG. 4;

FIG. 7 a front view of the assembly according to FIG. 5;

FIG. 8 a section of a further example of an overhead conveying device with chamfered guide rail and conically shaped running wheels of the transport carrier in front view;

FIG. 9 a front view of a further example of an overhead conveying device with an additional feeding device in front view;

FIG. 10 an oblique top view of a further example of an overhead conveying device with a two-part guide rail and a transport carrier mounted thereon;

FIG. 11 the transport carrier from FIG. 10 in a detailed oblique view;

FIG. 12 an oblique top view of the guide rail without the transport carrier in the region of a diverter;

FIG. 13 a detailed oblique top view of the diverter from FIG. 12;

FIG. 14 an oblique bottom view of the guide rail without the transport carrier in the region of the diverter;

FIG. 15 a detailed oblique bottom view of the diverter from FIG. 14;

FIG. 16 an oblique top view of the guide rail without the transport carrier in the region of the diverter during straight travel;

FIG. 17 a front view of the assembly from FIG. 16;

FIG. 18 a detailed view of the front view represented in FIG. 17 in the region of the diverter;

FIG. 19 an oblique top view of the guide rail with the transport carrier in the region of the diverter during diversion travel;

FIG. 20 a front view of the assembly from FIG. 19;

FIG. 21 a detailed view of the front view represented in FIG. 20 in the region of the diverter;

FIG. 22 an oblique top view of a further example of a transport carrier with a hanging article;

FIG. 23 an oblique bottom view of an overhead conveying device with a driving surface and the transport carrier from FIG. 22 adhered thereon;

FIG. 24 an detailed oblique top view of the transport carrier from FIG. 22;

FIG. 25 an detailed oblique bottom view of the transport carrier from FIG. 22;

FIG. 26 a detailed front view representation of the overhead conveying device from FIG. 23;

FIG. 27 an oblique top view of an example of a transport carrier with crawler belts;

FIG. 28 a front view of an overhead conveying device with an example transport carrier and articulated connection to the hanging article;

FIG. 29 an example, electrical block diagram of a transport carrier, and

FIG. 30 a schematic representation of a section of a transport network with a diverter.

### DETAILED DESCRIPTION OF EXEMPLARY EMBODIMENTS

It is worth noting here that the same parts have been given the same reference numerals or same component configurations in the embodiments described differently, yet the disclosures contained throughout the entire description can be applied analogously to the same parts with the same reference numerals or the same component configurations. The indications of position selected in the description, such as above, below, on the side etc. refer to the figure directly described and shown, and can be applied in the same way to the new position should the position change.

### Example Embodiment 1 (Transport Carrier with One-Sided Rail Guidance)

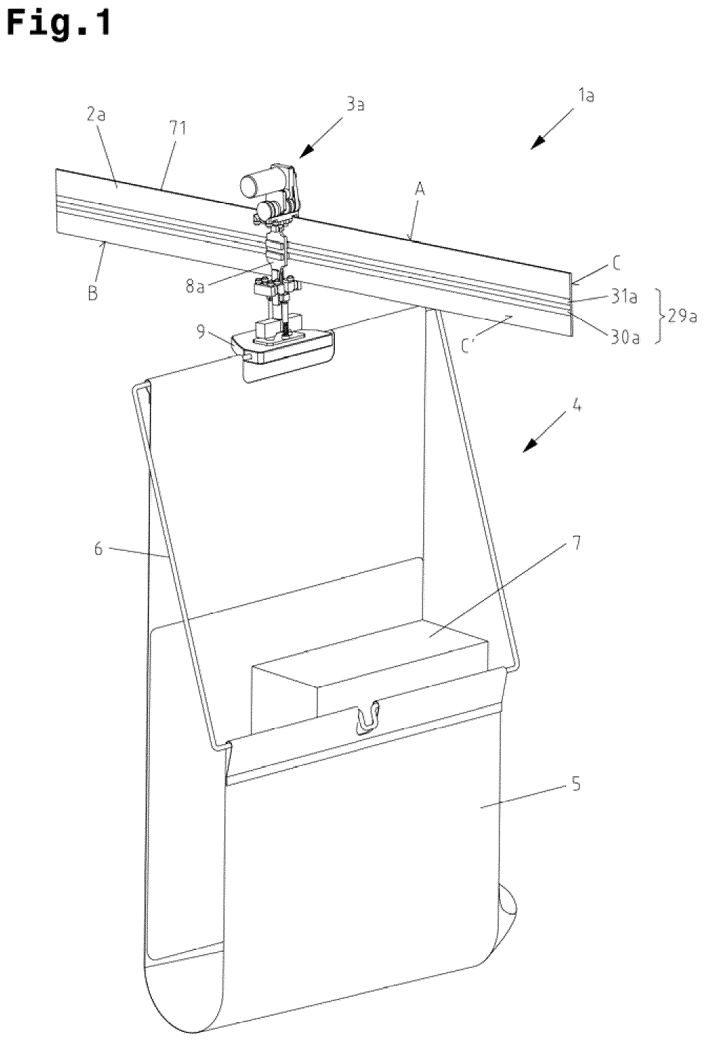

FIG. 1 shows an oblique view of an overhead conveying device 1a for an order-picking system, which comprises a support structure 71 configured as a guide rail 2a with a running surface A extending along the guide rail and a transport carrier 3a for transporting a hanging article. In this example, the hanging article comprises a transport bag with a bag body 5, which is attached to a hanger 6 and is intended for storing an article 7. Alternatively, the hanging article 4 can also be configured by a clothing article which is suspended from the transport carrier 3a by means of a clothes hanger.

The transport carrier 3a can have a base body 8a and a support body 9 with a receiving means for suspending the hanging article 4, as is the case in the example shown in FIG. 1. In this case, the receiving means comprises a fully enclosed receiving means opening to hang the hanger 6 of the hanging article 4 into. Alternatively, an open receiving means section (hook) for hanging a hanger 6 of the hanging article 4 into or onto could be provided. In particular, the support body 9 can be exchangeably fixed to the base body via a connecting device.

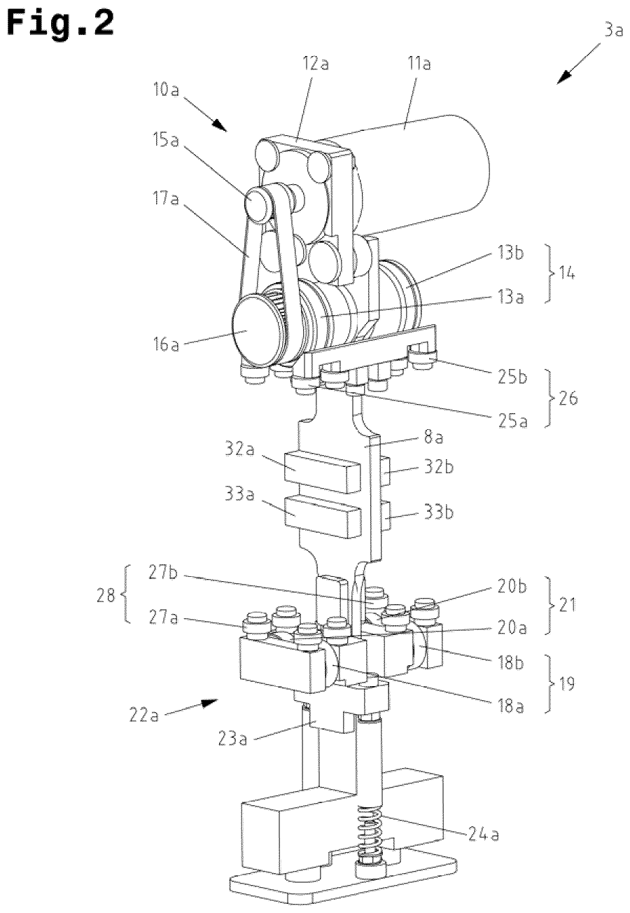

FIG. 2 shows the transport carrier 3a in detail. The transport carrier 3a comprises a base body 8a and a plurality of wheels 13a, 13b, 18a, 18b, 20a, 20b, 25a, 25b, 27a, 27b rotatably mounted thereon. The transport carrier 3a further comprises a drive device 10a for moving the transport carrier 3a along the guide rail 2a. The drive device 10a has an electrically powered motor 11a, which is mounted on the transport carrier 3a. As shown in FIG. 2 by way of example, the motor 11a can be connected to the base body 8a by means of a motor bracket 12a. The motor bracket 12a can in this case also be understood as part of the base body 8a.

At least a wheel of the wheels 13a, 13b, 18a, 18b, 20a, 20b, 25a, 25b, 27a, 27b mounted on the base body 8a is configured as a drive wheel 13a, 13b which is coupled to the motor 11a. In this example, a first drive wheel 13a and a second drive wheel 13b of a drive wheel pair 14 are provided, which are arranged coaxially on a shared drive shaft and are coupled to the motor 11a, in particular via a traction drive of the drive device 10a. The traction drive can, as shown in FIG. 2, comprise a motor pinion 15a, a gear wheel 16a mounted on the drive shaft, and a toothed belt 17a guided around the motor pinion 15a and the gear wheel 16a.

As can be seen in particular in FIG. 1, the first drive wheel 13a can lie on the running surface A in a rollable manner. In other words, the transport carrier 3a is suspended from the guide rail 2a by means of the first drive wheel 13a. The weight of the transport carrier 3a and potentially a weight of the hanging article 4 thus exerts a pressing force of the first drive wheel 13a onto the running surface A, whereby a friction force transferred by means of the first drive wheel 13a is increased.

Preferably, the electrically powered motor 11a is arranged above the drive wheels 13a, 13b on the base body 8a. Furthermore, the electrically powered motor 11a can be arranged above the guide rail 2a when the transport carrier 3a is suspended from the guide rail 2a, as can be seen in particular in FIG. 1. The drive wheels 13a, 13b can thereby be reliably and simply coupled to the electric motor 11a or the motor 11a can be arranged where there is normally sufficient space anyway.

It is advantageous if the guide rail 2a has a counter running surface B extending along it and if at least a wheel of the wheels 13a, 13b, 18a, 18b, 20a, 20b, 25a, 25b, 27a, 27b mounted on the base body 8a is configured as an adjusting wheel 18a, 18b, 20a, 20b and lies on the counter running surface in a rollable manner, as is the case in the example shown in FIGS. 1 and 2. A first adjusting wheel 18a and a second adjusting wheel 18b of a first adjusting wheel pair 19 and a first adjusting wheel 20a and a second adjusting wheel 20b of a second adjusting wheel pair 21 are hereby provided. In the condition represented in FIG. 1, the first adjusting wheel 18a of the first adjusting wheel pair 19 and the first adjusting wheel 20a of the second adjusting wheel pair 21 lie on the counter running surface B in a rollable manner. Guidance of the transport carrier 3a on the guide rail 2a is thereby improved. The counter running surface B advantageously extends with a vertical spacing parallel to the running surface A, as is the case in the example shown. A horizontal spacing between running surface A and counter running surface B would also be possible.

It is also advantageous if the transport carrier 3a has an adjusting device 22a by means of which the adjusting wheels 18a, 18b, 20a, 20b are pressed against the counter running surface B with an adjusting force, as is the case in the example shown in FIGS. 1 and 2. Guidance of the transport carrier 3a on the guide rail 2a is thereby further improved. In addition, a friction force transferred by the drive wheel 13a is also increased. In particular, the weight force caused by the transport carrier 3a, the weight force caused by the hanging article 4, and the adjusting force can act on the drive wheel 13a.

For this purpose, the adjusting device 22a can, as shown by way of example, have a carriage 23a mounted movably on the base body 8a and a holding force generator 24a acting against the carriage 23a, wherein the adjusting wheels 18a, 18b, 20a, 20b are mounted on the carriage 23a. The holding force generator 24a is, for example, configured by a preloaded spring. Fundamentally, however, the use of other force generators would be conceivable, such as the use of a preloaded rubber buffer, a pneumatic spring, a permanent magnet, or an electromagnet. In the example shown in FIG. 2, the carriage 23a is mounted in a vertically displaceable manner on the base body 8a. Alternatively, it would also be conceivable to use a swing arm that is movably (rotatably) mounted on the base body 8a and a force generator acting against the swing arm, wherein the adjusting wheels 18a, 18b, 20a, 20b are mounted on the swing arm.

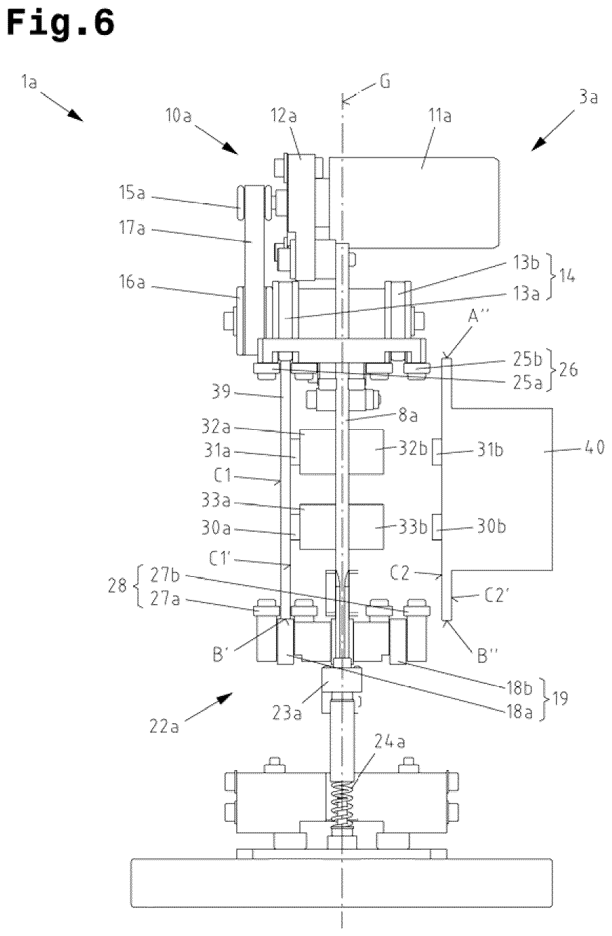

In the transport carrier 3a as shown in FIGS. 1 and 2, some of the wheels 13a, 13b, 18a, 18b, 20a, 20b, 25a, 25b, 27a, 27b mounted on the base body 8a are additionally configured as guide wheels. The transport carrier 3a shown as an example in FIGS. 1 and 2 comprises a plurality, in particular in this context a total of sixteen, guide wheels arranged in pairs, which are each mounted around vertical axles. A plurality of, in particular eight, guide wheels are located in the region of the drive wheels 13a, 13b, of which only two of the former are, however, explicitly shown in FIG. 2, namely the first guide wheel 25a and the second guide wheel 25b of a first guide wheel pair 26. A plurality of, in particular eight, guide wheels are located in the region of the adjusting wheels 18a, 18b, 18b, of which likewise only two of the former are explicitly shown in FIG. 2, namely the first guide wheel 27a and the second guide wheel 27b of a second guide wheel pair 28. The first guide wheels 25a, 27a as well as two further guide wheels, not shown explicitly here, on the outer left of the transport carrier 3a, can, as shown for example in the condition represented in FIG. 1, lie on the first rail guide surface C. Four further, not explicitly shown, first guide wheels on the inner left of the transport carrier 3a, can, as shown for example in the condition represented in FIG. 1, lie on the second rail guide surface C′. The guide wheels 25a, 25b, 27a, 27b reliably prevent a tipping of the transport carrier 3a and a consequential falling down of the same from the guide rail 2a. The guide wheels 25a, 25b, 27a, 27b are preferably arranged symmetrically to a vertical plane G extending in the longitudinal direction of the guide rail 2a, as is shown, for example, in FIGS. 1 and 2 or in FIG. 6.

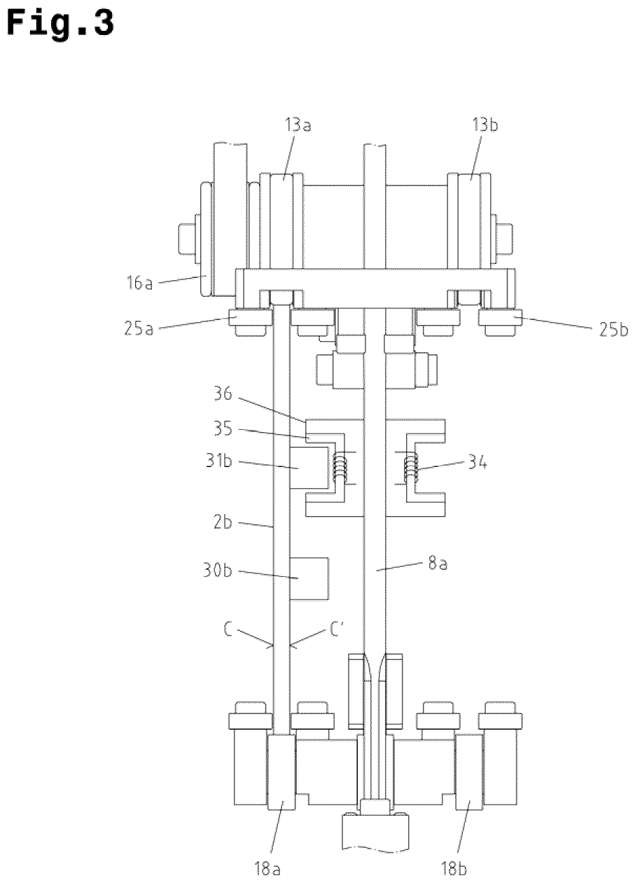

The example overhead conveying device 1a shown in FIGS. 1 and 2 further comprises an optional energy supply system 29a, which has an insulator and exposed electrical conductors 30a, 31a which extend along the guide rail 2a and in this case are fixed to the guide rail 2a. The energy supply system 29a comprises further electrical conductors 30b, 31b, which are, however, not visible in FIG. 1 (but reference is made to FIG. 6). Where such an energy supply system 29a is provided, it is expedient if the transport carrier 3a has current collectors 32a, 33a which are in electrical contact with the electrical conductors and are connected electrically to the motor 11a. The transport carrier 3a can, additionally, have current collectors 32b, 33b, which are alternatively in electrical contact with the further electrical conductors 30b, 31b and are likewise connected electrically to the motor 11a. In this example, the current collectors 32a, 32b, 33a, 33b are configured as sliding contacts which slide/brush on the electrical conductors 30a, 30b, 31a, 31b when the transport carrier 3a moves. The current collectors 32a, 32b, 33a, 33b can, however, be configured in the form of rollers or wheels and lie on the electrical conductors 30a, 30b, 31a, 31b in a rollable manner. In the example shown here, the electrical conductors 30a, 30b, 31a, 31b are fixed to the guide rail 2a. This is, however, not an essential condition; rather, the electrical conductors 30a, 30b, 31a, 31b could also extend at a distance to the guide rail 2a. Instead of a contact-based energy transmission, a contactless energy transmission could also be provided using an inductive energy supply system, as described in the following (see FIG. 3).

Furthermore, it can be provided that the energy supply system 29a is only provided on straight route sections of the guide rail 2a. The energy supply system 29a can thereby be configured more simply.

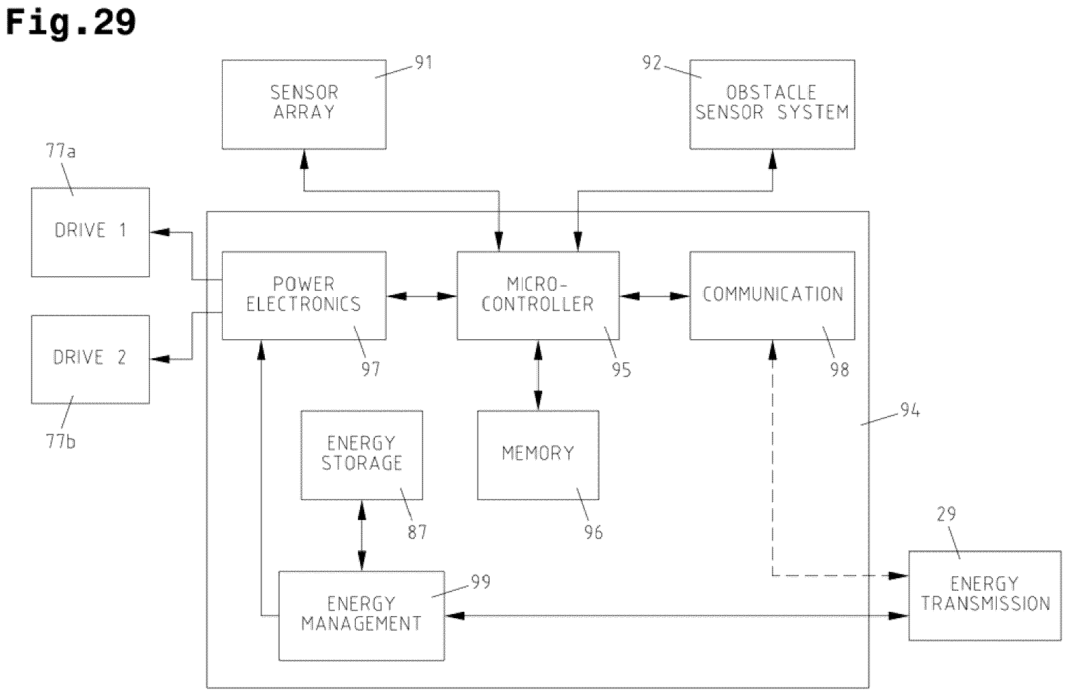

Optionally, on curves and diverters the motor 11a can be supplied from an energy storage (also see FIG. 29 in this regard). This can be provided irrespective of whether the energy supply system 29a is configured for contact-based or, as shown in FIG. 3, contactless energy transmission.

It can thereby be provided that the transport carrier 3a and/or the hanging article 4, in particular the transport bag, has an energy storage connected electrically to the motor 11a or an energy source connected electrically to the motor 11a (not shown in FIGS. 1 and 2). In particular, the motor 11a is connected to the energy storage or the energy source via a switch element or control element. The energy storage can, for example, be configured as a rechargeable battery. The energy source can be configured as a solar module.

Alternatively to the electrical conductors 30a, 30b, 31a, 31b, which as previously described can function as sliding conductors, an inductive energy supply system can be provided along the guide rail 2a, in particular on the guide rail 2a, and the energy transmission to the motor 11a (and where applicable to a charging connection of an energy course connected to the motor 11a) of the transport carrier 3a can be performed inductively, as is the case in the example shown in FIG. 3. FIG. 3 shows a section of a front view of the transport carrier 3a.

In particular, the inductive energy supply system can have one or more electrical conductors 30b, 31b extending parallel to the guide rail 2a, and a coil 34 arranged on the transport carrier 3a can be connected electrically to the motor 11a, wherein the energy transmission to the coil 34 is contactless, as is shown in FIG. 3. Particularly preferably, the transport carrier 3a comprises a ferromagnetic core 35 around which the coil 34 is wrapped and which at least partially surrounds the at least one electrical conductor 31b, as is shown in FIG. 3. In FIG. 3, the ferromagnetic core 35 and the coil 34 are additionally protected by a housing 36. The coil 34, the ferromagnetic core 35, and the housing 36 are not only arranged on the left side of the transport carrier 3a, but also on its right side. In FIG. 3, said components are only explicitly designated with a reference numeral on one side. For example, the ferromagnetic core 35 and the housing 36 are only designated with a reference numeral on the left side and the coil 34 only on the right side.

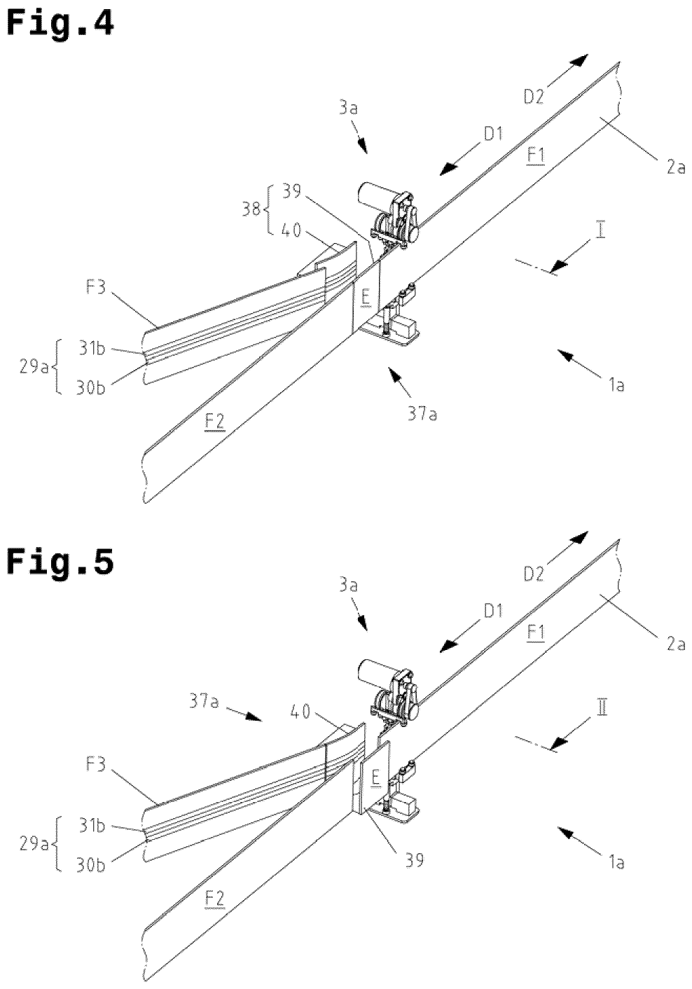

FIGS. 4, 5, 6 and 7 now show the processes in the region of a diverter 37a. Specifically, FIG. 4 shows an oblique view of the transport carrier 3a on the guide rail 2a close to the diverter 37a, wherein initially a first transport direction D1 of the transport carrier 3a is assumed.

The diverter 37a is assigned to a diverter section E of the guide rail 2a. The guide rail 2a additionally comprises a first rail route F1 upstream of the diverter 37a in the first transport direction D1 of the transport carrier and a second rail route F2 and a third rail route F3 downstream of the diverter 37a in the first transport direction D1 of the transport carrier 3a. The diverter 37a has a switchable diverter element 38 that can be switched between a first switch position and a second switch position in order to selectively guide the transport carrier 3a along a first transport path between the first rail route F1 and the second rail route F2, in particular from the first rail route F1 to the second rail route F2, or along a second transport path between the first rail route F1 and the third rail route F3, in particular from the first rail route F1 to the third rail route F3. The transport carrier 3a can thereby be transferred along the first transport path from the first rail route F1 to the second rail route F2, which in the example shown corresponds to the transport carrier 3a travelling straight. Alternatively, the transport carrier 3a can be transferred along the second transport path from the first rail route F1 to the third rail route F3, which in the example shown corresponds to the transport carrier 3a being diverted. For this purpose, the diverter element 38 preferably comprises a first diverter element 39 for the straight travel and a second diverter element 40 for the diversion travel.

The diverter element 38 is configured to be horizontally displaceable, in particular horizontally slidable, in this example. It would, however, also be conceivable that the diverter element 38 is configured to be vertically displaceable and/or pivotable with corresponding construction.

If a second transport direction of the transport carrier 3a is assumed, the conditions are partially inverted. The guide rail 2a then has the first rail route F1 downstream of the diverter 37a in the second transport direction D2 of the transport carrier 3a and the second rail route F2 and third rail route F3 upstream of the diverter 37a in the second transport direction D2 of the transport carrier 3a. In this case, the transport carrier 3a can be selectively guided with the switchable diverter element 38 along a first transport path between the second rail route F2 and the first rail route F1, in particular from the second rail route F2 to the first rail route F1, or along a second transport path between the third rail route F3 and the first rail route F1, in particular from the third rail route F3 to the first rail route F1.

In FIG. 4, the diverter element 38 is in the first switch position for straight travel. In this condition, the first guiding element 39 is activated for straight travel. The second guiding element 40 for diversion travel is, on the contrary, not activated.

In FIG. 5, the diverter element 38 is, by contrast, in the second switch position for diversion travel. In this condition, the second guiding element 40 is activated for diversion travel. The first guiding element 39 for straight travel is, on the contrary, not activated.

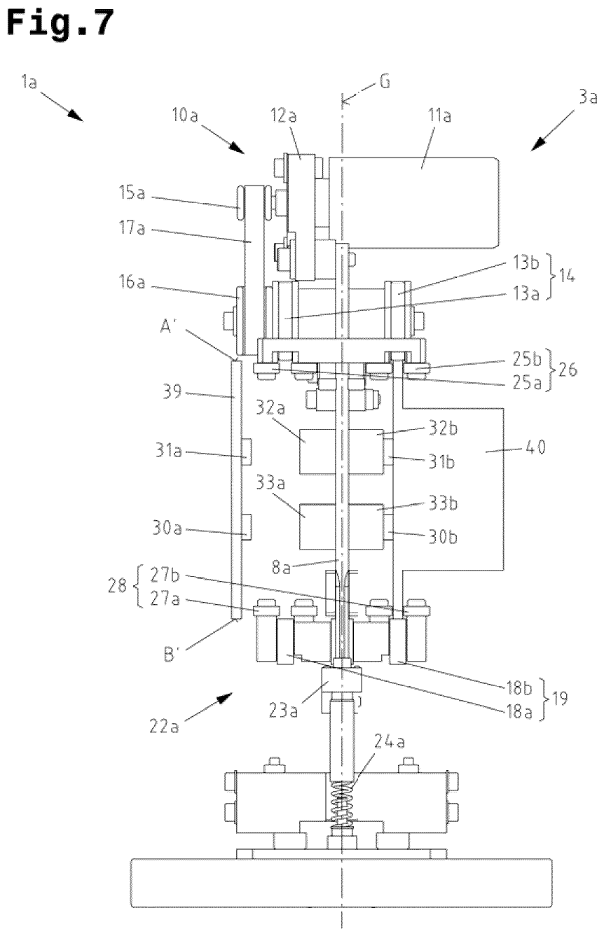

In addition, FIG. 6 shows view I-I and FIG. 7 view II-II.

The diverter element 38 comprises a first running surface A1 and a second running surface A2 as well as a first counter running surface B1 and a second counter running surface B2. The first running surface A1 and the second running surface A2 thereby extend with a horizontal spacing to one another. In addition, the first counter running surface B1 and the second counter running surface B2 extend with a horizontal spacing, in particular the same horizontal spacing as the running surfaces A1, A2, to one another. Furthermore, the running surfaces A1, A2 extend with a vertical spacing and parallel to the counter running surfaces B1, B2.

In the first switch position of the diverter element 38 (see FIG. 6) the first drive wheel 13a of the drive wheel pair 14 lies on the running surface A′ of the first guiding element 39 of the diverter element 38 in a rollable manner and where applicable the first adjusting wheel 18a of the first adjusting wheel pair 19 and the first adjusting wheel 20a of the second adjusting wheel pair 21 lie on the counter running surface B′ of the first guiding element 39 when the transport carrier 3a is moved along the diverter section E.

In the second switch position of the diverter element 38 (see FIG. 7) the second drive wheel 13b of the drive wheel pair 14 lies on the running surface A″ of the second guiding element 40 of the diverter element 38 in a rollable manner and where applicable the second adjusting wheel 18b of the first adjusting wheel pair 19 and the second adjusting wheel 20b of the second adjusting wheel pair 21 lie on the counter running surface B″ of the second guiding element 40 when the transport carrier 3a is moved along the diverter section E.

It can thereby be provided that in the first switch position a first end of the running surface A′ of the first guiding element 39 adjoins the running surface A of the first rail route F1 and a second end of the running surface A′ of the first guiding element 39 adjoins the running surface A of the second rail route F2 and in the second switch position a first end of the running surface A″ of the second guiding element 40 adjoins the running surface A of the first rail route and a second end of the running surface A″ of the second guiding element 40 adjoins the running surface A of the third rail route F3, such that the transport carrier 3a can be selectively transferred from the first rail route F1 to the second rail route F2 or third rail route F3.

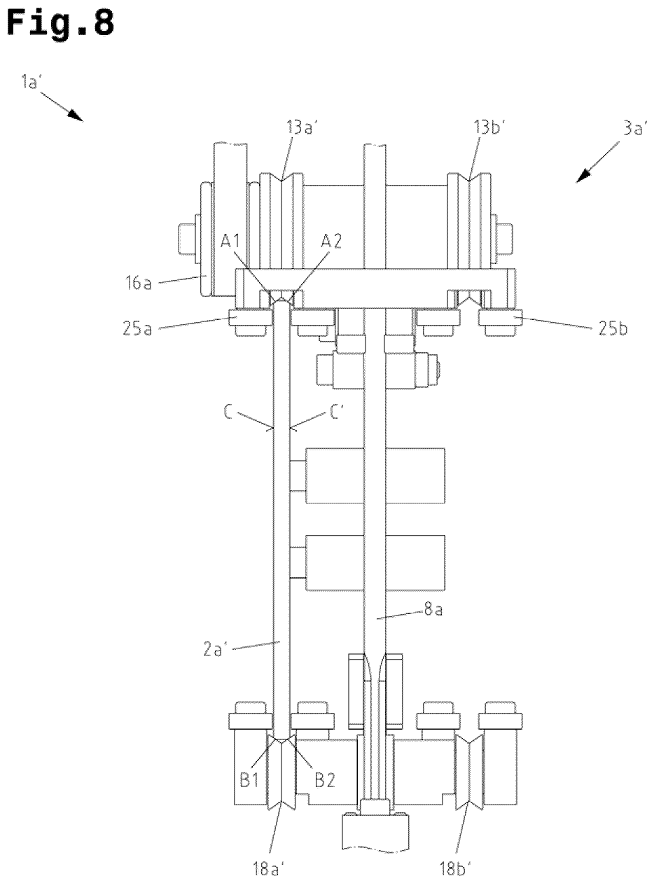

In the case shown in FIGS. 6 and 7, the first guiding element 39 has a running surface A′ and a counter running surface B′, and the second guiding element 40 has a running surface A″ and a counter running surface B″. It would, however, also be conceivable that, analogously to the guide rail 2a′ represented in FIG. 8, the first guiding element 39 and the second guiding element 40 each have two running surfaces A1, A2 and each have two counter running surfaces B1, B2.

It can thereby be provided that in the first switch position a first end of the first running surface A1 of the first guiding element 39 adjoins the first running surface A1 of the first rail route F1 and a second end of the first running surface A1 of the first guiding element 39 adjoins the first running surface A1 of the second rail route F2 and in the second switch position a first end of the first running surface A1 of the second guiding element 40 adjoins the first running surface A1 of the first rail route F1 and a second end of the first running surface A1 of the second guiding element 40 adjoins the first running surface A1 of the third rail route F3, such that the transport carrier 3a can be selectively transferred from the first rail route F1 to the second rail route F2 or the third rail route F3. Equally, in this case in the first switch position a first end of the second running surface A2 of the first guiding element 39 adjoins the second running surface A2 of the first rail route F1 and a second end of the second running surface A2 of the first guiding element 39 adjoins the second running surface A2 of the second rail route F2 and in the second switch position a first end of the second running surface A2 of the second guiding element 40 adjoins the second running surface A2 of the first rail route F1 and a second end of the second running surface A2 of the second guiding element 40 adjoins the second running surface A2 of the third rail route F3, such that the transport carrier 3a can be selectively transferred from the first rail route F1 to the second rail route F2 or the third rail route F3.

The diverter element 38 comprises a plurality of diverter guide surfaces C1, C1′, C2, C2′. In the first switch position of the diverter element 38 (see FIG. 6), the first diverter guide surfaces C1, C1′ of the first guiding element 39 interact with the transport carrier 3a, wherein the transport carrier 3a is guided along a first transport path, in particular straight ahead. Specifically, the first guide wheels 25a, 27a act upon the first diverter guide surfaces C1, C1′. In the second switch position of the diverter element 38 (see FIG. 7), the second diverter guide surfaces C2, C2′ of the second guiding element 40 interact with the transport carrier 3a, wherein the transport carrier 3a is guided along a second transport path. The transport carrier 3a can thus be diverted, for example. Specifically, the second guide wheels 25b, 27b act upon the second diverter guide surfaces C2, C2′.

As can be seen in FIGS. 4 to 7 in particular, the wheels 13a, 13b, 18a, 18b, 20a, 20b, 25a, 25b, 27a, 27b of the transport carrier 3a are configured double and are arranged in pairs symmetrically to the vertical plane G extending in the longitudinal direction of the guide rail 2, wherein in an operating state of the transport carrier 3a one set each of the wheels 13a, 13b, 18a, 18b, 20a, 20b, 25a, 25b, 27a, 27b provided in pairs is engaged with the guide rail 2a.

Furthermore, it is conceivable that in a switch mode of the diverter 37a, one pair each of the wheels 13a, 13b, 18a, 18b, 20a, 20b, 25a, 25b, 27a, 27b provided in pairs on the transport carrier 3a is, or both sets of the wheels 13a, 13b, 18a, 18b, 20a, 20b, 25a, 25b, 27a, 27b provided in pairs on the transport carrier 3a are, temporarily engaged with the diverter element 38. The latter enables a non-interrupted operation of the transport carrier 3a. In the given context, “temporarily” means, in particular, that both sets of wheels 13a, 13b, 18a, 18b, 20a, 20b, 25a, 25b, 27a, 27b are engaged with the diverter element 38 until the drive force can be fully assumed by one set.

It should be noted here that the above description refers in particular to the configuration of the diverter 37a as a right diverter as represented in FIGS. 1 to 9 and that different conditions can apply accordingly when using a left diverter.

### Embodiment Variation 1b (Inclined Running Surfaces)

FIG. 8 now shows a section of a front view of the overhead conveying device 1a′ or of the transport carrier 3a′. The overhead conveying device 1a′ and the transport carrier 3a′ shown in FIG. 8 are configured substantially analogously to the previously described examples. In addition to the previously described features, the guide rail 2a′ and the guiding elements 39, 40 are laterally chamfered at the top and bottom and the drive wheels 13a′, 13b′ and the adjusting wheels 18a′, 18b′ have a double-conical configuration. They could, however, also be formed by positioning two conical gear wheels next to one another.

In this case, the guide rail 2a′ comprises a first running surface A1 and a second running surface A2, wherein the first running surface A1 and the second running surface A2 extend inclined to one another with a mutual horizontal spacing. In this example, the first running surface A1 and the second running surface A2 are arranged symmetrically to a vertical plane extending in the longitudinal direction of the guide rail 2a′. Similarly, a first guiding element 39 and a second guiding element of a diverter element 38 can each have a first running surface A1 and a second running surface A2.

If the drive wheels 13a′, 13b′ are formed by positioning two conical gear wheels next to one another, a wheel of said wheels of the transport carrier 3a′ is then configured as the first drive wheel 13a′ of a first drive wheel pair, wherein the first drive wheel 13a′ comprises a first conical gear wheel and a second conical gear wheel, which are positioned next to one another with a cover surface. The first conical gear wheel of the first drive wheel 13a′ can thereby lie on the first running surface A1 in a rollable manner, and the second conical gear wheel of the first drive wheel 13a′ on the second running surface A2 of the guide rail 2a′, as is shown in FIG. 8, or of the first guiding element 39.

A further wheel of said wheels of the transport carrier 3a′ is thereby configured as the second drive wheel 13b′ of the first drive wheel pair, wherein the second drive wheel 13b′ comprises a first conical gear wheel and a second conical gear wheel, which are positioned next to one another which a cover surface. Where applicable, the first conical gear wheel of the second drive wheel 13b′ can thereby lie on the first running surface A1 in a rollable manner, and the second conical gear wheel of the second drive wheel 13b′ on the second running surface A2 of the guide rail 2a′ or of the second guiding element 40.

The first drive wheel 13a′ and the second drive wheel 13b′ of the first drive wheel pair are thereby arranged coaxially on a first drive shaft coupled to the motor 11a. The drive wheels 13a′, 13b′ can thus each be arranged symmetrically to the vertical plane G extending in the longitudinal direction of the guide rail 2a′.

The first running surface A1 and the second running surface A2 thereby not only have a supporting function, but also act as lateral guide surfaces. Specifically, the first running surface A1 acts as a first lateral guide surface and the second running surface A2 as a second lateral guide surface. This applies both for the guide rail 2a as well as for the first guiding element 39 and the second guiding element 40 of the diverter element 38.

In turn, the transport carrier 3a′ is suspended from the guide rail 2a′ by means of said drive wheels 13a′, 13b′. The drive device 10a can, as previously described, have a traction drive via which said drive wheels 13a′, 13b′ are coupled to the motor 11a.

Furthermore, the guide rail 2a′ has a first counter running surface B1 and a second counter running surface B2, which extend parallel to one another with a mutual horizontal spacing and parallel to the running surface A1, A2 with a vertical spacing. In this example, the first counter running surface B1 and the second counter running surface B2 are arranged symmetrically to the vertical plane G extending in the longitudinal direction of the guide rail 2a′. The first counter running surface B1 and the second counter running surface B2 not only assume the adjusting force, but in this example also act as lateral guide surfaces. Specifically, the first counter running surface B1 acts as a first lateral guide surface and the second counter running surface B2 as a second lateral guide surface. This applies both for the guide rail 2a′ as well as for the first guiding element 39 and the second guiding element 40 of the diverter element 38.

A wheel of said wheels of the transport carrier 3a′ is configured as the first adjusting wheel 18a′ of a first adjusting wheel pair and a further wheel of said wheels of the transport carrier is configured as the second adjusting wheel 18b′ of the first adjusting wheel pair, wherein the first adjusting wheel 18a′ and the second adjusting wheel 18b′ of the first adjusting wheel pair are arranged coaxially on a bearing axle.

If the adjusting wheels 18a′, 18b′ are each formed by positioning two conical gear wheels next to one another, the adjusting wheels 18a′, 18b′ can then be configured as previously described for the drive wheels 13a′, 13b′, wherein the first adjusting wheel 18a′ of the first adjusting wheel pair comprises a first conical gear wheel and a second conical gear wheel, which are positioned next to one another with a cover surface. The first conical gear wheel of the first adjusting wheel 18a′ can thereby lie on the first counter running surface B1 in a rollable manner, and the second conical gear wheel of the first adjusting wheel 18a′ on the second running surface B2 of the guide rail 2a′, as is shown in FIG. 8, or of the first guiding element 39.

The second adjusting wheel 18b′ of the first adjusting wheel pair can likewise comprise a first conical gear wheel and a second conical gear wheel which are positioned next to one another with a cover surface. Where applicable, the first conical gear wheel of the second adjusting wheel 18b′ can thereby lie on the first counter running surface B1 in a rollable manner, and the second conical gear wheel of the second adjusting wheel 18b′ on the second counter running surface B2 of the guide rail 2a′, or of the second guiding element 40. The wheels of the first adjusting wheel pair are configured inversely to the wheels of a second adjusting wheel pair. In other words, the adjusting wheels 18a′, 18b′ are each arranged symmetrically to a vertical plane G extending in the longitudinal direction of the guide rail 2b. Naturally, the use of a second adjusting wheel pair would, again, be possible.

By means of the adjusting device 22a, the first adjusting wheel 18a′ can be pressed with a first adjusting force against the first and/or second counter running surface B1, B2, in particular of the guide rail 2a′, and/or the second adjusting wheel 18b′ can be pressed with a second adjusting force against the first and/or second counter running surface B1, B2, in particular of the guide rail 2a′ or of the second guiding element 40. It can thereby be provided that the first adjusting wheel 18a′ or the second adjusting wheel 18b′ or both adjusting wheels 18a′, 18b′ are pressed against the respective counter running surface B1, B2.

According to this embodiment of the drive wheels 13a′, 13b′ and/or of the adjusting wheels 18a′, 18b′, they have conical running surfaces in order to be rollable on the inclined running surfaces A1, A2 and counter running surfaces B1, B2. This is, however, not a mandatory condition. For example, it would also be conceivable for the drive wheels 13a′, 13b′ and the adjusting wheels 18a′, 18b′ to have a cylindrical configuration and correspondingly inclined axes of rotation.

### Further General Remarks Relating to Embodiment Variations 1 and 1b

As can be seen from the figures, the transport carrier 3a, 3a′, the guide rail 2a, 2a′ and the diverter 37a have lateral guide elements which are provided with mutually complementarily configured lateral guide surfaces in order to limit a movement of the transport carrier 3a, 3a′ transversely to the longitudinal extension of the guide rail 2a, 2a′ and thus guide the transport carrier 3a, 3a′ during the transport movement along the longitudinal extension of the guide rail 2a, 2a′.

For example, the running surfaces A1, A2 and/or the counter running surfaces B1, B2 on the guide rail 2a, 2a′ and/or on the diverter 37a can each have, as a lateral guide element, a special or adjoining lateral guide surface. In particular, for this purpose the first running surface A1 and/or the second running surface A2 or the first counter running surface B1 and/or the second counter running surface B2 can, as previously described, extend inclined to one another along the guide rail 2a, 2a′ and/or the diverter 37a, as is the case in the embodiment represented in FIG. 8.

In addition, it is conceivable that the drive wheels 18a, 18b, 18a′, 18b′ of the transport carrier 3a, 3a′ each have a lateral guide surface as a lateral guide element. In the represented examples, this is achieved by a collar on both sides of the drive wheels 18a, 18b, or by a conical configuration of the drive wheels 18a′, 18b′, as shown in FIG. 8, for instance.

Fundamentally, the guide wheels 25a, 25b, 27a, 27b and the rail guide surfaces C, C′ as well as the diverter guide surfaces C1, C1′, C2, C2′ can be understood as lateral guide elements or lateral guide surfaces.

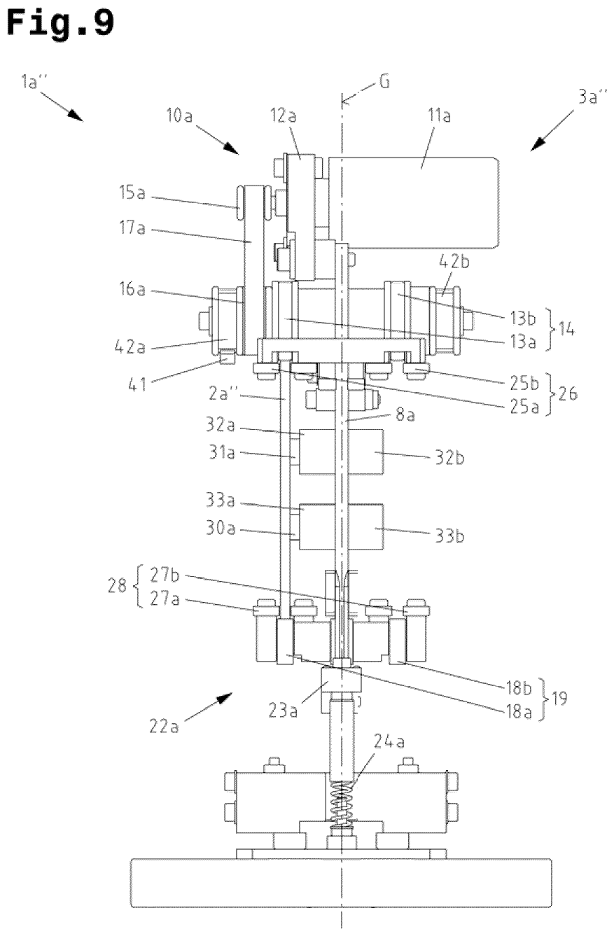

FIG. 9 now shows a front view of the overhead conveying device 1a″ or of the transport carrier 3a″, which has or can have substantially the same construction as previously described in relation to FIGS. 1 to 8. In addition, the overhead conveying device 1a″ comprises a rack 41 extending parallel to the guide rail 2a″ and the transport carrier 3a″ comprises a first gear wheel 42a which meshes with the rack 41 and is coupled to the motor 11a. The transport carrier 3a″ can additionally comprise a second gear wheel 42b opposite, which is, however, not engaged with a rack 41 in the condition shown in FIG. 9. The rack 41 and the gear wheels 42a, 42b can be understood as part of a feeding device.

In particular, the feeding device is assigned to a transport section of the guide rail 2a″, which extends between a first height level and a second height level, in particular from the first height level to the second height level. The transport carrier 3a″ can thereby be brought over the transport section from the first height level to the second height level The second height level is preferably different to the first height level. In the transport section, the feeding device can interact with the transport carrier 3a″ such that at least during the transport movement between the different height levels a feeding force can be applied to the transport carrier 3a″ by the feeding device. Due to the feeding device, greater drive forces can be transmitted, whereby the transport carrier 3a″ can move upwards or downwards even in relatively steep transport sections. The feeding force can act in addition to the drive force. Alternatively, it is conceivable that the drive is deactivated in the transport section and only the feeding force acts upon the transport carrier 3a″.

It is advantageous if the drive wheels 13a, 13b and the gear wheels 42a, 42b are coupled to one another. In particular, the drive wheels 13a, 13b and the gear wheels 42a, 42b can be coupled to one another in a torque-proof manner. Furthermore, the drive wheels 13a, 13b and the gear wheels 42a, 42b can be fixed on a shared drive shaft and be arranged with an axial offset to one another, as is the case in the example shown in FIG. 9.

Alternatively, the feeding device can, for example, also be configured by a bolt which is fixed to a traction drive extending parallel to the guide rail 2a″ and which can positively engage the transport carrier 3a″.

### Example Embodiment 2 (Transport Carrier with Two-Sided Rail Guidance)

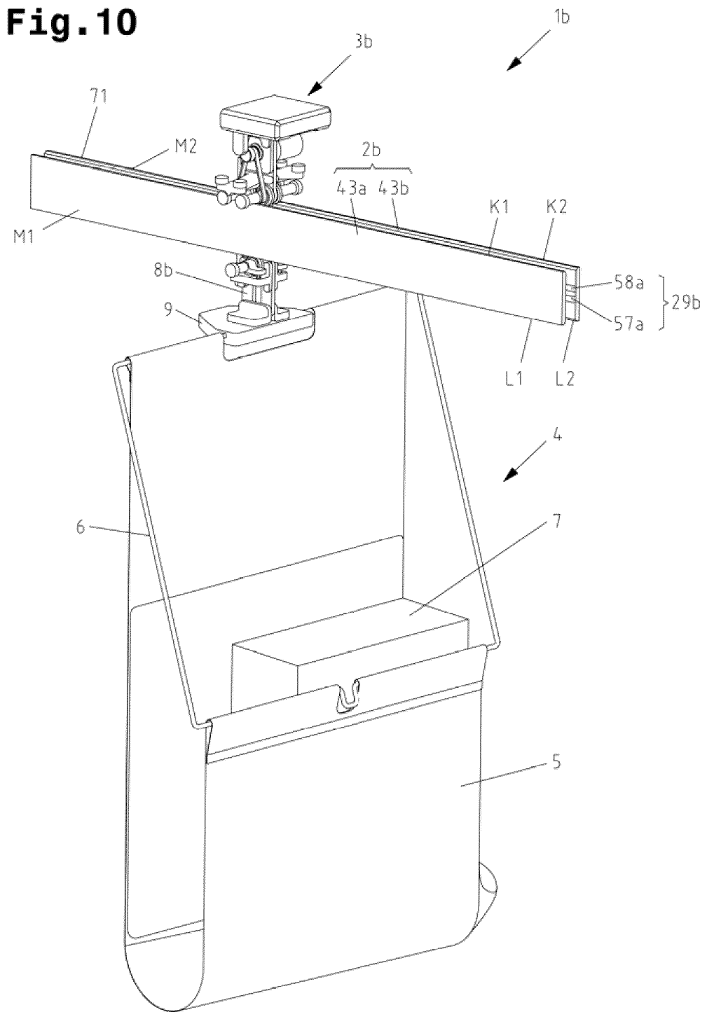

FIG. 10 shows an oblique view of a second embodiment of an overhead conveying device 1b for an order-picking system, which comprises a support structure 71 configured as a guide rail 2b and a transport carrier 3b for transporting a hanging article 4. The guide rail 2b is in two parts and comprises a first partial guide rail 43a with a first running surface K1 and a second partial guide rail 43b with a second running surface K2. In this example, the hanging article 4 again comprises a transport bag with a bag body 5, which is attached to a hanger 6 and is intended for storing an article 7. Alternatively, the hanging article 4 can again also be configured by a clothing article which is suspended from the transport carrier 3b by means of a clothes hanger.

Specifically, the transport carrier 3b can again have a base body 8b and a support body 9 with a receiving means for suspending the hanging article 4, as has previously been described in relation to the first embodiment variation and is the case in the example shown in FIG. 10. In this case, the receiving means comprises a fully enclosed receiving means opening to hang the hanger 6 of the hanging article 4 into. Alternatively, an open receiving means section (hook) for hanging a hanger 6 of the hanging article 4 into or onto could be provided. In particular, the support body 9 can be exchangeably fixed to the base body 8b via a connecting device.

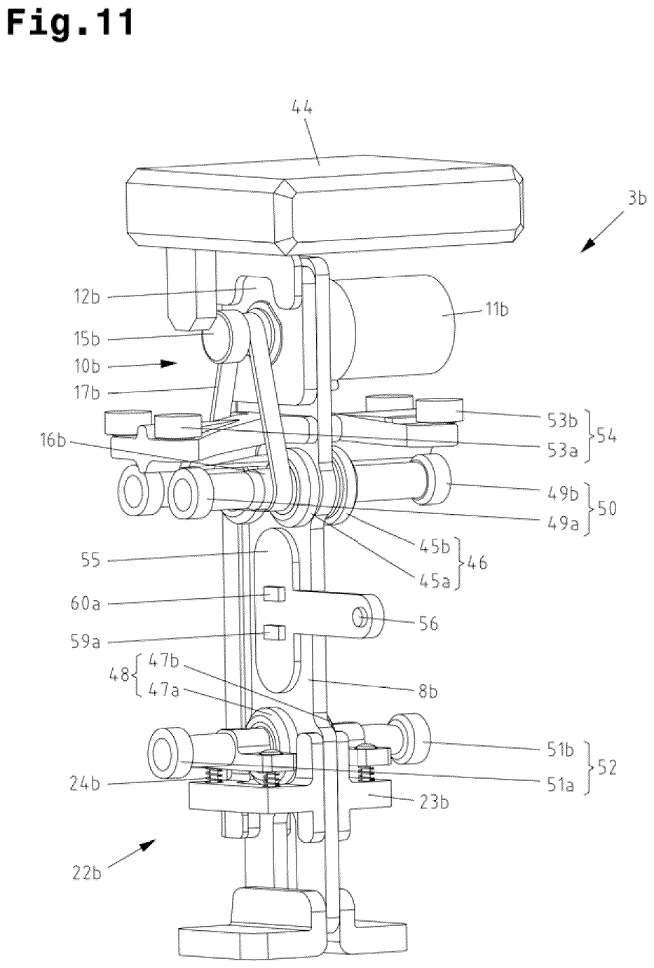

FIG. 11 now shows the transport carrier 3b in detail. The transport carrier 3b comprises a base body 8b and a plurality of wheels 45a, 45b, 47a, 47b, 49a, 49b, 51a, 51b, 53a, 53b rotatably mounted thereon. The transport carrier 3b further comprises a drive device 10b for moving the transport carrier 3b along the guide rail 2b. The drive device 10b has an electrically powered motor 11b, which is mounted on the transport carrier 3b. The motor 11b is preferably connected to the base body 8b via a motor bracket 12b. The motor bracket 12b can thereby also be understood as part of the base body 8b.

At least a wheel of the wheels 45a, 45b, 47a, 47b, 49a, 49b, 51a, 51b, 53a, 53b mounted on the base body 8b is configured as a drive wheel which is coupled to the motor 11b. In this example, a first drive wheel 45a and a second drive wheel 45b of a first drive wheel pair 46 are provided, which are arranged coaxially on a shared drive shaft and are coupled to the motor 11b, in particular via a traction drive of the drive device 10b. The traction drive preferably comprises a motor pinion 15b, a gear wheel 16b mounted on the drive shaft, and a toothed belt 17b guided around the motor pinion 15b and the gear wheel 16b. Furthermore, a first drive wheel and a second drive wheel of a second drive wheel pair, not shown explicitly in FIG. 11, can be provided, which are arranged coaxially on a shared second drive shaft and are likewise coupled to the motor 11b via the traction drive of the drive device 10b.

The drive wheels 45a, 45b can thereby, where applicable, be configured as previously described in relation to the first embodiment variation. In particular, the drive wheels 45a, 45b can be configured as previously described in relation to FIG. 8 by positioning two conical gear wheels next to one another.

As can be seen from FIG. 10 in particular, the drive wheels 45a, 45b of the first drive wheel pair 46 and the drive wheels of the second drive wheel pair lie on the running surfaces K1, K2 in a rollable manner. In other words, the transport carrier 3b is suspended from the guide rail 2b by means of the first drive wheel pair 46 and by means of the second drive wheel pair. The weight of the transport carrier 3b and potentially a weight of the hanging article 4 thus exerts a pressing force of the first drive wheel pair 46 and of the second drive wheel pair onto the running surfaces K1, K2, whereby a friction force transferred by means of the first drive wheel pair 46 and by means of the second drive wheel pair is increased.

In this example, the electrically powered motor 11b is arranged above the drive wheels 45a, 45b on the base body 8b. Furthermore, the electrically powered motor 11b is preferably arranged above the guide rail 2b when the transport carrier 3b is suspended from the guide rail 2b. The drive wheels 45a, 45b can thereby be reliably and simply coupled to the electric motor 11b or the motor 11b can be arranged where there is normally sufficient space anyway.

It is advantageous if the first partial guide rail 43a has a first counter running surface L1 extending along it and the second partial guide rail 43b has a second counter running surface L2 extending along it and if at least a wheel of the wheels 45a, 45b, 47a, 47b, 49a, 49b, 51a, 51b, 53a, 53b mounted on the base body 8b is configured as an adjusting wheel and lies on the counter running surfaces L1, L2 in a rollable manner, as is the case in the example shown in FIGS. 10 and 11. In particular, in this example a first adjusting wheel 47a and a second adjusting wheel 47b of a (first) adjusting wheel pair 48 are provided, which are arranged coaxially on a bearing axle. The first adjusting wheel 47a thereby lies on the first counter running surface L1 in a rollable manner and the second adjusting wheel 47b lies on the second counter running surface L2 in a rollable manner. Guidance of the transport carrier 3b on the guide rail 2b is thereby improved. The counter running surfaces L1, L2 advantageously extend with a vertical spacing parallel to the running surfaces K1, K2, as is the case in the example shown. A horizontal spacing between the running surfaces K1, K2 and the counter running surfaces L1, L2 is also possible.

Similarly, the running surfaces K1, K2 and/or the counter running surfaces L1, L2 can be configured as previously described in relation to the first embodiment variation. In particular, the running surfaces K1, K2 and/or the counter running surfaces L1, L2 can have a first and second lateral guide surface or act as such, as previously described in relation to FIG. 8.

It is also advantageous if the transport carrier 3b has an adjusting device 22b by means of which the adjusting wheels 47a, 47b are pressed against the counter running surfaces L1, L2 with an adjusting force, as is the case in the example shown in FIGS. 10 and 11. It is expedient if the first adjusting wheel 47a is pressed against the first counter running surface L1 by the adjusting device 22b with a first adjusting force and/or the second adjusting wheel 47b is pressed against the second counter running surface L2 by the adjusting device 22b with a second adjusting force. Guidance of the transport carrier 3b on the guide rail 2b is thereby further improved. In addition, a friction force transferred by the drive wheels 45a, 45b is also increased. In particular, the weight force caused by the transport carrier 3b, the weight force caused by the hanging article 4, and the adjusting force can act on the drive wheels 45a, 45b.

For this purpose, in this example the adjusting device 22b has a carriage 23b mounted movably on the base body 8b and a holding force generator 24b acting against the carriage 23b, wherein the adjusting wheels 47a, 47b are mounted on the carriage 23b. In this example, the holding force generator 24b is configured by a preloaded spring. Fundamentally, however, the use of other force generators would be conceivable, such as the use of a preloaded rubber buffer, a pneumatic spring, a permanent magnet, or an electromagnet. In the example shown in FIG. 11, the carriage 23b is mounted in a vertically displaceable manner on the base body 8b. Alternatively, it would also be conceivable to use a swing arm that is movably (rotatably) mounted on the base body 8b and a force generator acting against the swing arm, wherein the adjusting wheels 47a, 48b are mounted on the swing arm.

According to the example shown, a wheel of said wheels 45a, 45b, 47a, 47b, 49a, 49b, 51a, 51b, 53a, 53b of the transport carrier 3b can additionally be configured as the first support wheel 49a of a first support wheel pair 50 and a further wheel of said wheels 45a, 45b, 47a, 47b, 49a, 49b, 51a, 51b, 53a, 53b of the transport carrier 3b as the second support wheel 49b of the first support wheel pair 50, which are arranged coaxially on the first drive shaft coupled to the motor 11b on either side of the first drive wheel pair 46. In addition, further wheels, not explicitly assigned a reference numeral, of the transport carrier 3b are configured as the first support wheel and second support wheel of a second support wheel pair, which are arranged coaxially on the second drive shaft coupled to the motor 11b on either side of the second drive wheel pair. In the example shown, the support wheels 49a, 49b of the first support wheel pair 50 and the support wheels of the second support wheel pair are mounted movably in relation to the respective drive shaft and are thus not driven. It would, however, also be conceivable that the support wheels 49a, 49b of the first support wheel pair 50 and the support wheels of the second support wheel pair are mounted in a torque-proof manner to the respective drive shaft and are thus driven.

Furthermore, in this example a wheel of said wheels 45a, 45b, 47a, 47b, 49a, 49b, 51a, 51b, 53a, 53b of the transport carrier 3b is configured as the first additional adjusting wheel 51a of a first additional adjusting wheel pair 52 and a further wheel of said wheels 45a, 45b, 47a, 47b, 49a, 49b, 51a, 51b, 53a, 53b of the transport carrier 3b as the second additional adjusting wheel 51b of the additional adjusting wheel pair 52, which are arranged coaxially on the first bearing axle on either side of the first adjusting wheel pair 48. In the example shown, the additional adjusting wheels 51a, 51b are mounted movably in relation to the first bearing axle of the first adjusting wheel pair 48 and can thus rotate relatively thereto. It would, however, also be conceivable that the additional adjusting wheels 51a, 51b are connected in a torque-proof manner with the first bearing axle of the first adjusting wheel pair 48 and can therefore not rotate relative thereto.

In the transport carrier 3b as shown in FIGS. 10 and 11, some of the wheels 45a, 45b, 47a, 47b, 49a, 49b, 51a, 51b, 53a, 53b mounted on the base body 8b are additionally configured as guide wheels. In particular, a wheel of said wheels 45a, 45b, 47a, 47b, 49a, 49b, 51a, 51b, 53a, 53b of the transport carrier 3b is configured as the first guide wheel 53a of a first guide wheel pair 54 and a further wheel of said wheels 45a, 45b, 47a, 47b, 49a, 49b, 51a, 51b, 53a, 53b of the transport carrier 3b as the second guide wheel 53b of the first guide wheel pair 54. In addition, further wheels, not explicitly assigned reference numerals, of the transport carrier 3b are configured as the first guide wheel and second guide wheel of a second guide wheel pair. The guide wheels 53a, 53b of the first guide wheel pair 54 and the guide wheels of the second guide wheel pair are thereby each mounted around vertical axles.

The transport carrier 3b further has an optional lighting element 56 fixed to a lighting element bracket 55, the function of former being explained later together with the description of the controls of the transport carrier 3b.

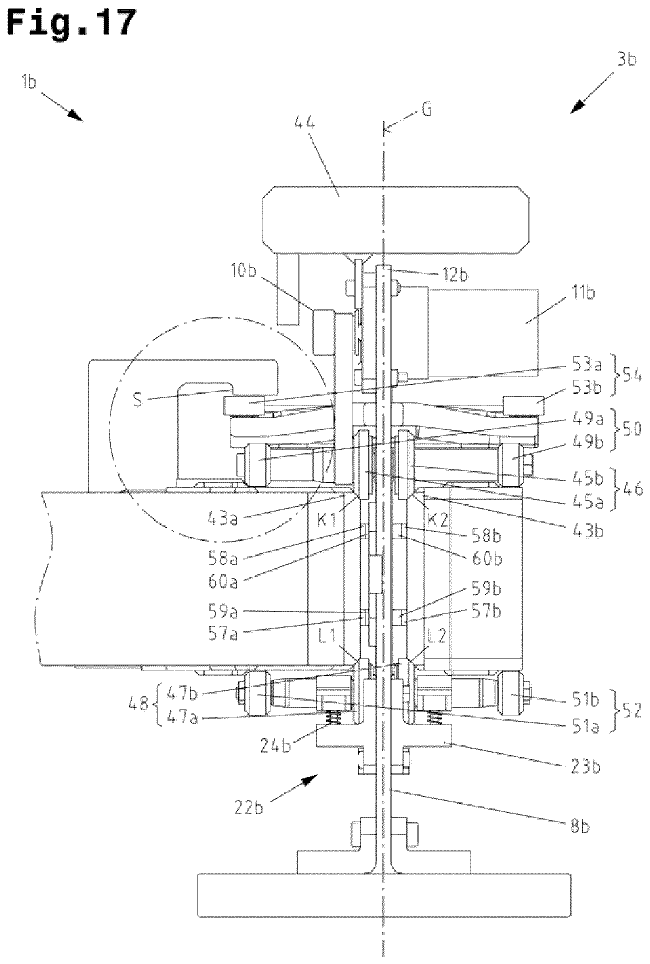

The example overhead conveying device 1b shown in FIG. and 10 further comprises an optional energy supply system 29b, which has an insulator and exposed electrical conductors 57a, 58a which extend along the guide rail 2b and in this case are fixed to the guide rail 2b (specifically on the second partial guide rail 43b). The energy supply system 29b comprises further electrical conductors 57b, 58b on the first partial guide rail 43a, which are, however, not visible in FIG. 10 (but reference is made to FIG. 17). In addition, the transport carrier 3b has current collectors 59a, 60a, which are in electrical contact with the electrical conductors 57a, 58a and are connected electrically to the motor 11b. In addition, the transport carrier 3b has current collectors 59b, 60b, which are in electrical contact with the electrical conductors 57b, 58b and are likewise connected electrically to the motor 11b. In this example, the current collectors 59a, 59b, 60a, 60b are configured as sliding contacts which slide/brush on the electrical conductors 57a, 57b, 58a, 58b when the transport carrier 3b moves. The current collectors 59a, 59b, 60a, 60b can, however, be configured in the form of wheels or rollers and lie on the electrical conductors 57a, 57b, 58a, 58b in a rollable manner. In the example shown, the electrical conductors 57a, 57b, 58a, 58b are fixed to the guide rail 2b. This is, however, not an essential condition; rather, the electrical conductors 57a, 57b, 58a, 58b could also extend at a distance to the guide rail 2b. Instead of a contact-based energy transmission, a contactless energy transmission could also be provided using an inductive energy supply system. Reference is hereby made to FIG. 3 and the technical teaching disclosed therein, which is also applicable to the embodiment variation disclosed in FIGS. 10 and 11 in an analogous and unrestricted manner.

As previously described, it can also be provided here that the energy supply system 29b is only provided on straight route sections of the guide rail 2b. The energy supply system 29b can thereby be configured more simply. For example, on curves and diverters, the motor 11b can be supplied from an energy storage (see FIG. 29).

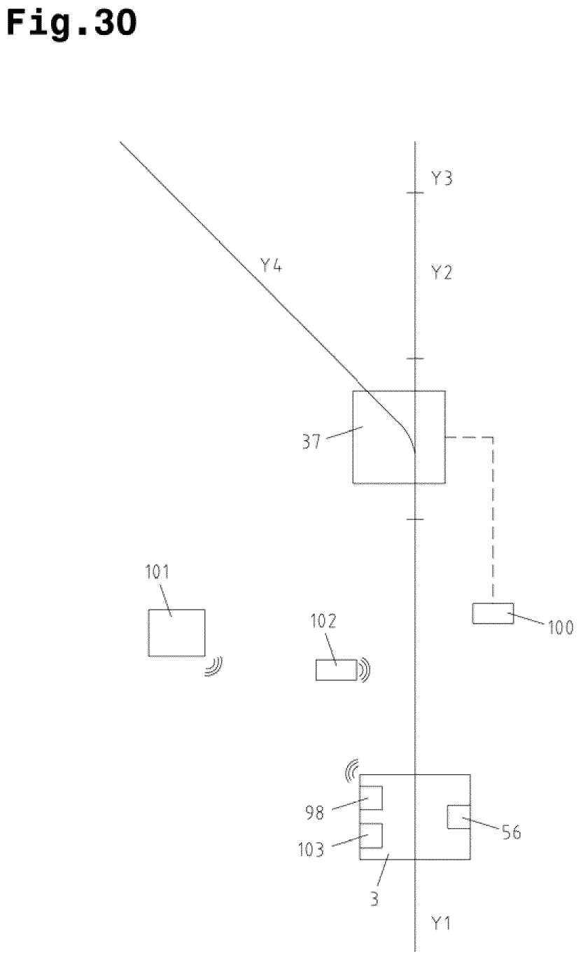

Furthermore, it can be provided that the transport carrier 3b and/or the hanging article 4, in particular the transport bag, have an energy storage connected electrically to the motor 11b and/or an energy source connected electrically to the motor 11b, which is indeed not explicitly shown in FIGS. 10 and 11, but can nevertheless be arranged in or on the housing 44 of a control unit, wherein the control unit can be structured in particular in the manner of the control unit 94 shown in FIG. 29 and/or can assume the functions described in connection with claims 86 to 117 or in connection with FIGS. 29 and 30. In particular, the motor 11b is connected to the energy storage/energy source via a switch element or control element. The energy storage can, for example, be configured as a rechargeable battery, the energy source as a solar module.

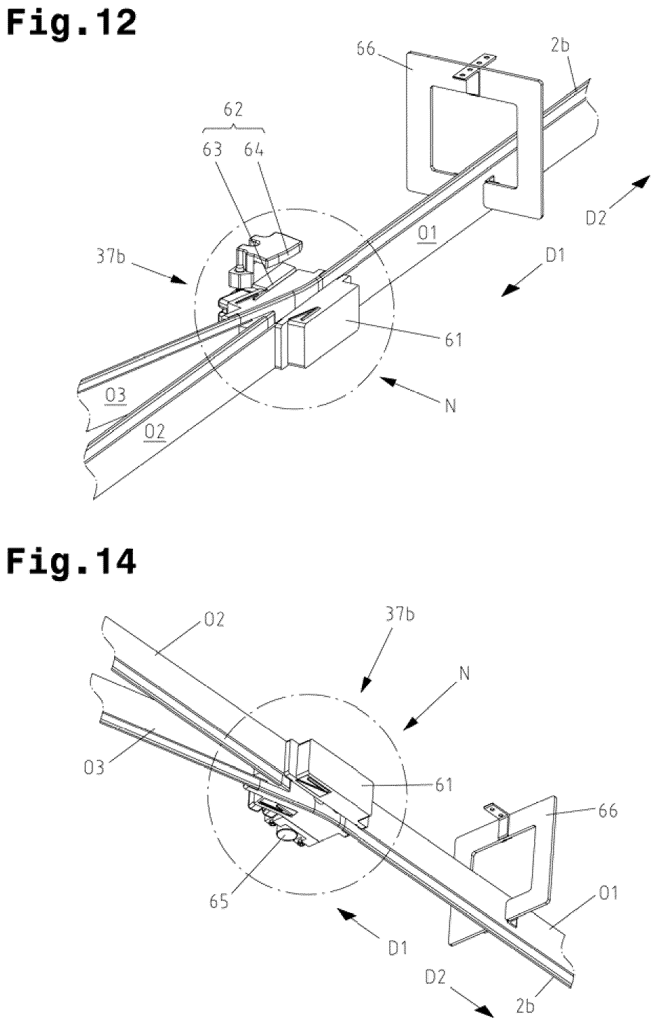

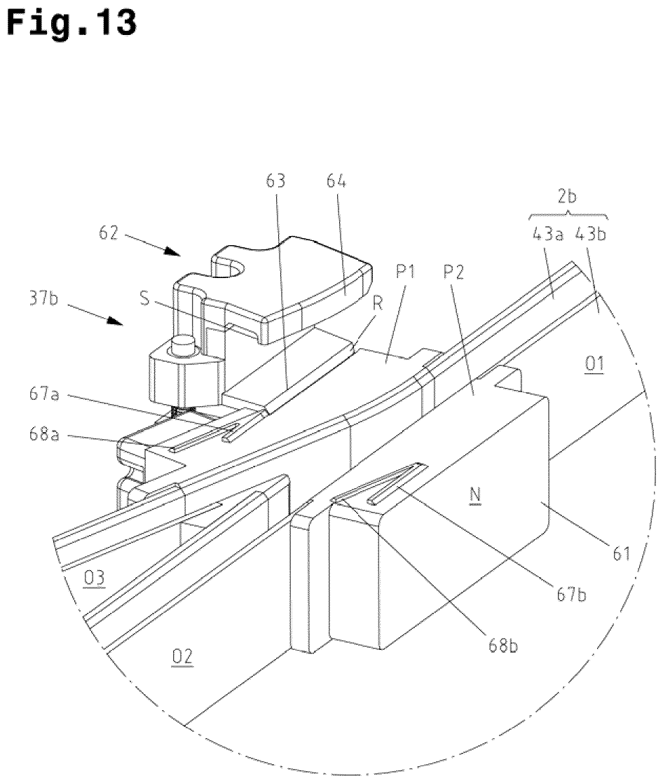

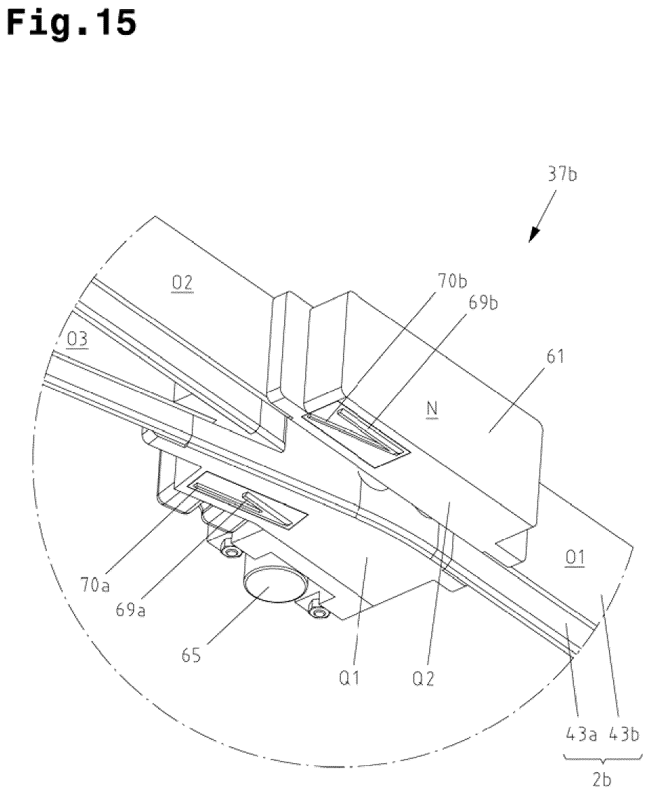

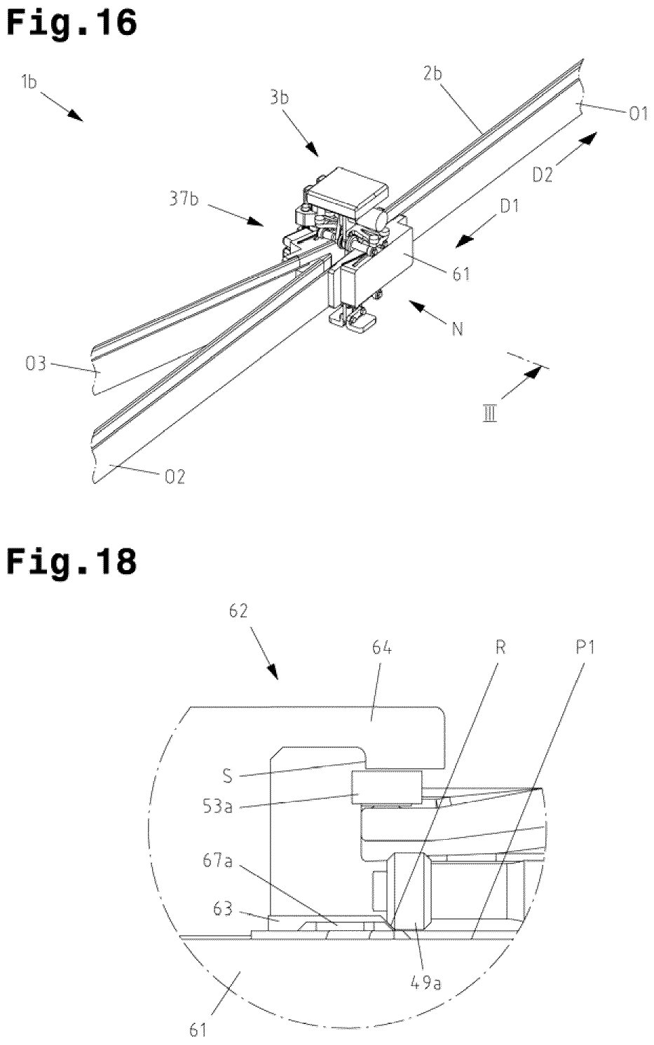

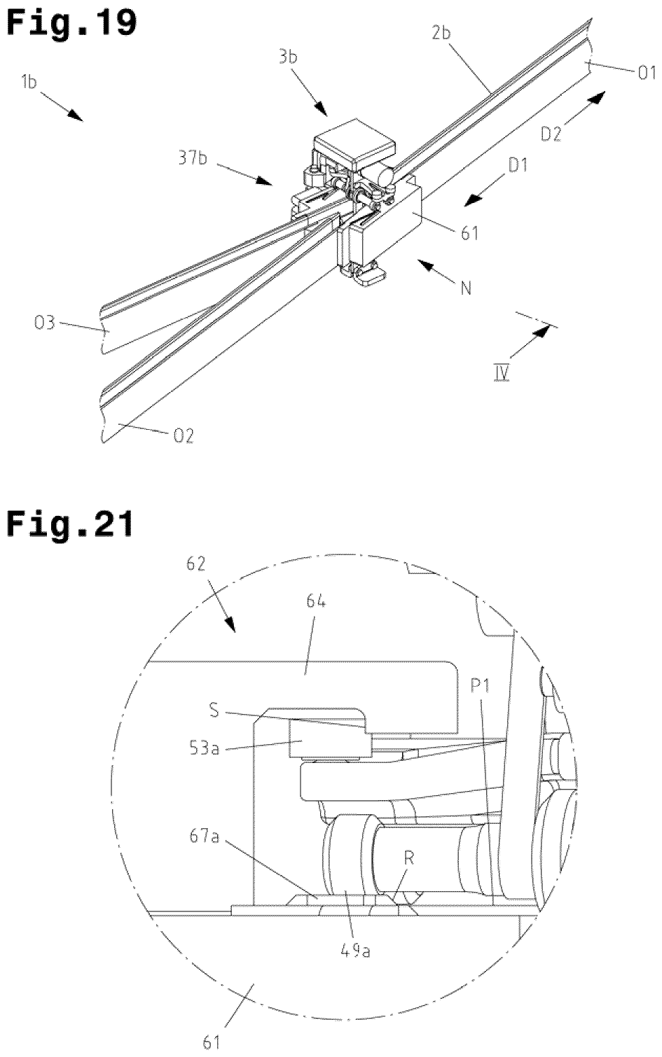

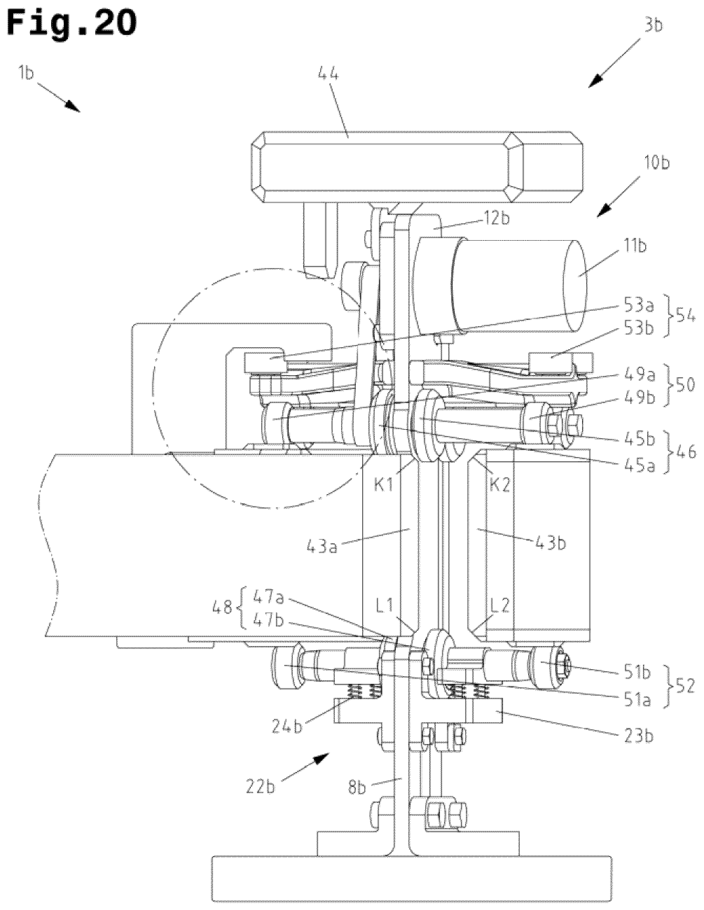

FIGS. 12 to 21 now show the processes in the region of a diverter 37b. Specifically, FIG. 12 shows an oblique top view of the guide rail 2b without the transport carrier 3b in the region of the diverter 37b, FIG. 13 shows a detailed oblique top view of the diverter 37b, FIG. 14 shows an oblique bottom view of the guide rail 2b without the transport carrier 3b in the region of the diverter 37b, FIG. 15 shows a detailed bottom view of the diverter 37b, FIG. 16 shows an oblique top view of the guide rail 2b including the transport carrier 3b in the region of the diverter 37b during straight travel, FIG. 17 shows a front view of the transport carrier 3b in the region of the diverter 37b during straight travel (i.e., view III-III), FIG. 18 shows a detailed front view of the front view shown in FIG. 17 in the region of the diverter 37b, FIG. 19 shows an oblique top view of the guide rail including the transport carrier 3b in the region of the diverter 37b during diversion travel, FIG. 20 shows a front view of the transport carrier 3b in the region of the diverter 37b during diversion travel (i.e., view IV-IV), and FIG. 21 shows a detailed front view shown in FIG. 20 in the region of the diverter 37b.

The diverter 37b is assigned to a diverter section N of the guide rail 2b. The guide rail 2b additionally comprises a first rail route O1 upstream of the diverter 37b in the first transport direction D1 of the transport carrier and a second rail route O2 and a third rail route O3 downstream of the diverter 37b in the first transport direction D1 of the transport carrier 3b. The diverter 37b has a base body 61 as well as a diverter element 62 which is mounted in or on the base body 61 and can be switched between a first switch position and a second switch position. By means of the diverter element 62, the transport carrier 3b can be guided selectively along a first transport path between the first rail route O1 and the second rail route O2, in particular from the first rail route O1 to the second rail route O2, or along a second transport path between the first rail route O1 and the third rail route O3, in particular from the first rail route O1 to the third rail route O3. In the example shown, the first transport path thus equates to straight travel and the second transport path to diversion travel. In this example, the diverter element 61 therefore comprises a first diverter element 63 for straight travel and a second diverter element 64 for diversion travel.

The diverter element 62 is configured to be vertically displaceable, in particular vertically slidable, in this example. It would, however, also be conceivable that the diverter element 62 is configured to be horizontally displaceable and/or pivotable with corresponding construction. The displacement of the diverter element 62 is performed by the drive 65 (see in particular FIG. 14).

In addition, a guide rail bracket 66 is represented by way of example in FIGS. 12 and 14.

If a second transport direction D2 of the transport carrier 3b is assumed, the conditions are partially inverted. The guide rail 2b then has the first rail route O1 downstream of the diverter 37b in the second transport direction D2 of the transport carrier 3b and the second rail route O2 and third rail route O3 upstream of the diverter 37b in the second transport direction D2 of the transport carrier 3b. In this case, the transport carrier 3b can be selectively guided by the switchable diverter element 62 along a first transport path between the second rail route O2 and the first rail route O1, in particular from the second rail route O2 to the first rail route O1, or along a second transport path between the third rail route O3 and the first rail route O1, in particular from the third rail route O3 to the first rail route O1.

The diverter element 62, here in particular the first guiding element 63, additionally comprises a first diverter guide surface R, which in the (upper) first switch position of the diverter element 62 acts upon a support wheel 49a, 49b of the first support wheel pair 50 and, as in the present example, on a support wheel of the second support wheel pair, wherein the transport carrier 3b is guided along the first transport path (corresponding to straight travel). In the (lower) second switch position of the diverter element 62, the first diverter guide surface R does not, by contrast, interact with the transport carrier 3b and is thus ineffective. The transport carrier 3b and then be moved along the second transport path unhindered.

The diverter element 62, here in particular the second guiding element 64, additionally comprises a second diverter guide surface S (diversion surface), which in the (upper) first switch position of the diverter element 62 does not interact with the transport carrier 3b, wherein the transport carrier 3b can be moved along the first transport path (corresponding to straight travel). In the (lower) second switch position of the diverter element 62, the second diverter guide surface S (diversion surface) does, by contrast, interact with the guide wheel 53a, 53b of the first guide wheel pair 54 and, as in the present example, with a guide wheel of the second guide wheel pair, whereby the transport carrier 3b is guided along the second transport path. The transport carrier 3b can thus be diverted, for example.

In FIGS. 12, 13, 16, 17 and 18, the diverter element 62 is in the first (upper) switch position for straight travel. In this condition, the first diverter guide surface R is activated for straight travel. The second diverter guide surface S for diversion travel is, on the contrary, not activated.

In FIGS. 19 to 21, the diverter element 62 is, by contrast, in the second (lower) switch position for diversion travel. In this condition, the second diverter guide surface S is activated for diversion travel. The first diverter guide surface R for straight travel is, by contrast, not activated.

The diverter base body 61 comprises an upper side, a lower side, and a first passage channel (in this example for straight travel) extending from the upper side to the lower side and along a first transport path, to which at one end of the passage channel the first rail route O1 adjoins and at an opposite, further end of the passage channel the second rail route O2 adjoins. Furthermore, the diverter base body 61 comprises a second passage channel (in this example for diversion travel) extending from the upper side to the lower side and along a second transport path, which at one end of the second passage channel leads into the first passage channel and at an opposite, further end of the second passage channel adjoins to the third rail route O3.

A first running surface K1 and a second running surface K2 are located on the upper side of the diverter base body 61. In the construction of the diverter 37b as a right diverter as shown in FIGS. 12 to 21 and in the orientation of the transport carrier 3b as shown in FIGS. 12 to 21, the first drive wheel 45a of the first drive wheel pair 46 and, as in the present example, the first drive wheel of the second drive wheel pair, lie on the first running surface K1 in a rollable manner (and permanently) when the transport carrier 3b is moved along the second transport path. As shown by way of example in FIGS. 19 to 21, the transport carrier 3b is thereby diverted. The second drive wheel 45b of the first drive wheel pair 46 and, as in the present example, the second drive wheel of the second drive wheel pair, lie in this construction and orientation on the second running surface K2 in a rollable manner (and permanently) when the transport carrier 3b is moved along the first transport path, in particular straight ahead.

On the second transport path, in particular during diversion travel, the second drive wheel 45b of the first drive wheel pair 46 and, as in the present example, the second drive wheel of the second drive wheel pair, temporarily lift off from the second running surface K2. For the rest of the time on the second transport path, the second drive wheel 45b of the first drive wheel pair 46 and, as in the present example, the second drive wheel of the second drive wheel pair, also lie on the second running surface K2.

On the first transport path, in particular during straight travel, the first drive wheel 45a of the first drive wheel pair 46 and, as in the present example, the first drive wheel of the second drive wheel pair, temporarily lift off from the first running surface K1. For the rest of the time on the first transport path, the first drive wheel 45a of the first drive wheel pair 46 and, as in the present example, the first drive wheel of the second drive wheel pair, also lie on the first running surface K1.

In the given context, “temporarily” refers in particular to the region in the diverter section N, W in which the first running surface K1 and the second running surface K2 do not extend parallel to one another, or to the time period that the transport carrier 3b needs to pass through this region.

In the case of a left diverter 37b and/or if the transport carrier 3b is placed on the guide rail 2b having been turned 180°, the conditions are correspondingly changed. The first drive wheel 45a of the first drive wheel pair 46 and, as in the present example, the first drive wheel of the second drive wheel pair can thereby lie on the first running surface K1 in a rollable manner (and permanently) when the transport carrier 3b is moved along the first transport path, in particular straight ahead, and the second drive wheel 45b of the first drive wheel pair 46 and, as in the present example, the second drive wheel of the second drive wheel pair can lie on the second running surface K2 in a rollable manner (and permanently) when the transport carrier 3b is moved along the second transport path, in particular is diverted.

On the first transport path the second drive wheel 45b of the first drive wheel pair 46 and, as in the present example, the second drive wheel of the second drive wheel pair, temporarily lift off from the second running surface K2. For the rest of the time on the first transport path, the second drive wheel 45b of the first drive wheel pair 46 and, as in the present example, the second drive wheel of the second drive wheel pair, also lie on the second running surface K2.

On the second transport path the first drive wheel 45a of the first drive wheel pair 46 and, as in the present example, the first drive wheel of the second drive wheel pair, then temporarily lift off from the first running surface K1. For the rest of the time on the second transport path, the first drive wheel 45a of the first drive wheel pair 46 and, as in the present example, the first drive wheel of the second drive wheel pair, also lie on the first running surface K1.

A first support surface P1 upon which the first support wheel 49a of the first support wheel pair 50 and, as in the present example, the first support wheel of the second support wheel pair lie in a rollable manner, is preferably located on the upper side of the diverter base body 61. A second support surface P2 upon which the second support wheel 49b of the first support wheel pair 50 and, as in the present example, the second support wheel of the second support wheel pair lie in a rollable manner, can additionally be located on the upper side of the diverter base body 61.

Moreover, a first straight guidance 67a upon which the first support wheel 49a of the first support wheel pair 50 and, as in the present example, the first support wheel of the second support wheel pair lie in a rollable manner, is located on the upper side of the diverter base body 61 when the transport carrier 3b is moved straight ahead. A second support surface 67b upon which the second support wheel 49b of the first support wheel pair 50 and, as in the present example, the second support wheel of the second support wheel pair lie in a rollable manner, is additionally located on the upper side of the diverter base body 61 when the transport carrier 3b is moved straight ahead.

Furthermore, a first diversion guidance 68a upon which the first support wheel 49a of the first support wheel pair 50 and, as in the present example, the first support wheel of the second support wheel pair lie in a rollable manner, is located on the upper side of the diverter base body 61 when the transport carrier 3b is diverted. In addition, a second diversion guidance 68ba upon which the second support wheel 49b of the first support wheel pair 50 and, as in the present example, the second support wheel of the second support wheel pair lie in a rollable manner, is located on the upper side of the diverter base body 61 when the transport carrier 3b is diverted.

Furthermore, a first counter running surface L1 and a second counter running surface L2 are located on the lower side of the diverter base body 61. In the construction of the diverter 37b as a right diverter as shown in FIGS. 12 to 21 and in the orientation of the transport carrier 3b as shown in FIGS. 12 to 21, the first adjusting wheel 47a of the (first) adjusting wheel pair 48 lies on the first counter running surface L1 in a rollable manner (and permanently) when the transport carrier 3b is moved along the second transport path, in particular is diverted. In the construction and orientation, the second adjusting wheel 47b of the (first) adjusting wheel pair 48 lies on the second counter running surface L2 in a rollable manner (and permanently) when the transport carrier 3b is moved along the first transport path, in particular straight ahead.

Similar considerations apply to the adjusting wheels 47a, 47b as to the drive wheels 45a, 45b. Accordingly, on the second transport path the second adjusting wheel 47b of the first adjusting wheel pair 48 temporarily lifts off from the second counter running surface L2. For the rest of the time, on the second transport path the second adjusting wheel 47b also lies on the second counter running surface L2. On the first transport path, the first adjusting wheel 47a of the first adjusting wheel pair 48 temporarily lifts off from the first counter running surface L1. For the rest of the time, the first adjusting wheel 47a lies on the second counter running surface L1 on the first transport path as well.

In the case of a left diverter 37b and/or if the transport carrier 3b is placed on the guide rail 2b having been turned 180°, the conditions are again correspondingly changed. The first adjusting wheel 47a of the first adjusting wheel pair 48 thereby lies on the first counter running surface L1 in a rollable manner (and permanently) when the transport carrier 3b is moved along the first transport path, in particular straight ahead, and the second adjusting wheel 47b of the first adjusting wheel pair 48 can lie on the second counter running surface K2 in a rollable manner (and permanently) when the transport carrier 3b is moved along the second transport path, in particular is diverted.

On the first transport path, the second adjusting wheel 47b of the first adjusting wheel pair 48 then temporarily lifts off from the second counter running surface K2. For the rest of the time, the second adjusting wheel 47b lies on the second counter running surface K2 on the first transport path as well. On the second transport path, the first adjusting wheel 47a of the first adjusting wheel pair 48 then temporarily lifts off from the first counter running surface L1. For the rest of the time, the first adjusting wheel 47a lies on the second counter running surface L1 on the second transport path as well.

Moreover, a first additional support surface Q1 upon which the first additional adjusting wheel 51a of the additional adjusting wheel pair 52 lies in a rollable manner, along with a second additional support surface Q2 upon which the second additional adjusting wheel 51b of the additional adjusting wheel pair 52 lies in a rollable manner, are located on the lower side of the diverter base body 61.

Furthermore, a first additional straight guidance 69a, upon which the first additional adjusting wheel 51a of the additional adjusting wheel pair 52 lies in a rollable manner when the transport carrier 3b is moved straight ahead, is located on the lower side of the diverter base body 61. Moreover, a second additional straight guidance 69b, upon which the second additional adjusting wheel 51b of the additional adjusting wheel pair 52 lies in a rollable manner when the transport carrier 3b is moved straight ahead, is located on the lower side of the diverter base body 61.

Furthermore, a first additional diversion guidance 70a, upon which the first additional adjusting wheel 51a of the additional adjusting wheel pair 50 lies in a rollable manner when the transport carrier 3b is diverted, is located on the lower side of the diverter base body 61. Moreover, a second additional diversion guidance 70b, upon which the second additional adjusting wheel 51b of the additional adjusting wheel 50 pair lies in a rollable manner when the transport carrier 3b is diverted, is located on the lower side of the diverter base body 61.

In particular, the following optional features can be seen in FIGS. 17 and 20:
The guide rail 2b comprises a first running surface K1 and a second running surface K2, which extend parallel to one another with a mutual horizontal spacing.
The guide rail 2b comprises a first counter running surface L1 and a counter second running surface L2, which extend parallel to one another with a mutual horizontal spacing.
The first running surface K1 and the second running surface K2 are arranged symmetrically to a vertical plane G extending in the longitudinal direction of the guide rail 2b.
The first counter running surface L1 and the second counter running surface L2 are also arranged symmetrically to the vertical plane G extending in the longitudinal direction of the guide rail 2b.
The wheels of the transport carrier 3b are configured double and are arranged in pairs symmetrically to a vertical plane G extending in the longitudinal direction of the guide rail 2b. In particular, this applies to the doubly configured drive wheels 45a, 45b that are each arranged symmetrically around the vertical plane G extending in the longitudinal direction of the guide rail 2b, the doubly configured adjusting wheels 47a, 47b that are each arranged symmetrically around the vertical plane G extending in the longitudinal direction of the guide rail 2b, the doubly configured support wheels 49a, 49b that are each arranged symmetrically around the vertical plane G extending in the longitudinal direction of the guide rail 2b, the doubly configured additional adjusting wheels 51a, 51b that are each arranged symmetrically around the vertical plane extending in the longitudinal direction of the guide rail 2b, as well as the doubly configured guide wheels 53a, 53b that are each arranged symmetrically around the vertical plane G extending in the longitudinal direction of the guide rail 2b.
The drive wheels 45a, 45b of the first drive wheel pair 46 and the drive wheels of the second drive wheel pair are all engaged with the guide rail 2b when the transport carrier 3b is moved on the guide rail 2b. A tipping of the transport carrier 3b and a consequential falling down of the same from the guide rail 2b is thereby avoided effectively.
The adjusting wheels 47a, 47b of the first adjusting wheel pair 48 are all engaged with the guide rail 2b when the transport carrier 3b is moved on the guide rail 2b. A tipping of the transport carrier 3b and a consequential falling down of the same from the guide rail 2b is thereby again avoided effectively.
In a switch mode of the diverter 37b, temporarily only one of the drive wheels 45a, 45b of the first drive wheel pair 46 is engaged with the diverter base body 61. In a switch mode of the diverter 37b, likewise only one of the drive wheels of the second drive wheel pair is temporarily engaged with the diverter base body 61.
In a switch mode of the diverter 37b, temporarily only one of the adjusting wheels 47a, 47b of the first adjusting wheel pair 48 is engaged with the diverter base body 61.

In these temporary circumstances, the following conditions are present during straight travel or movement along the first transport path: One drive wheel 45a, 45b each of the drive wheel pairs 46 and one adjusting wheel 47a, 47b of the first adjusting wheel pair 48 are pressed against one of the running surfaces K1, K2 or against one of the counter running surfaces L1, L2 by the support wheels 49a, 49b of the support wheel pairs 50, which are supported by the diverter guide surface R and on the straight guidances 67a, 67b, and by the additional adjusting wheels 51a, 51b of the additional adjusting wheel pair 52, which are supported by the additional straight guidances 69a, 69b. In FIGS. 16 to 18, the second drive wheel 45b of the first drive wheel pair 46, the second drive wheel of the second drive wheel pair, and the second adjusting wheel 47b of the first adjusting wheel pair 48 are pressed against the second running surface K2 or against the second counter running surface L2. If the transport carrier 3b is placed on the guide rail 2b having been turned 180°, the first drive wheel 45a of the first drive wheel pair 46, the first drive wheel of the second drive wheel pair, and the first adjusting wheel 47a of the first adjusting wheel pair 48 are then pressed against the second running surface K2 or against the second counter running surface L2. The contact of the support wheels 49a, 49b of the first support wheel pair 50 and of the support wheels of the second support wheel pair with the support surfaces P1, P2 and the contact of the additional adjusting wheels 51a, 51b of the additional adjusting wheel pair 52 with the additional support surfaces Q1, Q2 prevents, in both cases, a tipping of the transport carrier 3b.

In these temporary circumstances, the following conditions are present during diversion travel or movement along the second transport path: One drive wheel 45a, 45b each of the drive wheel pairs 46 and one adjusting wheel 47a, 47b of the first adjusting wheel pair 48 are pressed or pulled against one of the running surfaces K1, K2 or against one of the counter running surfaces L1, L2 by the opposite guide wheel 53a, 53b of the first guide wheel pair and by the opposite guide wheel of the second guide wheel pair, which are supported by the second diverter guide surface S (diversion surface), by the support wheels 49a, 49b of the support wheel pairs 50, which are supported by the diversion guidances 68a, 68b, and by the additional adjusting wheels 51a, 51b of the additional adjusting wheel pair 52, which are supported by the additional diversion guidances 70a, 70b. In FIGS. 19 to 21, the first drive wheel 45a of the first drive wheel pair 46, the first drive wheel of the second drive wheel pair, and the first adjusting wheel 47a of the first adjusting wheel pair 48 are pressed in such a manner against the second running surface K1 or against the second counter running surface L1. If the transport carrier 3b is placed on the guide rail 2b having been turned 180°, the second drive wheel 45b of the first drive wheel pair 46, the second drive wheel of the second drive wheel pair, and the second adjusting wheel 47b of the first adjusting wheel pair 48 are then pressed against the first running surface K1 or against the first counter running surface L1. The contact of the support wheels 49a, 49b of the first support wheel pair 50 and of the support wheels of the second support wheel pair with the support surfaces P1, P2 and the contact of the additional adjusting wheels 51a, 51b of the additional adjusting wheel pair 52 with the additional support surfaces Q1, Q2 also prevents, in both cases, a tipping of the transport carrier 3b.

From what has already been described, it is clear that the support wheels 49a, 49b of the first support wheel pair 50, the support wheels of the second support wheel pair and the guide wheels 53a, 53b of the first guide wheel pair 54 and the guide wheels of the second guide wheel pair are double configured and are arranged in pairs symmetrically around the vertical plane G, wherein in a switching state of the diverter 37b, only one set of said wheels 49a, 49b, 53a, 53b provided in pairs on the transport carrier 3b is engaged with the diverter element 62. The first diverter guide surface R, the second diverter guide surface S, the support surfaces P1, P2 as well as the additional support surfaces Q1, Q2 are only provided in the region of the diverter 37b.

As can be seen from the figures, the transport carrier 3b, the guide rail 2b and the diverter 37b have lateral guide elements which are provided with mutually complementarily configured lateral guide surfaces in order to guide the transport carrier 3b during the transport movement transverse to the longitudinal extension of the guide rail 2b.

For example, the running surfaces K1, K2 and/or the counter running surfaces L1, L2 on the guide rail 2b and/or on the diverter 37b can each have, as a lateral guide element, a lateral guide surface. In particular, for this purpose, the first running surface K1 and second running surface K2 can be configured as running surfaces extending inclined to one another along the guide rail 2b and/or the diverter 37b, as is the case in the embodiment represented in FIGS. 10 to 21. Furthermore, for this purpose, the first counter running surface L1 and second counter running surface L2 can be configured as counter running surfaces extending inclined to one another along the guide rail 2b and/or the diverter 37b, as is the case in the embodiment represented in FIGS. 10 to 21.

In addition, it is conceivable that the drive wheels 45a, 45b and/or the adjusting wheels 47a, 47b of the transport carrier 3b each have a lateral guide surface as a lateral guide element. In the represented examples, this is achieved by a conical configuration of the drive of the drive wheels 45a, 45b and by a conical configuration of the adjusting wheels 47a, 47b.

The overhead conveying device 1b of this embodiment can also have a feeding device as described above. This can also have a rack extending parallel to the guide rail 2b and a gear wheel of the transport carrier 3b, which meshes with the rack and is coupled to the motor 11b. In order to enable turning of the transport carrier 3b, gear wheels can be provided on both sides. Reference is made to FIG. 9 in this regard. The teaching disclosed therein can be applied in the same way to the embodiment represented in FIGS. 10 to 21.

In particular, the feeding device is assigned to a transport section of the guide rail 2b which extends between a first height level and a second height level, in particular from the first height level to the second height level, wherein the feeding device is in an operative connection with the transport carrier 3b and the feeding device applies a feeding force onto the transport carrier 3b at least during the transport movement between the different height levels. Due to the feeding device, greater drive forces can be transmitted, whereby the transport carrier 3b can move upwards or downwards even in relatively steep transport sections. The feeding force can act in addition to the drive force. Alternatively, it is conceivable that the drive is deactivated in the transport section and only the feeding force acts upon the transport carrier 3b.

It is advantageous if the drive wheels 45a, 45b and the gear wheels are coupled. In particular, the drive wheels 45a, 45b and the gear wheels can be coupled to one another in a torque-proof manner. Furthermore, the drive wheels 45a, 45b and the gear wheels can be fixed on a shared drive shaft and be arranged with an axial offset to one another, as is the case in the example shown in FIG. 9.

Alternatively, the feeding device can, for example, also be configured by a bolt which is fixed to a traction drive extending parallel to the guide rail 2b and which can positively engage the transport carrier 3b″.

At this point, it should be noted that, in this embodiment as well, the guide rail 2b has external rail guide surfaces M1, M2 as well as internal rail guide surfaces not explicitly designated, on which, in this exemplary embodiment, no wheels of the transport carrier 3b are rollable. However, it would be conceivable for the transport carrier 3b to have corresponding wheels in order to support and/or stabilize the former. These can be particularly advantageous if the drive wheels 45a, 45b and the adjusting wheels 51a, 51b are configured cylindrically and the running surfaces K1, K2 and the counter running surfaces L1, L2 are aligned horizontally.

It is further noted that the drive wheels 45a, 45b and the adjusting wheels 47a, 47b also have conical running surfaces in this embodiment in order to be rollable on the inclined running surfaces K1, K2 and counter running surfaces L1, L2, however this is not a mandatory condition. In this case, it would also be conceivable for the drive wheels 45a′, 45b′ and the adjusting wheels 47a′, 47b′ to have a cylindrical configuration and correspondingly inclined axes of rotation.

### Embodiment 3 (Transport Carrier Adhering to Support Structure)

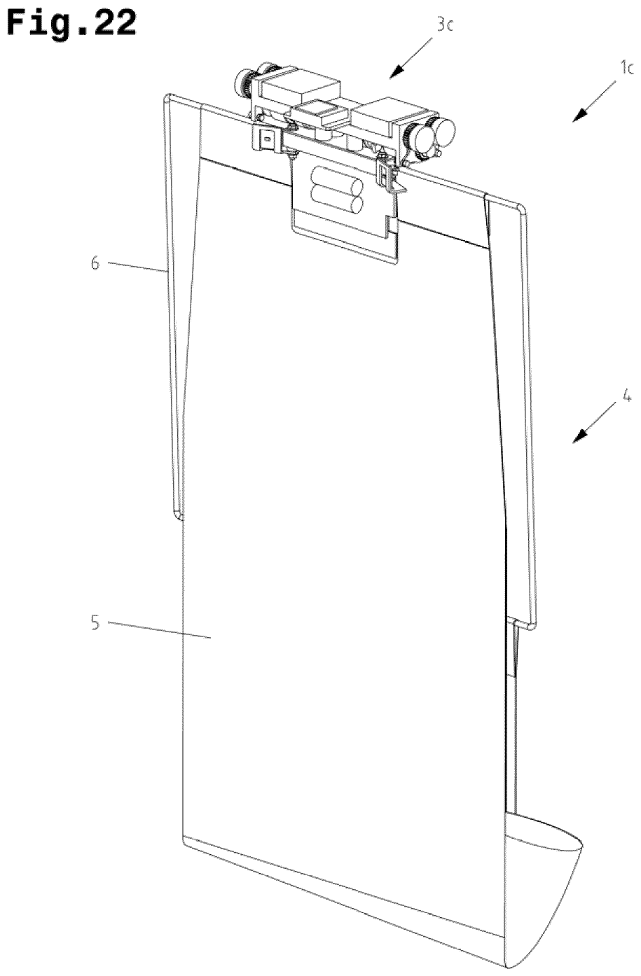

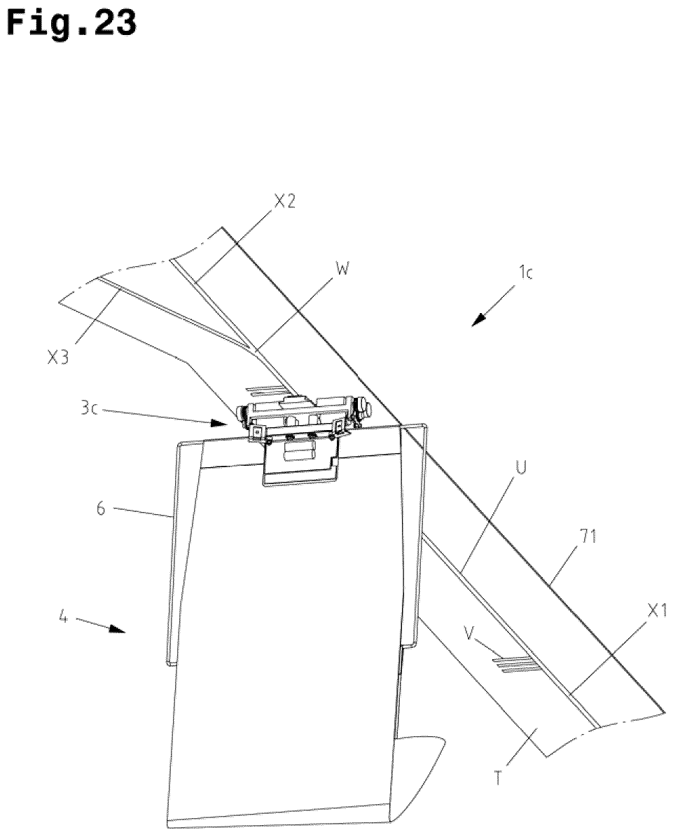

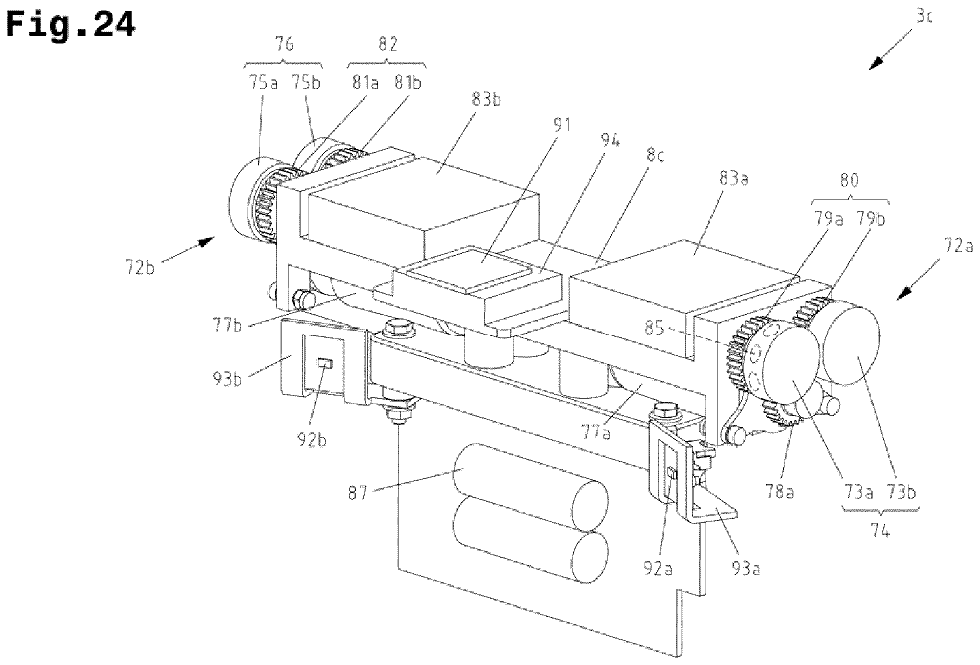

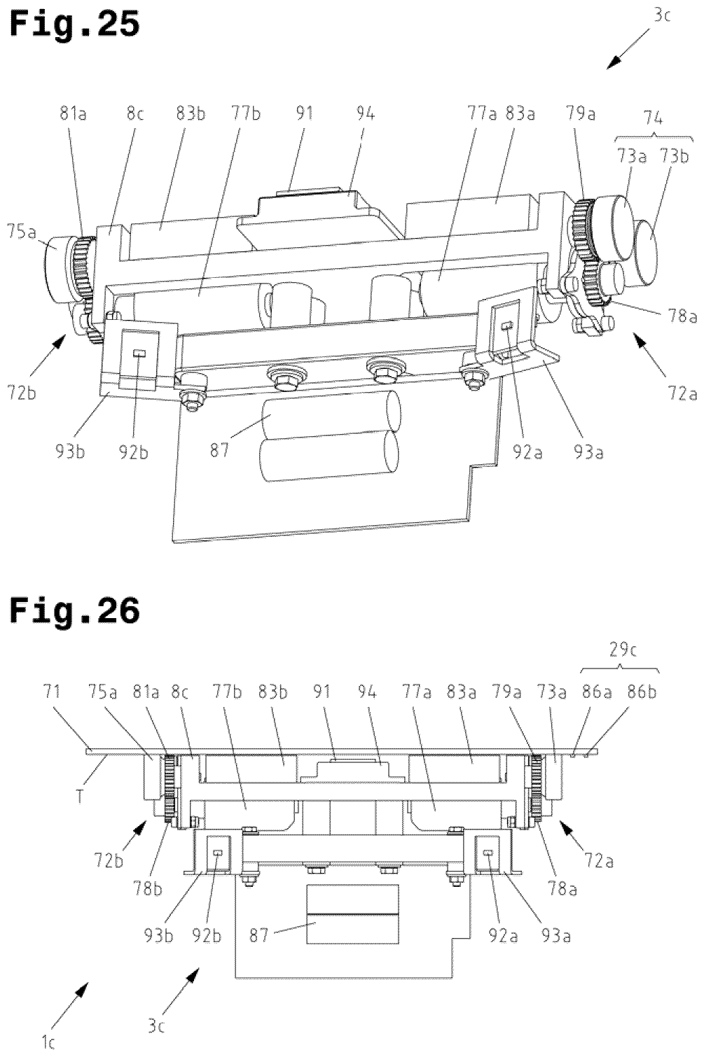

FIGS. 22 to 26 depict a further embodiment of an overhead conveying device 1c for an order-picking system or a transport carrier 3c for transporting hanging articles 4. FIG. 22 shows the transport carrier 3c with a hanging article 4 in an oblique view from above, FIG. 23 shows the overhead conveying device 1c in an oblique view from below, FIG. 24 shows the transport carrier 3c in a detailed depiction in an oblique view from above, FIG. 25 shows a detailed depiction of the transport carrier 3c in an oblique view from below, and FIG. 26 shows the transport carrier 3c or the overhead conveying device 1c in a detailed front view representation.

The overhead conveying device 1c comprises a support structure 71, which forms a driving surface T, and a transport carrier 3c for transporting hanging articles 4, the former forming a base body 8c. The base body 8c forms a first transport carrier side and a second transport carrier side in particular opposite the first transport carrier side. In this example, the hanging article 4 again comprises a transport bag with a bag body 5, which is attached to a hanger 6 and is intended for storing an article not shown explicitly here. Alternatively, the hanging article 4 can also be configured by a clothing article which is suspended from the transport carrier 3c by means of a clothes hanger.

The transport carrier 3c can, as is the case in the example shown in FIG. 23, have a support body with a receiving means for hanging up the hanging article 4. The receiving means can have a fully enclosed receiving means opening to hang the hanger 6 of the hanging article 4 into. Alternatively, an open receiving means section (hook) for hanging the hanger 6 of the hanging article 4 into or onto could be provided. In particular, the support body can be exchangeably fixed to the base body 8a via a connecting device. The technical teaching disclosed in this context in FIG. 1 is also applicable to the transport carrier 3c without restriction.

The transport carrier 3c additionally comprises two drive devices 72a, 72b for moving the transport carrier 3c on the driving surface T and a holding force generator 83a, 83b, by means of which the transport carrier 3c adheres movably to the support structure 71 and in particular to the driving surface T.

The drive devices 72a, 72b each comprise drive elements, which adjoin the driving surface T, and a plurality of electrically powered motors 77a, 77b, which are arranged on the base body 8c. The drive elements in this example are in particular formed by drive wheels 73a, 73b, 75a, 75b. In the example shown, a first drive element on the first transport carrier side comprises a first drive wheel 73a and a second drive wheel 73b. Furthermore, a second drive element on the second transport carrier side comprises a first drive wheel 75a and a second drive wheel 75b.

Thus, two drive wheels 73a, 73b of a first pair of drive wheels 74, which form the first drive element, are located on the first transport carrier side (right), and two drive wheels 75a, 75b of a second pair of drive wheels 76, which form the second drive element, are located on the second transport carrier side (left). The drive wheels 73a, 73b of the first drive element are coupled to a first motor 77a of the electrically powered motors 77a, 77b. In the same way, the drive wheels 75a, 75b of the second drive element are coupled to a second motor 77b of the electrically powered motors 77a, 77b.

Two motors 77a, 77b are therefore provided in this example. However, it would also be conceivable for the drive elements 73a, 73b, 75a, 75b to be coupled to one single motor.

In this embodiment, the drive elements 73a, 73b, 75a, 75b are coupled to the electrically powered motors 77a, 77b via a motor pinion 78a, 78b seated on the respective motor 77a, 77b and via gear wheels 79a, 79b of a first gear wheel pair 80 and gear wheels 81a, 81b of a second gear wheel pair 82. Specifically, the first gear wheel 79a of the first gear wheel pair 80 is arranged coaxially with the first drive wheel 73a of the first drive wheel pair 74, the second gear wheel 79b of the first gear wheel pair 80 is arranged coaxially with the second drive wheel 73b of the first drive wheel pair 74, the first gear wheel 81a of the second gear wheel pair 82 is arranged coaxially with the first drive wheel 75a of the second drive wheel pair 76, and the second gear wheel 81b of the second gear wheel pair 82 is arranged coaxially with the second drive wheel 75b of the second drive wheel pair 76.

In contrast to the examples depicted thus far, coupling the drive wheels 73a, 73b, 75a, 75b with the motors 77a, 77b takes place via a gear wheel transmission. It would also be conceivable to again use a traction drive here as is the case in the examples depicted in FIGS. 1 to 21. Conversely, in the examples depicted in FIGS. 1 to 21, the use of gear wheel transmissions instead of the traction drives used therein would also be possible.

Although the drive of the transport carrier 3c is provided by motors 77a, 77b arranged on the transport carrier 3c in the example shown in FIGS. 22 to 26, it would also be conceivable for the drive of the transport carrier 3c to be provided by means of the linear motor principle. For example, coils can be provided along the driving surface T and a short-circuit coil, an externally excited coil or a permanent magnet on the transport carrier 3c such that the arrangement acts as a linear asynchronous motor or linear synchronous motor.

The transport carrier 3c further has one or more holding force generators, which comprise two permanent magnets 83a, 83b in the example shown of FIGS. 22 to 26. The permanent magnets 83a, 83b or holding force generators are arranged on the base body 8c between the first transport carrier side and second transport carrier side.

The support structure 71 also forms the driving surface T and is preferably made of a (ferro)magnetic material. The support structure 71 or the driving surface T can be made of sheet steel, for example. With the aid of the permanent magnets 83a, 83b, the transport carrier 3c adheres upside down to the driving surface T, wherein the transport carrier 3c is movable on the driving surface T.

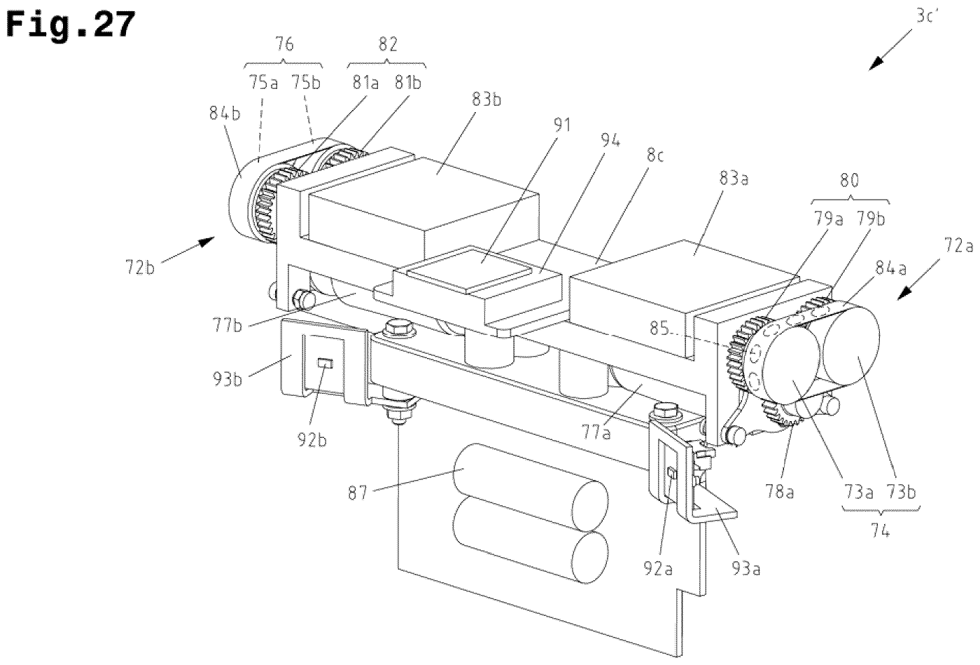

The drive elements in the example shown in FIGS. 22 to 26 are formed by drive wheels 73a, 73b, 75a, 75b. However, this is not the only conceivable possibility. It would also be conceivable for the drive elements to comprise an endlessly circulating first crawler belt 84a guided around the drive wheels 73a, 73b of the first drive wheel pair 74 on the first transport carrier side and an endlessly circulating second crawler belt 84b guided around the drive wheels 75a, 75b of the second drive wheel pair 76 on the second transport carrier side, as is the case in the example shown in FIG. 27.

Similarly, it would also be conceivable for chains to be provided instead of the crawler belts 84a, 84b. The drive elements are then formed by a first endlessly circulating chain guided on the first transport carrier side around the drive wheels 73a, 73b of the first drive wheel pair 74 and by a second endlessly circulating chain guided on the second transport carrier side around the drive wheels 75a, 75b of the second drive wheel pair 76.

In the example shown in FIG. 22-27, the holding force generators comprise permanent magnets 83a, 83b. However, this is not the only conceivable possibility. It would also be conceivable for the holding force generators to comprise adhesive lamellae according to the gecko principle, suction cups and/or a Velcro strip of a Velcro fastening and thus hooks or mushroom heads of a Velcro fastening, for example, which are arranged on the outer circumference of the drive elements, i.e. on the circumference of the drive wheels 73a, 73b, 75a, 75b or outside on the crawler belts 84a, 84b or chains, for example. In FIG. 24, optional suction cups 85 are indicated by dashed circles on the drive wheel 73a and in FIG. 27 by dashed circles on the crawler belt 84a. In reality, the use of suction cups 85 is of course not limited to the drive wheel 73a and the crawler belt 84a. These can alternatively or additionally also be arranged on the other drive wheels 73b, 75a and 75b and/or on the crawler belt 84b. In the case of a Velcro fastening, a part of a Velcro strip can be arranged on the outer circumference of the drive elements. The other part of the Velcro fastening is then located on the driving surface T.

When using adhesive lamellae, suction cups or a Velcro fastening, the permanent magnets 83a, 83b can be omitted or provided in addition to said holding force generators.

The embodiment of the overhead conveying device 1c or of the transport carrier 3c shown in FIGS. 22 to 27 comprises an optional energy supply system 29c which has an insulator and exposed electrical conductors 86a, 86b which extend along the driving surface T and can be mounted thereon (explicitly depicted in FIG. 26). In addition, the transport carrier 3c can have current collectors (not shown in FIGS. 22 to 27), which are in electrical contact with the electrical conductors 86a, 86b and are connected electrically to the motors 77a, 77b. In this example, the current collectors can also be configured as sliding contacts which slide/brush on the electrical conductors 86a, 86b when the transport carrier 3c moves. The current collectors can, however, also be configured in the form of wheels or rollers and lie on the electrical conductors 86a, 86b in a rollable manner.

The energy supply system 29c can in particular be configured in the same way as the energy supply systems 29a, 29b depicted in FIGS. 1 to 2 and 4 to 21. The technical teaching disclosed on this can therefore also be analogously applied to the energy supply system 29c.

Instead of a contact-based energy transmission, a contactless energy transmission could also be provided using an inductive energy supply system. Reference is hereby made to FIG. 3 and the technical teaching disclosed therein, which is also applicable to the embodiment variation disclosed in FIGS. 22 to 27 in an analogous and unrestricted manner.

If the holding force generators comprise permanent magnets 83a, 83b and the support structure 71 is made of a (ferro)magnetic material, it is advantageous for the electrical conductors 86a, 86b to be arranged below the support structure 71 as shown in FIG. 26. It would also be conceivable for the electrical conductors 86a, 86b to be arranged above the support structure 71, specifically above an insulating region of the support structure 71, or also if the support structure 71 were made entirely of an insulating material. In this case, adhesive lamellae, suction cups 85 and/or a Velcro fastening should be provided as holding force generators.

In one embodiment variation, it can again be provided that the energy supply system 29c is only provided on straight route sections of the driving surface T. The energy supply system 29c can thereby be configured more simply. In curves and in the region of branches, the motors 77a, 77b in this embodiment can again be supplied from an energy storage 87 as has already been described in connection with the other embodiments. If the driving surface T is configured to be relatively narrow, this can also be considered and referred to as a “movement track”.

For this purpose, it can also be provided that the transport carrier 3c and/or the transport bag has/have an energy storage 87 connected electrically to the motors 77a, 77b or an energy source connected electrically to the motors 77a, 77b. The position of the energy storage 87 indicated in FIGS. 22 to 27 is not mandatory. Instead, the energy storage 87 can, for example, also be installed in a housing of a control unit (see also FIG. 29). In particular, the motors 77a, 77b are connected to the energy storage 87 via switch elements or control elements. The energy storage 87 can, for example, be configured as a rechargeable battery. A solar module can be provided additionally or alternatively as an energy source.

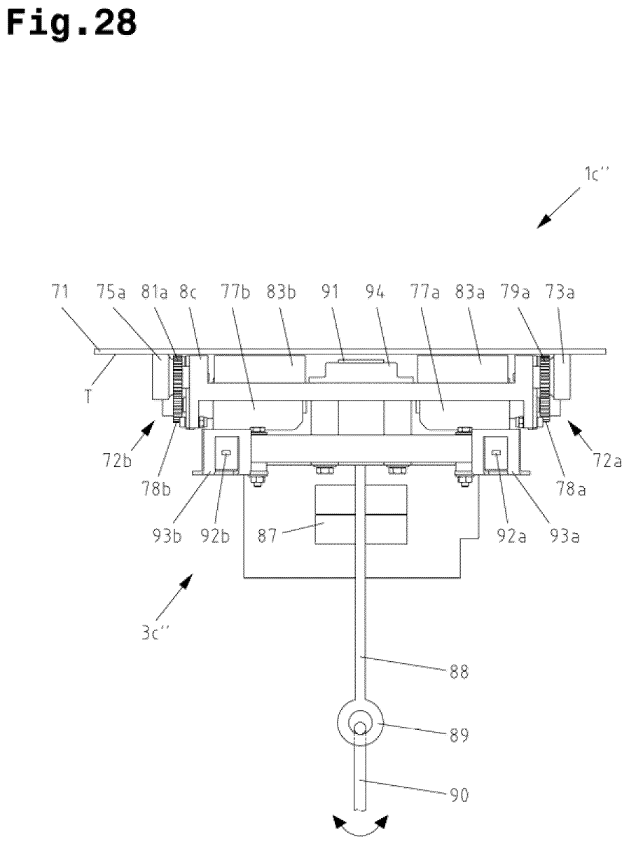

It is also conceivable for the driving surface T not to be aligned horizontally as shown in FIGS. 23 and 26 but to extend obliquely or even be aligned vertically, i.e. to form a wall in principle. The transport carriers 3c adhering to the driving surface T can also move on this wall. For example, a space-saving storage surface for the transport carriers 3c could be formed this way. In this context in particular, it is advantageous if the transport carrier 3c comprises a hinge assembly which allows the hanging article 4 to be pivoted relative to the base body 8c by more than 45° and in particular by at least 90° transverse to the movement direction of the transport carrier 3c. In this context, FIG. 28 discloses a transport carrier 3c″ in front view, which is configured similarly to the transport carrier 3c of FIGS. 22 to 26. Contrary thereto, the transport carrier 3c″ comprises an extension bar 88 with an eyelet 89 arranged thereon and a hook 90 of a hanging article 4 rotatably mounted therein. This can pivot both in the longitudinal direction and in the transverse direction (see the double arrow) due to the suspension. A corresponding selection of the length of the extension bar 88 can, in particular, determine the lateral pivot angle.

### Driving Control of the Transport Carrier

The overhead conveying device 1c has further features that will be explained in more detail in the following. This specifically relates to a driving marking U and the control marking V attached to the driving surface T, as well as the driving surface sensor 91 arranged on the transport carrier 3c. Furthermore, the transport carrier 3c can comprise a plurality of, in particular two, distance sensors 92a, 92b which are mounted on the base body 8c by means of sensor brackets 93a. It is also clear from FIG. 23 that the driving marking U is divided into one diverter section W and three travel routes X1 . . . X3 in the same way as the diverter sections E, N and rail routes F1 . . . F3, O1 . . . O3 of the overhead conveying devices 1a, 1b.

In this context, FIG. 29 also discloses an exemplary electrical block diagram of a transport carrier 3a . . . 3c″. The transport carrier 3a . . . 3c″ can comprise a control unit 94, with a driving control 95, configured as a microcontroller, a memory 96 (data and/or program memory) connected thereto, power electronics 97 connected to the driving control 95 and a communication module 98 connected to the driving control 95. The driving control 95 or the communication module 98 can be configured for optical, radio-based or wired communication, in particular for communication via the energy supply system 29 in accordance with the power-line communication technology. Furthermore, the control unit 94 can comprise an energy management module 99 and the energy storage 87 connected thereto. The driving surface sensor 91 and the distance sensor 92 (or both distance sensors 92a, 92b insofar as two distance sensors 92a, 92b are provided) can also be connected to the driving control 95. Both motors 77a, 77b (or only the motor 11a, 11b in the case of only one motor 11a, 11b) are connected to the power electronics 97. Furthermore, the energy management module 99 and the communication module 98 are connected to the energy supply system 29 or part thereof. At this point, it is noted that the block diagram shown in FIG. 29 as well as the function of the control unit 94 relate not only to the transport carrier 3c, but to all construction types of transport carriers, thus in particular also to the transport carriers 3a . . . 3c″.

The function of the transport carrier 3a . . . 3c″ equipped in this way is as follows:

As specified, the transport carrier 3a . . . 3c″ has the driving control 95 and the memory 96 configured to be writable and readable connected thereto. In particular, the driving control 95 can be configured to influence, control or regulate a movement of the transport carrier 3a . . . 3c″ on the support structure 71 or the guide rails 2a . . . 2b acting as a support structure on the basis of movement data stored or deposited in the memory 96.

For example, the driving control 95 of the transport carrier 3a . . . 3c″ can be configured to regulate a speed of the transport carrier 3a . . . 3c″. The motors 11a, 11b, 77a, 77b are correspondingly actuated by the driving control 95 for this purpose. Specifically, the power electronics 97 connected to the motors 11a, 11b, 77a, 77b are actuated by the driving control 95, the former obtaining the electrical energy required to power the motors 11a, 11b, 77a, 77b from the energy supply system 29 or the energy storage 87 via the energy management module 99.

The driving surface sensor 91 can be used to guide the transport carrier 3c . . . 3c″ along the driving marking U. The driving marking U can, for example, be a line painted, printed or glued onto the driving surface T, which has a different brightness and/or color than the rest of the driving surface T. The driving marking U can be black on a light background, for example. In this case, the driving surface sensor 91 is configured as an optical driving surface sensor, for example as a sensor array of a plurality of optical sensors. By evaluating the sensor signal, directional corrections or changes in direction can be derived for the transport carrier 3c . . . 3c″. A directional correction or change of direction is carried out by differing actuation of the motors 77a, 77b. Different rotational speeds cause the transport carrier 3c . . . 3c″ to move in a curve.

It would also be conceivable for the driving marking U to be configured as a magnetic strip and the driving surface sensor 91 as a magnetic sensor (in particular as a Hall sensor) The transport carrier 3c . . . 3c″ can also be guided along the driving marking U in this way.

The distance sensor 92 (or the distance sensors 92a, 92b) can be configured to measure a distance to another transport carrier 3a . . . 3c″ moving ahead and connected to the driving control 95. In this case, the driving control 95 can be configured to regulate a distance to the other transport carrier 3a . . . 3c moving ahead on the basis of the distance measured by the distance sensor 92 (or by the distance sensors 92a, 92b). The distance sensor 92, 92a, 92b can be configured as an ultrasonic sensor, for example.

The two distance sensors 92a, 92b are advantageously arranged at an acute angle (greater than 0° and less than) 90° to one another in this example. As a result, the distance to a transport carrier 3a . . . 3c″ moving ahead can also be measured well in curves or in the diverter section E, N, W. The signal of the distance sensor 92a, 92b pointing into the inside of the curve is thereby evaluated preferably or exclusively. Quite generally, however, an angle greater than 0° and less than 180° between the two distance sensors 92a, 92b would also be possible.

The driving control 95 of the transport carrier 3a . . . 3c″ can also be configured to regulate a speed of the transport carrier 3a . . . 3c″ and/or to regulate a distance from another transport carrier 3a . . . 3c″.

It is also conceivable that the movement of the transport carrier 3a . . . 3c″ on the support structure 71 or on the guide rails 2a . . . 2b is influenced by means of the control marking V. This can be optically or magnetically applied to the driving surface T or to the guide rails 2a . . . 2b and read by the driving surface sensor 91 or another sensor provided for this purpose, wherein the same considerations apply as for the driving marking U.

For example, the control marking V can mean that the transport carrier 3a . . . 3c″ should change (i.e. increase or decrease) its speed when it detects the control marking V, change the distance to a transport carrier 3c . . . 3c″ moving ahead (i.e. increase or decrease) or stop or should continue its movement in the diverter section E, N, W starting from the first travel route F1, O1, X1 along the second travel route F2, O2, X2 or along the third travel route F3, O3, X3.

Setting of a desired speed of the transport carrier 3a . . . 3c″ or of a desired distance of the transport carrier 3a . . . 3c″ from another transport carrier 3a . . . 3c″ can also be caused by a control marking V which is arranged in the region of the support structure 71 or on the guide rails 2a . . . 2b so as to be detected by the transport carrier 3a . . . 3c″.

The driving surface sensor 91 of the transport carrier 3c . . . 3c″ in this example is, in sum, a light-sensitive element connected to the driving control 95, with which an optical driving marking U attached to the support structure 71 and/or optical control marking V is readable, with which a movement of the transport carrier 3c . . . 3c″ on the support structure 71 can be influenced. The optical marking U, V can be configured as a driving line or driving marking U on the driving surface T of the support structure 71, however it can also be configured as a control element or control marking V for the transport carrier 3c . . . 3c″ and function as a turn-off point when the control marking V influences the movement direction of the transport carrier 3c . . . 3c″ or as a stop point when the control marking V causes the transport carrier 3c . . . 3c″ to stop. The optical control marking V can particularly also be configured as a barcode or QR code. In addition, the optical control marking V can also be configured to be longer and act on a plurality of successive transport carriers 3c . . . 3c″.

It would also be conceivable for the track marking U and/or the control marking V not to be attached to the support structure T in a fixed manner, but to be configured as a controllable light source, via which a control command can be transferred from the light source to the driving surface sensor 91 or to another light-sensitive element of the transport carrier 3c . . . 3c″ and thus from the support structure 71 to the driving control 95 of the transport carrier 3c . . . 3c″. The controllable light source on the support structure 71 can have a plurality of individually activatable luminous dots arranged in the form of a matrix, for example. As a result of the proposed measures, the control commands transferred to the transport carrier 3c . . . 3c″ are not fixed, but can be flexibly adapted to a specific situation.

For example, the control marking V can optionally be used to change the speed of the transport carrier 3a . . . 3c″ as necessary, to change the distance from a transport carrier 3c . . . 3c″ moving ahead as necessary, to stop the transport carrier 3c . . . 3c″ as necessary and/or to control the movement direction of the transport carrier 3c . . . 3c″ in the diverter section W as necessary. The driving marking U can also flexibly influence the movement direction of the transport carrier 3c . . . 3c″. By accordingly specifying the speed of the transport carrier 3a . . . 3c″ and/or the distance of the transport carrier 3a . . . 3c″ to another transport carrier 3c . . . 3c″ travelling ahead, a specific throughput of transport carriers 3c . . . 3c″ can also be specified or achieved. For example, said speed and said distance can be reduced on curves and increased on straights. Said throughput can thereby be kept particularly constant.

At this point, it should be noted that the aforementioned technical teaching regarding the control marking V also relates without restriction to the transport carriers 3a . . . 3b. Accordingly, the transport carriers 3a . . . 3b can have a corresponding sensor for detecting such a control marking V.

Not only the actuation of the transport carrier 3c . . . 3c″ by a driving marking U and/or control marking V on the support structure 71, but also the actuation of (fixed) elements of the over-head conveying device 1a . . . 1a″, 1b, 1c by the transport carrier 3a . . . 3c″ is conceivable. In other words, the driving control 95 can be configured to influence a movement of a control element of the support structure 71 or on the guide rails 2a . . . 2b on the basis of control data stored or saved in the memory 96. For example, the control element of the support structure 71 or of the guide rails 2a . . . 2a″, 2b is configured as a diverter 37a, 37b and a control command of the driving control 95 of the transport carrier 3a . . . 3c″ can cause a switching of the diverter 37a, 37b into a predeterminable switch position. That is, said control command can cause a switching of the diverter element 38, 61 for straight travel or diversion travel.

For example, the transport carrier 3a . . . 3c″ can have a light source connected to the driving control 95 and the control element of the support structure 71 a light-sensitive element, wherein a control command can be transferred from the driving control 95 of the transport carrier 3a . . . 3c″ to the control element of the support structure 71 with the light source via the light-sensitive element. The lighting element 56 of the transport carrier 3b is to be referenced as a representative example of such a light source. However, the lighting element 56 could also be arranged at on the other transport carriers 3a . . . 3a″, 3c . . . 3c′ disclosed by way of example. For example, the diverter element 38, 61 can be brought into the position for diversion movement when the light emitted by the lighting element 56 is received, whereas the diverter element 38, 61 otherwise remains in the position for straight-ahead movement and vice versa.

FIG. 30 additionally shows a schematic depiction of a detail of a transport network with a diverter 37, which is connected to a light-sensitive element 100. If the latter receives a corresponding signal when the transport carrier 3 moves past, the diverter element 38, 61 of the diverter 37 is actuated accordingly.

As a result of the proposed measures, it is possible for the transport carrier 3a . . . 3c″ to move autonomously across the transport network formed by the support structure 71 or by the guide rail 2a . . . 2a″, 2b and the diverters 37, 37a, 37b.

For example, the driving control 95 of the transport carrier 3a . . . 3c″ can be configured, also according to this path definition, to receive a path definition from a superordinate controller 101, to store this path definition in the memory 96 of the transport carrier 3a . . . 3c″ and to select a path of a plurality of paths in a diverter section E, N, W with the help of the driving control 95. The path definition can be transmitted with the help of optical, wired or radio-based communication (in particular via power-line communication).

The selection of a path can in particular comprise the autonomous switching of diverters 37, 37a, 37b of the support structure 71 by means of the driving control 95 and the path definition. For example, as stated above, this can be carried out with the help of the lighting element 56 and with the help of the light-sensitive elements 100 along the support structure 71 or along the guide rails 2a . . . 2a″, 2b. Of course, control elements of the support structure 71 can also be actuated differently, for example by means of wired or radio-based communication. A more complex optical data transmission by corresponding modulation of the lighting element 56 would also be possible.

The path definition can comprise, for instance, the selection of a certain driving marking U in a diverter section W or the sequence for switching the next four diverters 37, 37a, 37b, for example, such as the sequence “straight travel, diversion travel, diversion travel, straight travel”. As mentioned, this path definition is transmitted to the driving control 95, stored in the memory 96, and is then used for the selection of a driving marking U or the autonomous switching of the diverters 37, 37a, 37b. In the case of a driving marking U, that driving marking U in the first diverter section W is accordingly selected that effects a straight travel, in the second diverter section W, that driving marking U that effects diversion movement, and so on. For this purpose, it can be provided that the transport carrier 3c . . . 3c″ follows the left or right edge of the driving marking U with the aid of driving surface sensor 91 and the control unit 94. By selecting the corresponding edge, the selection of the desired path in the diverter section W can be effected. In the case of switchable diverters 37, 37a, 37b, the exemplary path definition causes the first diverter 37, 37a, 37b that the transport carrier 3a . . . 3c″ reaches during its movement to be actuated such that the diverter element 38, 61 is set to straight travel, the second diverter 37, 37a, 37b such that the diverter element 38, 61 is set to diversion travel, and so on. The superordinate controller 101 thus specifies the path, upon which the transport carrier 3a . . . 3c″ then moves autonomously with the help of the driving control 95. The sequence for switching the next four diverters 37, 37a, 37b, for instance, can also be direction-independent and simply specify switch commands for the diverters 37, 37a, 37b, for example the sequence “do not switch, switch, switch, do not switch”. A switch command is thereby not bound to a certain direction. Depending on the diverter 37, 37a, 37b construction, “switch” can mean either straight travel or diversion travel. The same applies to “do not switch”. The sequence can also be specified in a purely binary manner, for instance in the sequence “0, 1, 1, 0” and then be used directly for controlling a light source 56 of the transport carrier 3, 3a . . . 3c″ that is connected to the driving control 95 if the diverter 37, 37a, 37b has a light-sensitive element 100 for controlling the diverter 37, 37a, 37b.

It would also be conceivable that a switching of a diverter 37, 37a, 37b is caused by means of a control marking V which is arranged in the region of the support structure 71 or of the guide rail 2a . . . 2a″, 2b such that it can be detected by the transport carrier 3, 3a . . . 3c″.

Of course, the transmission of data from the superordinate controller 101 to the driving control 95 of the transport carrier 3, 3a . . . 3c″ is not limited to path definitions, rather a desired speed or a desired distance to a transport carrier 3, 3a . . . 3c″ moving ahead can also be transmitted. This can be carried out additionally or alternatively to the control with the aid of control markings V.

It is particularly advantageous for the driving control 95 of the transport carrier 3, 3a . . . 3c″ to be configured to receive a weight of a mass transported by the transport carrier 3, 3a . . . 3c″ (i.e. to receive a weight of the article 7, for example) from the superordinate controller 101, to store this weight in the memory 96 and to execute an acceleration profile with the help of the driving control 95 and as a function of this weight. The movement dynamics of the transport carrier 3, 3a . . . 3c″ can be adapted to the article 7 in this way. Said weight can be derived from a database, for example, in which the weight assigned to an article 7 is stored, or can be detected by weighing.

In a further embodiment, the control marking V triggers an (active) signalling of the driving control 95 to the superordinate controller 101. In turn, reading the control marking V can be carried out by the driving surface sensor 91 or another sensor of the transport carrier 3, 3a . . . 3c″.

For example, the driving control 95 signalling to the superordinate controller 101 can trigger the sending of a path definition by the superordinate controller 101. For example, the transport network formed by the support structure 71 or by the guide rail 2a . . . 2a″, 2b and the diverters 37, 37a, 37b can be divided into a plurality of segments separated by signalling points. When the driving control 95 actively notifies at a control marking V acting as a signalling point, the driving control 95 receives the path definition for the following segment from the superordinate controller 101. In this way, the transport carrier 3, 3a . . . 3c″, can be guided flexibly through the transport network (see also the supply segments Y1 . . . Y4 in FIG. 30).

It would also be conceivable for short-range radio transmitters 102 to be distributed in the transport network and for the transport carriers 3, 3a . . . 3c″ to have short-range radio receivers 103 connected to the driving control 95 or vice versa, as shown schematically in FIG. 30. If a short-range radio receiver 103 detects a signal of a short-range radio transmitter 102, this can trigger the driving control 95 to notify the superordinate controller 101 and consequently also to transfer a path definition from the superordinate controller 101 to the driving control 95. If short-range radio receivers 103 are distributed in the transport network and the transport carriers 3, 3a . . . 3c″ have short-range radio transmitters 102, the roles shown in FIG. 30 are reversed. In this case, receiving the signal of the short-range radio transmitter 102 at the stationary short-range radio receiver 103 can trigger notification of the transport carrier 3, 3a . . . 3c″, to the superordinate controller 101 by the short-range radio receiver 103 and, as a result, also the transmission of a path definition from the superordinate controller 101 to the travel controller 95.

The control marking V or the short-range radio transmitter 102 (or alternatively the short-range radio receiver 103 arranged in the transport network) can be assigned a local position, and the notification of the driving control 95 at the superordinate controller 101 can effect an adaptation of the path definition starting from the specified position by the superordinate controller 101, if a target position of the transport carrier 3, 3a . . . 3c″ does not correspond to the local position of the control marking V or of the short-range radio transmitter 102 (or of the short-range radio receiver 103). It can occur that the actual position of the transport carrier 3, 3a . . . 3c″ which corresponds to the position of this control marking V or this short-range radio transmitter 102 (or this short-range radio receiver 103) when the control marking V is detected or when the signal of the short-range radio transmitter 102 is detected, does not correspond to the position of the transport carrier 3a . . . 3c″ (desired position) assumed by the driving control 95. The selection of a certain path or the switching of diverters 37, 37a, 37b according to the path definition stored in the memory 96 may then lead to switching errors and guiding errors. With the proposed measures, a deviation of the actual position of the transport carrier 3, 3a . . . 3c″ from the position assumed by the driving control 95 can be taken into account or the desired position of the transport carrier 3, 3a . . . 3c″ can be corrected again, i.e. set to its actual position.

It would also be conceivable for the control marking V or the short-range radio transmitter 102 (or the short-range radio receiver 103) to be configured to effect the simultaneous notification of the driving controls 95 of several transport carriers 3a . . . 3c″ to the superordinate controller 101.

If the energy supply system 29, 29a, 29b of the overhead conveying device 1a . . . 1a″, 1b, 1c (i.e. the sliding conductor or the inductive energy supply system) is also configured for wired communication with the driving control 95 of the transport carrier 3, 3a . . . 3c″, it can advantageously be provided that the energy supply system 29, 29a, 29b of the overhead conveying device 1a . . . 1a″, 1b, 1c is divided into a plurality of supply segments Y1 . . . Y4 which have different addresses in a communication system of the overhead conveying device 1a . . . 1a″, 1b, 1c as symbolically depicted in FIG. 30.

A local position can also be assigned to a supply segment Y1 . . . Y4 of the energy supply system 29, 29a, 29b, wherein moving the transport carrier 3, 3a . . . 3c″ into this supply segment Y1 . . . Y4 effects an adaptation of the path definition starting from said position by the superordinate controller 101 if a target position of the transport carrier 3a . . . 3c″ does not match the local position of the supply segment Y1 . . . Y4 of the energy supply system 29, 29a, 29b. The selection of a certain path or the switching of diverters 37, 37a, 37b according to the path definition stored in the memory 96 again leads to switching errors and guiding errors in case of the aforementioned deviation. The proposed measures do, however, allow for a deviation of the actual position of the transport carrier 3, 3a . . . 3c″ from the position as assumed by the driving control 95 to be taken account of and the desired position of the transport carrier 3, 3a . . . 3c″ to be corrected again, that is to say, reverted to its actual position (in this case to the position of the supply segment Y1 . . . Y4 that the transport carrier 3, 3a . . . 3c″ is entering).

In the example shown in FIG. 30, no supply segment Y1 . . . Y4 is provided in the region of the diverter 37. Instead, the transport carrier is supplied from the energy storage 87 there. However, this is not mandatory, but a supply segment Y1 . . . Y4 could also be provided in the region of the diverter 37.

It is additionally noted that the considerations disclosed for actuating a transport carrier 3, 3a . . . 3c″ apply and are applicable to all embodiments shown in FIGS. 1 to 28. Only the switching of a diverter 37, 37a, 37b is omitted in the embodiments shown in FIGS. 22 to 28 insofar as the diverter section is embodied without a moveable diverter element 38, 62.

Finally, it should be noted that the scope of protection is defined by the claims. The description and the drawings should, however, be consulted when construing the claims. Individual features or combinations of features from the various example embodiments as shown and described can constitute separate inventive solutions. The problem to be solved by the individual inventive solutions can be derived from the description.

In particular, it should be noted that in reality the represented devices can comprise more or fewer components than shown. The represented devices and their components can partially also be shown not to scale and/or in magnification and/or shrunk down.

1. An overhead conveying device for an order-picking system, comprising
a support structure configured as a guide rail having a running surface extending along the guide rail,
a transport carrier for transporting a hanging article,
a drive device for moving the transport carrier along the guide rail, the drive device having an electrically powered motor that is mounted on the transport carrier and arranged above the guide rail when the transport carrier is suspended from the guide rail,
wherein the transport carrier has a base body with a receiving means for suspending the hanging article, a plurality of wheels rotatably mounted on the base body and current collectors that are electrically connected to the motor,
wherein a wheel of the plurality of wheels is configured as a drive wheel is coupled to the motor, and
wherein the guide rail has a first partial guide rail with a first running surface and a second partial guide rail with a second running surface, the first running surface and the second running surface being extended parallel to or inclined towards one another with a mutual horizontal spacing,
an electrical energy supply system having an insulator and exposed electrical conductors, the electrical conductors being arranged along and with a spacing to the guide rail and can be contacted with the current collectors and slide, brush or roll on the electrical conductors when the transport carrier moves.

2. The overhead conveying device according to claim 1, characterized in that the drive wheel lies on the running surface in a rollable manner and in that the transport carrier is suspended from the guide rail by the drive wheel.

3. The overhead conveying device according to claim 1, characterized in that the electrically powered motor is arranged above the drive wheel on the base body.

4. The overhead conveying device according to claim 1, characterized in that the guide rail having a counter running surface extending along the guide rail and in that a wheel of the plurality of wheels is configured as an adjusting wheel and lies on the counter running surface in a rollable manner.

5. The overhead conveying device according to claim 4, characterized in that the transport carrier having an adjusting device by means of which the adjusting wheel is pressed against the counter running surface with an adjusting force.

6. The overhead conveying device according to claim 5, characterized in that the adjusting device having
a carriage mounted movably on the base body and a force generator acting against the carriage, wherein the adjusting wheel is mounted on the carriage, or
a swing arm mounted movably on the base body and a force generator acting against the swing arm, wherein the adjusting wheel is mounted on the swing arm.

7. The overhead conveying device according to claim 6, characterized in that the force generator comprises a pre-loaded elastic spring element, a pneumatic spring, a permanent magnet, or an electromagnet.

8. The overhead conveying device according to claim 1, characterized in that the drive device has further having a traction drive via which the drive wheel is coupled to the motor.

9. The overhead conveying device according to claim 1, characterized in that the overhead conveying device comprises further comprising the hanging article which is transportable with the transport carrier, and the hanging article having a transport bag with a bag body for storing an article.

10. The overhead conveying device according to claim 1, characterized in that the transport carrier and/or the hanging article, in particular the transport bag, having an energy storage electrically connected to the motor and/or an energy source electrically connected to the motor.

11. The overhead conveying device according to claim 1, characterized in that at least some of the plurality of wheels of the transport carrier are double configured and arranged in pairs symmetrically to a vertical plane extending in the longitudinal direction of the guide rail, wherein in an operating mode of the transport carrier one set each of the wheels provided in pairs is engaged with the guide rail.

12. The overhead conveying device according to claim 1, characterized in that the drive wheel of the transport carrier is configured as a first drive wheel of a first drive wheel pair and a further wheel of the plurality of wheels of the transport carrier is configured as a second drive wheel of the first drive wheel pair, wherein the first drive wheel and the second drive wheel of the first drive wheel pair are arranged coaxially on a first drive shaft coupled to the motor.

13. The overhead conveying device according to claim 12, characterized in that the first drive wheel of the first drive wheel pair lies on the first running surface in a rollable manner and the second drive wheel of the first drive wheel pair lies on the second running surface in a rollable manner.

14. The overhead conveying device according to claim 12, characterized in that the transport carrier is suspended from the guide rail by the drive wheels.

15. The overhead conveying device according to claim 12, characterized in that the drive device having a traction drive via which the drive wheels are coupled to the motor.

16. The overhead conveying device according to claim 5, characterized in that a wheel of the plurality of wheels of the transport carrier is configured as a first adjusting wheel of a first adjusting wheel pair and a further wheel of the plurality of wheels of the transport carrier is configured as a second adjusting wheel of the first adjusting wheel pair, wherein the first adjusting wheel and the second adjusting wheel of the first adjusting wheel pair are arranged coaxially on a first bearing axle.

17. The overhead conveying device according to claim 16, characterized in that a wheel of the plurality of wheels of the transport carrier is configured as a first adjusting wheel of a second adjusting wheel pair and a further wheel of the plurality of wheels of the transport carrier is configured as a second adjusting wheel of a second adjusting wheel pair, wherein the first adjusting wheel and the second adjusting wheel of the second adjusting wheel pair are arranged coaxially on a second bearing axle.

18. The overhead conveying device according to claim 16, characterized in that the first adjusting wheel lies on the first counter running surface in a rollable manner and the second adjusting wheel lies on the second counter running surface in a rollable manner.

19. The overhead conveying device according to claim 16, characterized in that the transport carrier having an adjusting device by means of which the first adjusting wheel is pressed with a first adjusting force against the first counter running surface and/or the second adjusting wheel is pressed with a second adjusting force against the second counter running surface.

20. The overhead conveying device according to claim 13, characterized in that a wheel of the plurality of wheels of the transport carrier is configured as a first support wheel of a first support wheel pair and a further wheel of the plurality of wheels of the transport carrier is configured as a second support wheel of the first support wheel pair, which are arranged coaxially on the first drive shaft coupled to the motor on either side of the first drive wheel pair.

21. The overhead conveying device according to claim 1, characterized in that the overhead conveying device further comprising a diverter in a diverter section, wherein the guide rail comprises a first rail route upstream of the diverter in a first transport direction of the transport carrier and a second rail route and third rail route downstream of the diverter in the first transport direction of the transport carrier, and in that the diverter having a diverter element which is switchable between a first switch position and a second switch position in order to selectively direct the transport carrier along a first transport path between the first rail route and the second rail route or along a second transport path between the first rail route and the third rail route.

22. The overhead conveying device according to claim 21, characterized in that the diverter element is horizontally or vertically displaceable, in particular pivotable or slidable.

23. The overhead conveying device according to claim 4, characterized in that the overhead conveying device further comprising a diverter in a diverter section, wherein the guide rail comprises a first rail route upstream of the diverter in a first transport direction of the transport carrier and a second rail route and third rail route downstream of the diverter in the first transport direction of the transport carrier,
wherein the diverter having a diverter element which is switchable between a first switch position and a second switch position in order to selectively direct the transport carrier along a first transport path between the first rail route and the second rail route or along a second transport path between the first rail route and the third rail route,
wherein the diverter element comprises a running surface and a counter running surface,
wherein the counter running surface extends parallel to the running surface with a horizontal spacing and/or a vertical spacing.

24. The overhead conveying device according to claim 4, characterized in that the overhead conveying device further comprising a diverter in a diverter section, wherein the guide rail comprises a first rail route upstream of the diverter in a first transport direction of the transport carrier and a second rail route and third rail route downstream of the diverter in the first transport direction of the transport carrier,
wherein the diverter having a diverter element which is switchable between a first switch position and a second switch position in order to selectively direct the transport carrier along a first transport path between the first rail route and the second rail route or along a second transport path between the first rail route and the third rail route,
wherein the diverter element comprises a first running surface and a second running surface as well as a first counter running surface and a second counter running surface,
wherein the first running surface and the second running surface extend parallel to the first counter running surface and to the second counter running surface with a horizontal spacing and/or a vertical spacing.

25. The overhead conveying device according to claim 23, characterized in that
in the first switch position of the diverter element the first drive wheel of the first drive wheel pair lies on a running surface of a first guiding element of the diverter element in a rollable manner and the first adjusting wheel of the first adjusting wheel pair lies on a counter running surface of the first guiding element when the transport carrier is moved along the diverter section, and
in the second switch position of the diverter element the second drive wheel of the first drive wheel pair lies on a running surface of a second guiding element of the diverter element and the second adjusting wheel of the first adjusting wheel pair lies on a counter running surface of the second guiding element when the transport carrier is moved along the diverter section.

26. The overhead conveying device according to claim 21, characterized in that the diverter element comprises a first diverter guide surface which in the first switch position of the diverter element acts on a support wheel of the first support wheel pair and/or interacts with a guide wheel of the first guide wheel pair and the transport carrier is guided along the first transport path, and in the second switch position of the diverter element does not interact with the transport carrier and the transport carrier can be moved unhindered along the second transport path.

27. The overhead conveying device according to claim 21, characterized in that the diverter element comprises a second diverter guide surface which in the first switch position of the diverter element does not interact with the transport carrier, wherein the transport carrier is movable along the first transport path, and in the second switch position of the diverter element interacts with a guide wheel of the first guide wheel pair, wherein the transport carrier is guided along the second transport path.

28. The overhead conveying device according to claim 21, characterized in that the diverter additionally having a diverter base body upon which the diverter element is mounted, the diverter base body comprises
an upper side,
a lower side,
a first passage channel extending from the upper side to the lower side and along a first transport path, to which at one end of the first passage channel the first rail route adjoins and at an opposite, further end of the first passage channel the second rail route adjoins,
a second passage channel extending from the upper side to the lower side and along a second transport path which at one end of the second passage channel leads into the first passage channel and at an opposite, further end of the second passage channel adjoins to the third rail route,
on the upper side a first running surface upon which the first drive wheel of the first drive wheel pair lies in a rollable manner when the transport carrier is moved along the first transport path, and a second running surface upon which the second drive wheel of the first drive wheel pair lies in a rollable manner when the transport carrier is moved along the second transport path,
on the upper side a first support surface upon which the first support wheel of the first support wheel pair lies in a rollable manner, and a second support surface upon which the second support wheel of the first support wheel pair lies in a rollable manner,
on the upper side a first straight guidance upon which the first support wheel of the first support wheel pair lies in a rollable manner, and a second straight guidance upon which the second support wheel of the first support wheel pair lies in a rollable manner when the transport carrier is moved straight, and
on the upper side a first diversion guidance upon which the first support wheel of the first support wheel pair lies in a rollable manner, and a second diversion guidance upon which the second support wheel of the first support wheel pair lies in a rollable manner when the transport carrier is diverted.

29. The overhead conveying device according to claim 28, characterized in that the diverter base body additionally comprises
on the lower side a first counter running surface upon which the first adjusting wheel of the first adjusting wheel pair lies in a rollable manner when the transport carrier is moved along the first transport path, and a second counter running surface upon which the second adjusting wheel of the first adjusting wheel pair lies in a rollable manner when the transport carrier is moved along the second transport path,
on the lower side a first additional support surface upon which the first additional adjusting wheel of the additional adjusting wheel pair lies in a rollable manner, and a second additional support surface upon which the second additional adjusting wheel of the additional adjusting wheel pair lies in a rollable manner,
on the lower side a first additional straight guidance upon which the first additional adjusting wheel of the additional adjusting wheel pair lies in a rollable manner, and a second additional straight guidance upon which the second additional adjusting wheel of the additional adjusting wheel pair lies in a rollable manner when the transport carrier is moved straight, and
on the lower side a first additional diversion guidance upon which the first additional adjusting wheel of the additional adjusting wheel pair lies in a rollable manner, and a second additional diversion guidance upon which the second additional adjusting wheel of the additional adjusting wheel pair lies in a rollable manner when the transport carrier is diverted.

30. The overhead conveying device according to claim 25, characterized in that the diverter guide surfaces and/or the support surfaces are only provided in the region of the diverter.

31. The overhead conveying device according to claim 21, characterized in that at least some of the plurality of wheels of the transport carrier are configured double and are arranged in pairs symmetrically to a vertical plane extending in the longitudinal direction of the guide rail,
wherein in a switching state of the diverter one set each of the wheels provided in pairs on the transport carrier is engaged with the diverter element, or
wherein in a switching state of the diverter both sets of the wheels provided in pairs on the transport carrier are engaged with the diverter element until a drive force for the transport carrier can be completely taken on by one set of the drive wheels provided in pairs.

32. The overhead conveying device according to claim 21, characterized in that the guide rail comprises rail guide surfaces and/or the diverter element comprises diverter guide surfaces which interact with the guide wheels of the transport carrier.

33. The overhead conveying device according to claim 1, characterized in that the transport carrier, the guide rail and the diverter have lateral guide elements which are provided with mutually complementary lateral guide surfaces in order to guide the transport carrier during a transport movement of the transport carrier along a longitudinal extension of the guide rail or along a longitudinal extension of the diverter.

34. The overhead conveying device according to claim 33, characterized in that the drive wheels of the transport carrier each have a lateral guide surface as a lateral guide element.

35. The overhead conveying device according to claim 1, characterized in that the transport carrier having a driving control and a writably and readably configured memory connected to the driving control.

36. The overhead conveying device according to claim 35, characterized in that the support structure having at least one control element and the driving control is configured to control a movement of at least one control element of the support structure on the basis of control data stored in the memory, wherein the driving control of the transport carrier and/or the at least one control element of the support structure is configured for optical, wired or wireless communication, wherein the transport carrier having a light source connected to the driving control and the control element of the support structure having a light-sensitive element, wherein a control command can be transmitted from the driving control of the transport carrier to the control element of the support structure with the light source via the light-sensitive element.

37. The overhead conveying device according to claim 36, characterized in that the control element of the support structure is configured as a diverter, and a control command of the driving control of the transport carrier triggers a switching of the diverter into a predeterminable switch position.

38. The overhead conveying device according to claim 35, characterized in that the transport carrier having a driving surface sensor connected to the driving control with which a driving marking and/or control marking arranged on the support structure is readable, with which a movement of the transport carrier on the support structure can be influenced.

39. The overhead conveying device according to claim 36, characterized in that the support structure having a controllable light source and the transport carrier having an optical driving surface sensor connected to the driving control, wherein a control command can be transmitted from the support structure to the driving control of the transport carrier by the light source and the optical driving surface sensor.

40. The overhead conveying device according to claim 39, characterized in that the controllable light source on the transport carrier or the support structure having a plurality of individually activatable luminous dots arranged in the form of a matrix.

41. The overhead conveying device according to laim 35, characterized in that the driving control of the transport carrier is configured
to closed-loop control a speed of the transport carrier, and/or
to closed-loop control a distance from another transport carrier.

42. The overhead conveying device according to claim 41, characterized in that the transport carrier having a plurality of distance sensors, which are connected to the driving control and are arranged in such a way that they form an angle greater than 0° and less than 180° in pairs.

43. The overhead conveying device according to claim 38, characterized in that a desired speed of the transport carrier or a desired distance of the transport carrier from another transport carrier is set on the basis of the control marking, which is arranged in the region of the support structure and can be detected by the transport carrier.
